(19) United States
(12) Patent Application Publication
(10) Pub. No.: US 2024/0220622 A1
(43) Pub. Date: Jul. 4, 2024

(54) SECURITY AND METHODS FOR IMPLEMENTING ADDRESS TRANSLATION EXTENSIONS FOR CONFIDENTIAL COMPUTING HOSTS

(71) Applicant: Intel Corporation, Santa Clara, CA (US)

(72) Inventors: Utkarsh Y. Kakaiya, El Dorado Hills, CA (US); Eric Geisler, Hillsboro, OR (US); Rupin H. Vakharwala, Hillsboro, OR (US); Michael Prinke, Aloha, OR (US); David Koufaty, Portland, OR (US)

(21) Appl. No.: 18/149,055

(22) Filed: Dec. 30, 2022

(51) Int. Cl. G06F 21/57

(52) U.S. Cl. CPC G06F 21/57; G06F 2221/033

(57) ABSTRACT

Circuitry and methods for implementing address translation extensions for confidential computing hosts are described. In certain examples, a system includes a hardware processor core to implement a trust domain manager to manage one or more hardware isolated virtual machines as a respective trust domain with a region of protected memory; an input/output device coupled to the hardware processor core; and input/output memory management unit (IOMMU) circuitry comprising trusted direct memory access translation data and coupled between the hardware processor core and the input/output device, wherein the IOMMU circuitry is to, for a request from the input/output device for a direct memory access of a protected memory of a trust domain: in response to a field in the request being set to indicate the input/output device is in a trusted computing base of the trust domain and an entry in the trusted direct memory access translation data being set into an active state by the trust domain manager, allow the direct memory access by the input/output device.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

Various examples in accordance with the present disclosure will be described with reference to the drawings, in which:

FIG. 1 illustrates a block diagram of a computer system including a plurality of cores having a trust domain manager, a memory, an input/output memory management unit (IOMMU), and an input/output (IO) device according to examples of the disclosure.

FIG. 2 illustrates a block diagram of a host coupled to an IO device according to examples of the disclosure.

FIG. 3A illustrates a block diagram of an IOMMU having an IO cache according to examples of the disclosure.

FIG. 3B illustrates a block diagram of untrusted translation tables and trusted translation tables for the IOMMU of FIG. 3A according to examples of the disclosure.

FIG. 4 illustrates a state machine, having a free state and a present state, for an entry of an IOMMU according to examples of the disclosure.

FIG. 5A illustrates a state machine, having a free state, configured state, present state, and a blocked state for an entry of a trusted IOMMU according to examples of the disclosure.

FIG. 5B illustrates a state machine, having a free state, configured state, present state, and a plurality of blocked states, for an entry of a trusted IOMMU according to examples of the disclosure.

FIG. 6 is a flow diagram for enabling a trusted direct memory access (trusted DMA) translation for an IO device according to examples of the disclosure.

FIG. 7 is a flow diagram for disabling a trusted direct memory access (trusted DMA) translation for an IO device according to examples of the disclosure.

FIG. 8 illustrates a state machine, having a free state, present state, and a plurality of blocked states, for a non-leaf entry of a trusted IOMMU according to examples of the disclosure.

FIG. 9 illustrates a block diagram of an IOMMU that supports trusted address translation services (trusted ATS) according to examples of the disclosure.

FIG. 10 illustrates a block diagram of an IOMMU, coupled to an untrusted invalidation queue and a trusted invalidation queue, that supports untrusted and trusted invalidation according to examples of the disclosure.

FIG. 11 illustrates a block diagram of an IOMMU, coupled to an untrusted invalidation queue, a trusted invalidation queue, an untrusted page request queue, and a trusted page request queue, that supports untrusted and trusted page request services (PRS) according to examples of the disclosure.

FIG. 12A illustrates example formats of address translation services (ATS) packets including a trusted polarity of completer (TPC) field according to examples of the disclosure.

FIG. 12B illustrate example formats of PCI Express (PCIe) packets including eXtended TEE (XT) attribute field according to examples of the disclosure.

FIG. 13 is a table of IOMMU registers according to examples of the disclosure.

FIG. 14 is an example format of a trusted root table address register according to examples of the disclosure.

FIG. 15 is an example format of a trusted invalidation queue head register according to examples of the disclosure.

FIG. 16 is an example format of a trusted invalidation queue tail register according to examples of the disclosure.

FIG. 17 is an example format of a trusted invalidation queue address register according to examples of the disclosure.

FIG. 18 is an example format of a trust domain (e.g., trust domain extensions (TDX)) mode register according to examples of the disclosure.

FIG. 19 is an example format of an extended capability register having trust domain IO capability enumeration according to examples of the disclosure.

FIG. 20 is an example format of an enhanced command status register according to examples of the disclosure.

FIG. 21 is an example format of an enhanced command capability register according to examples of the disclosure.

FIG. 22 is an example format of an enhanced command register according to examples of the disclosure.

FIG. 23 is an example format of an enhanced command response register according to examples of the disclosure.

FIG. 24 is an example format of a processing set trust domain (e.g., trust domain extensions (TDX)) mode bit according to examples of the disclosure.

FIG. 25 is an example format of an example error report according to examples of the disclosure.

FIG. 26 is an example format of an example error report according to examples of the disclosure.

FIG. 27 is an example format of an example error report for a fault during a first-stage page table (FSPT) walk according to examples of the disclosure.

FIG. 28 is an example format of an example error report for fault during a second-stage page table (SSPT) walk according to examples of the disclosure.

FIG. 29 is a table of translation structures according to examples of the disclosure.

FIG. 30 is an example format of a trusted invalidation completion status register according to examples of the disclosure.

FIG. 31 is an example format of a trusted invalidation event control register according to examples of the disclosure.

FIG. 32 is an example format of a trusted invalidation event data register according to examples of the disclosure.

FIG. 33 is an example format of a trusted invalidation event address register according to examples of the disclosure.

FIG. 34 is an example format of a trusted invalidation event upper address register according to examples of the disclosure.

FIG. 35 is an example format of a trusted invalidation queue error record register according to examples of the disclosure.

FIG. 36 is an example format of a trusted page request queue head register according to examples of the disclosure.

FIG. 37 is an example format of a trusted page request queue tail register according to examples of the disclosure.

FIG. 38 is an example format of a trusted page request queue address register according to examples of the disclosure.

FIG. 39 is an example format of a trusted page request status register according to examples of the disclosure.

FIG. 40 is an example format of a trusted page request event control register according to examples of the disclosure.

FIG. 41 is an example format of a trusted page request event data register according to examples of the disclosure.

FIG. 42 is an example format of a trusted page request event address register according to examples of the disclosure.

FIG. 43 is an example format of a trusted page request event upper address register according to examples of the disclosure.

FIG. 44 is an example format of a trusted extended capability register according to examples of the disclosure.

FIG. 45 is an example format of a TDX-IO registers offset register according to examples of the disclosure.

FIG. 46 is an example of new IOMMU error report associated with TDX-IO according to examples of the disclosure.

FIG. 47 is a flow diagram illustrating operations of a method for processing a request for a direct memory access of a protected memory of a trust domain from an input/output device according to examples of the disclosure.

FIG. 48 illustrates an example computing system.

FIG. 49 illustrates a block diagram of an example processor and/or System on a Chip (SoC) that may have one or more cores and an integrated memory controller.

FIG. 50A is a block diagram illustrating both an example in-order pipeline and an example register renaming, out-of-order issue/execution pipeline according to examples.

FIG. 50B is a block diagram illustrating both an example in-order architecture core and an example register renaming, out-of-order issue/execution architecture core to be included in a processor according to examples.

FIG. 51 illustrates examples of execution unit(s) circuitry.

FIG. 52 is a block diagram of a register architecture according to some examples.

FIG. 53 illustrates examples of an instruction format.

FIG. 54 illustrates examples of an addressing information field.

FIG. 55 illustrates examples of a first prefix.

FIGS. 56A-56D illustrate examples of how the R, X, and B fields of the first prefix in FIG. 55 are used.

FIGS. 57A-57B illustrate examples of a second prefix.

FIG. 58 illustrates examples of a third prefix.

FIG. 59 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for implementing address translation extensions for confidential computing hosts.

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM), for example, accessible according to a Peripheral Component Interconnect Express (PCIe) standard.

In certain examples of computing, a virtual machine (VM) (e.g., guest) is an emulation of a computer system. In certain examples, VMs are based on a specific computer architecture and provide the functionality of an underlying physical computer system. Their implementations may involve specialized hardware, firmware, software, or a combination. In certain examples, a virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (IO) resources, such as, but not limited to, an input/output memory management unit (IOMMU) (e.g., an IOMMU circuit). The VMM may provide a centralized interface for managing the entire operation, status, and availability of VMs that are installed over a single host machine or spread across different and interconnected hosts.

However, it may be desirable to maintain the security (e.g., confidentiality) of information for a virtual machine from the VMM and/or other virtual machine(s). Certain processors (e.g., a system-on-a-chip (SoC) including a processor) utilize their hardware to isolate virtual machines, for example, with each referred to as a “trust domain”. Certain processors support an instruction set architecture (ISA) (e.g., ISA extension) to implement trust domains. For example, Intel® trust domain extensions (Intel® TDX) that utilize architectural elements to deploy hardware-isolated virtual machines (VMs) referred to as trust domains (TDs).

In certain examples, a hardware processor and its ISA (e.g., a trust domain manager thereof) isolates TD VMs from the VMM (e.g., hypervisor) and/or other non-TD software (e.g., on the host platform). In certain examples, a hardware processor and its ISA (e.g., a trust domain manager thereof) implement trust domains to enhance confidential computing by helping protect the trust domains from a broad range of software attacks and reducing the trust domain's trusted computing base (TCB). In certain examples, a hardware processor and its ISA (e.g., a trust domain manager thereof) enhance a cloud tenant's control of data security and protection. In certain examples, a hardware processor and its ISA (e.g., a trust domain manager thereof) implement trust domains (e.g., trusted virtual machines) to enhance a cloud-service provider's (CSP) ability to provide managed cloud services without exposing tenant data to adversaries.

In certain examples, a hardware processor and its ISA (e.g., a trust domain manager thereof) also support device input/output (IO). For example, with an ISA (e.g., Intel® TDX 2.0) supporting trust domain extension (TDX) with device input/output (IO) (e.g., TDX-IO). In certain examples, a hardware processor and its ISA (e.g., a trust domain manager thereof) that support device input/output (IO) (e.g., TDX-IO) enables the use (e.g., assignment) of a physical function (PF) and/or a virtual function (VF) of a device to (e.g., only) a specific TD.

Certain trust domains (TDs) are used to host confidential computing workloads isolated from hosting environments. Certain trust domain technology (e.g., TDX 1.0) architecture enables isolation of the TD (e.g., central processing unit (CPU)) context and memory from the hosting environment, but does not support trusted IO (e.g., direct memory access (DMA) or memory-mapped I/O (MMIO)) to TD private memory, e.g., leading to higher overheads as trust domains are to use a software mechanism for protecting data sent to IO devices (e.g., storage, network, etc.), for example, where all IO data is sent through bounce buffers in TD shared memory using para-virtualized interfaces. However, in certain examples, this precludes the use of some IO models, such as, but not limited to, shared virtual memory, direct IO assignments, and compute offload to an accelerator, field-programmable gate array (FPGA), and/or graphics processing unit (GPU). Thus, from an IO perspective, certain trust domain technology (e.g., TDX 1.0) suffers from the limitations of 1) functionality (e.g., security) because protection can only be extended for devices having the capabilities of end to end encryption (e.g., hardware (H/W) or software (S/W) stack based), as well as no support for state of the art IO virtualization/programming models, and 2) performance because copying for bounce buffers (and software based encryption) incurs significant performance overheads, especially with increased speed/bandwidth of IO devices (e.g., accelerators). Certain trust domain technology (e.g., TDX 1.0) suffers from the limitations that DMAs from devices is done to unprotected memory (e.g., shared memory, which may or may not be encrypted and integrity-protected memory pages) and the TD (e.g., software running in the TD) hence is to copy the data between the unprotected (e.g., shared) memory and TD Private Memory. In certain examples, these additional copies introduce significant overhead on software and/or are used when the data that needs to be sent or received from the device is previously encrypted or integrity-protected (e.g., using software-managed keys), for example, in the case of network traffic or storage. In certain examples, this scheme of “bouncing” the data through shared buffers does not support shared virtual memory (SVM) usages since devices cannot access the shared (e.g., IA) page tables in TD private memory and does not support accelerator offload models where clear-text data from the TD private memory needs to be operated upon by the accelerator.

Certain trust domain technology (for example, trust domain extensions (TDX) with device input/output (IO) (e.g., TDX-IO)) defines the hardware, firmware, and/or software extensions to enable direct and trusted (e.g., confidential) IO between TDs and corresponding IO (e.g., TDX-IO) enlightened devices, and thus overcomes the above limitations. In certain examples, an IOMMU (e.g., a VT-d engine thereof) on a system-on-a-chip (SoC) is the critical hardware enabling trusted direct memory access (trusted DMA) between these device(s) (e.g., in TD's trusted computing base (TCB)) and one or more TD's private memory, and overcomes the above limitations.

Certain examples herein are directed to VT-d/IOMMU extensions for enabling TDX-IO. Certain examples herein are directed to TDX-IO IOMMU (e.g., virtualization technology for directed I/O (VT-d)) extensions to a processor and/or its ISA. Certain examples herein extend an IOMMU (e.g., circuitry) to enable direct device assignment to one or more TDs and/or enable IO (e.g., PCIe) devices to access a TD's confidential memory. Certain examples herein extend an IOMMU (e.g., circuitry) with (i) new security attributes of initiator (SAI) protected (e.g., access controlled to only trusted firmware or TDX Module and/or SEAM) architectural register set, (ii) trusted root table pointer for enabling trusted DMA walks to TD private memory from device(s) in TD's TCB (e.g., a TD assigned device), a trusted invalidation queue (e.g., and register(s) for its base address, head, tail, and events) for enabling trusted invalidations, a trusted page request queue (e.g. and registers(s) for its base address, head, tail, and events) for enabling trusted page-requests, and thereby secure page and/or IO resource reassignment, and/or (iii) a control (e.g., TDX_MODE) register for securely transitioning IOMMU in and out of trust domain (e.g., tdx_mode) operation. In certain examples, a T attribute (e.g., a trusted execution environment (TEE) bit or an “ide_t” bit) or an XT attribute (e.g., an eXtended trusted execution environment (XT) bits or XT0/XT1 bits) (e.g., in an incoming Peripheral Component Interconnect Express (PCIe) standard's integrity and data encryption (IDE) transaction layer packet (TLP) prefix) in a memory access request (e.g., a request by an IO device to a private/shared memory of a trust domain) (i) signifies whether a DMA request (e.g., transaction) originates from a trusted IO context, and/or (ii) is used to select between walking the untrusted (e.g., VMM) maintained (e.g., VT-d) translation tables (e.g., from root pointer) or the trusted (e.g., TDM) (e.g., TDX Module) maintained (e.g., VT-d) translation tables (e.g., from trusted root pointer). In certain examples, a translation table includes a mapping of a virtual address to a physical address. Certain examples herein are directed to IOMMU/host extensions to support trusted DMAs to TD's private memory, e.g., including the definition of new architectural states to manage trusted DMA-translation table entries, support trusted Address Translation Services (trusted ATS), support trusted Page Request Services (trusted PRS), support TEE-Polarity of Completer (TPC) in ATS transactions, and/or support eXtended TEE (XT) mode.

In certain examples, a VMM is not trusted to access “trusted” translation table(s) for a trust domain or a plurality of trust domains (e.g., not trusted with the mappings of a (e.g., guest) trust domain (e.g., physical) address to a host (e.g., physical) address), and a trust domain manager is to instead manage the translation tables for the trust domain or the plurality of trust domains. In certain examples, an IOMMU is to restrict access to the “trusted” translation tables, for example, to ensure that only trusted access(es) by an IO device is allowed, e.g., to ensure that the IO device is in the trusted computing base of the trust domain (or the plurality of trust domains).

In certain examples, an IOMMU includes an IO cache (e.g., IO translation lookaside buffer (IOTLB), context-cache, PASID-cache, first-stage and second-stage paging structure caches) to perform a translation, walk, etc. In certain examples, respective IOMMU caches are tagged to separate between trusted and untrusted (e.g., VT-d) mappings. In certain examples, for different transactions to memory (e.g., originating from the I/O device or the IOMMU itself), the IOMMU generates a command which is used to selectively allow addresses to TD private memory, e.g., where this catches various security threats from untrusted VMM/operating system(OS) VT-d tables/IOMMU programming and/or malicious devices.

In certain examples, the IOMMU enhancements enable TDX-IO, and thus are improvements to the functioning of a SoC (e.g., processor) (e.g., of a computer) itself as they allow for confidential computing in the cloud space (e.g., with (e.g., all) direct, performant IO models supported as well), particular with the rise of heterogeneous computing with accelerators and IO devices in the cloud.

In certain examples, IOMMU enhancements include one or more of: an access controlled register set in corresponding IOMMU, two (e.g., “trusted” and “untrusted”) root pointers, two (e.g., “trusted” and “untrusted”) invalidation queues, two (e.g. “trusted” and “untrusted”) page request queues, “trusted’ tags in the IOMMU caches (e.g., translation table cache(s)), and/or new faults for trusted/untrusted DMA walks. In certain examples, these are architectural changes and are also documented in a corresponding IOMMU specification. In certain examples, these architectural changes can be seen by monitoring a DMA path of trusted transactions to and/or from system memory. In certain examples, IOMMU enhancements enable accelerator offload models for Trust Domains and allows these accelerators to access TD's private memory. In certain examples, ATS support enables high-performance I/O (e.g., for next-gen datacenters) and makes various customer scenarios viable (e.g., direct peer-to-peer between TDX-IO devices, compute express link (CXL) cache, etc.). In certain examples, PRS support enables simplified programming model for data-accelerators and enables efficient memory management with the use of shared virtual memory. In certain examples, TEE-Polarity of Completer (TPC) support enables efficient device caching/sharing and direct peer-to-peer scenarios. In certain examples, eXtended TEE (XT) mode support enables (i) a mechanism to convey TEE or non-TEE intent on the memory requests, and (ii) appropriate access checks based on the conveyed intent.

It should be understood that the functionality herein may be added to other confidential computing technology as a computing solution for IO devices, for example, to AMD® Secure Encrypted Virtualization (e.g., SEV) (e.g., Secure Encrypted Virtualization-Encrypted State (SEV-ES) and/or SEV-Secure Nested Paging (SEV-SNP)) or ARM® Realm Management Extension (RME). In certain examples, the confidential computing technology (e.g., AMD® SEV) uses one key per virtual machine to isolate guests and the hypervisor from one another, for example, where the keys are managed by a trust domain manager (e.g., AMD Secure Processor). In certain examples, the confidential computing (e.g., SEV) requires enablement in the guest operating system and hypervisor. In certain examples, the guest changes allow the virtual machine to indicate which pages in memory should be encrypted. In certain examples, the hypervisor changes use hardware virtualization instructions and communication with the trust domain manager (e.g., AMD Secure processor) to manage the appropriate keys in the memory controller. In certain examples, the confidential computing technology (e.g., ARM® Confidential Compute Architecture (ARM® CCA)) enables the construction of protected execution environments called realms, for example, where realms allow lower-privileged software, such as an application or a virtual machine, to protect its content and execution from attacks by higher-privileged software, such as an OS or a hypervisor.

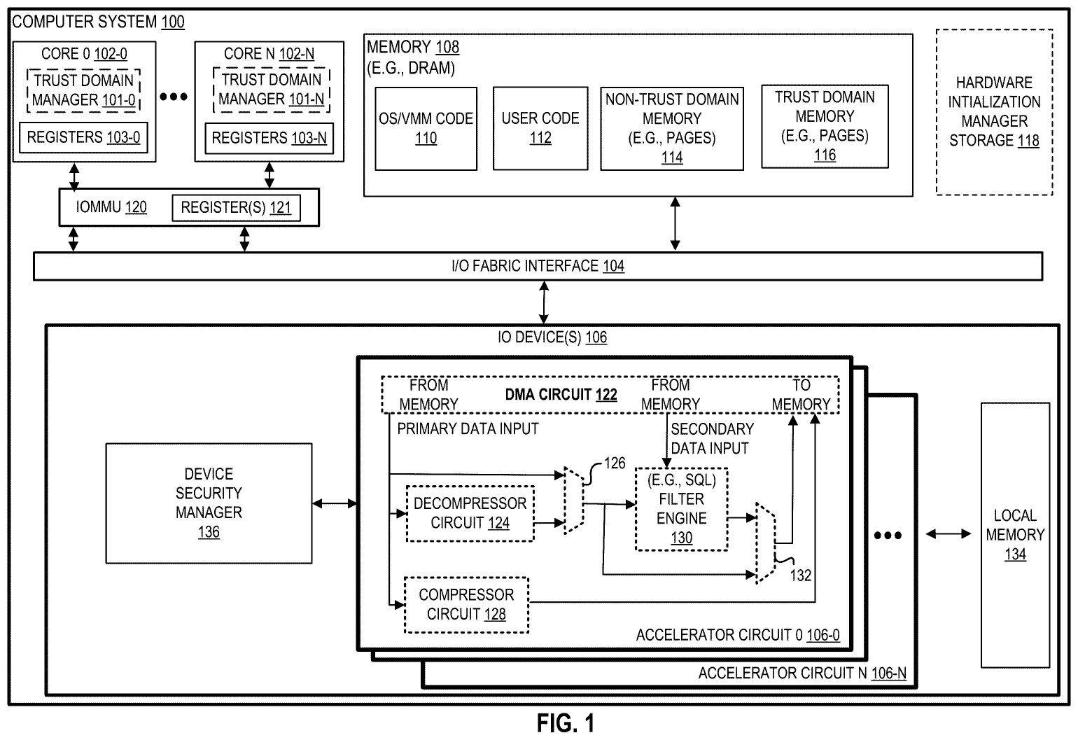

Turning now to FIG. 1, an example system architecture is depicted. FIG. 1 illustrates a block diagram of a computer system 100 including a plurality of cores (e.g., where N is any positive integer greater than one, although single core examples may also be utilized) having a trust domain manager 101-0 to 101-N, a memory 108 (e.g., a system memory separate from a processor and/or core memory), an input/output memory management unit (IOMMU) 120 (e.g., circuit), and an input/output (IO) device 106 according to examples of the disclosure.

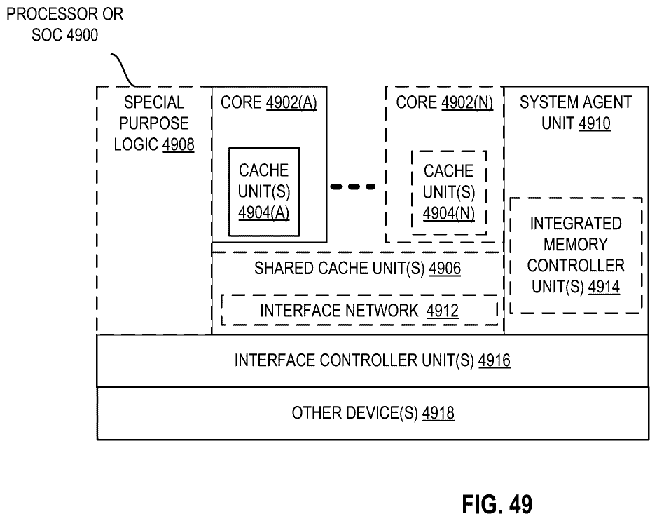

In certain examples, each core includes (e.g., or logically includes) a set of registers, e.g., registers 103-0 for core 102-0, registers 103-N for core 102-N, etc. Registers 103 may be data registers and/or control registers, e.g., for each core (e.g., or each logical core of a plurality of logical cores of a physical core). In certain examples, each core includes its own cache and/or coupling to a next level(s) cache, for example, the cache hierarchy shown in FIG. 49. In certain examples, a cache used by the core(s) 102 is separate from any cache in IOMMU 120 (e.g., IO cache 302 in IOMMU 120). In certain examples, a cache used by the core(s) 102 is separate from any cache that is to store trusted and/or untrusted DMA translation data (e.g., IO cache 302 in IOMMU 120).

In certain examples, IO device 106 includes one or more accelerators (e.g., accelerator circuits 106-0 to 106-N(e.g., where N is any positive integer greater than one, although single accelerator circuit examples may also be utilized)).

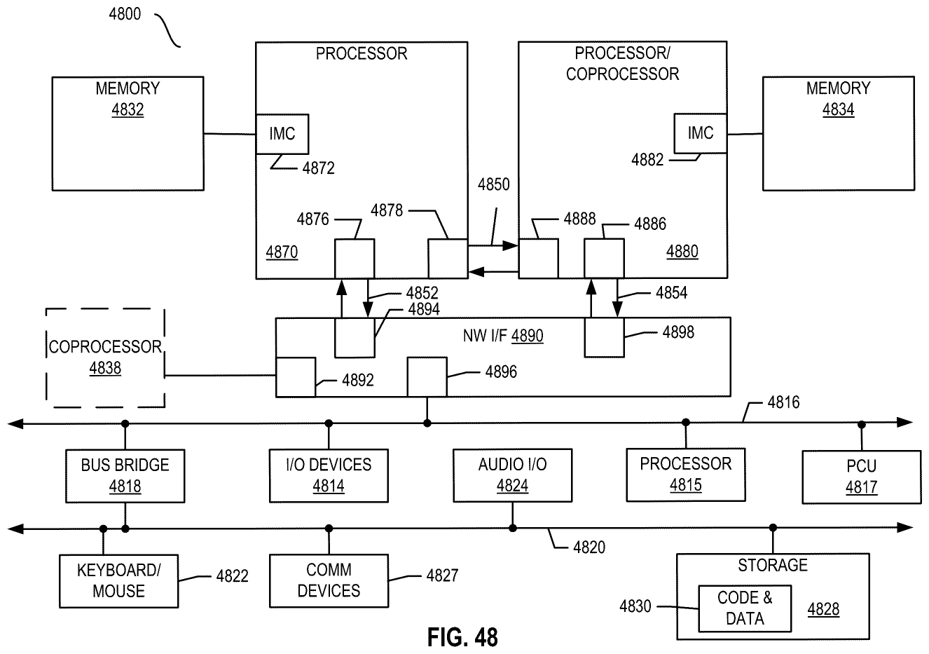

Although the example shown in FIG. 1 of the device 106 is an accelerator, it should be understood that other devices (e.g., non-accelerator devices) can utilized the examples disclosed herein. In the depicted example, a (e.g., each) accelerator circuit 106-0 to 106-N includes a decompressor circuit 124 to perform decompression operations, a compressor circuit 128 to perform compression operations, and a direct memory access (DMA) circuit 122, e.g., to connect to memory 108 and/or internal memory (e.g., cache) of a core. In one example, compressor circuit 128 is (e.g., dynamically) shared by two or more of the accelerator circuits 106-0 to 106-N. In certain examples, the data for a job that is assigned to a particular accelerator circuit (e.g., accelerator circuit 106-0) is streamed in by DMA circuit 122, for example, as primary and/or secondary input. Multiplexers 126 and 132 may be utilized to route data for a particular operation. Optionally, a (e.g., Structured Query Language (SQL)) filter engine 130 may be included, for example, to perform a filtering query (e.g., for a search term input on the secondary data input) on input data, e.g., on decompressed data output from decompressor circuit 124. Device 106 may include a local memory 134, e.g., shared by a plurality of accelerator circuits 106-0 to 106-N. Computer system 100 may couple to a hard drive, e.g., storage 4828 in FIG. 48.

Memory 108 may include operating system (OS) and/or virtual machine monitor code 110, user (e.g., program) code 112, non-trust domain memory 114 (e.g., pages), trust domain memory 116 (e.g., pages), uncompressed data (e.g., pages), compressed data (e.g., pages), or any combination thereof. In certain examples of computing, a virtual machine (VM) is an emulation of a computer system. In certain examples, VMs are based on a specific computer architecture and provide the functionality of an underlying physical computer system. Their implementations may involve specialized hardware, firmware, software, or a combination. In certain examples, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (IO) resources, such as, but not limited to, an input/output memory management unit (IOMMU). The VMM may provide a centralized interface for managing the entire operation, status, and availability of VMs that are installed over a single host machine or spread across different and interconnected hosts.

Memory 108 may be memory separate from a core and/or device 106. Memory 108 may be DRAM. Compressed data may be stored in a first memory device (e.g., far memory) and/or uncompressed data may be stored in a separate, second memory device (e.g., as near memory). A coupling (e.g., input/output (IO) fabric interface 104) may be included to allow communication between device 106, core(s) 102-0 to 102-N, memory 108, etc.

In certain examples, the hardware initialization manager (non-transitory) storage 118 stores hardware initialization manager firmware (e.g., or software). In one example, the hardware initialization manager (non-transitory) storage 118 stores Basic Input/Output System (BIOS) firmware. In another example, the hardware initialization manager (non-transitory) storage 118 stores Unified Extensible Firmware Interface (UEFI) firmware. In certain examples (e.g., triggered by the power-on or reboot of a processor), computer system 100 (e.g., core 102-0) executes the hardware initialization manager firmware (e.g., or software) stored in hardware initialization manager (non-transitory) storage 118 to initialize the system 100 for operation, for example, to begin executing an operating system (OS) and/or initialize and test the (e.g., hardware) components of system 100.

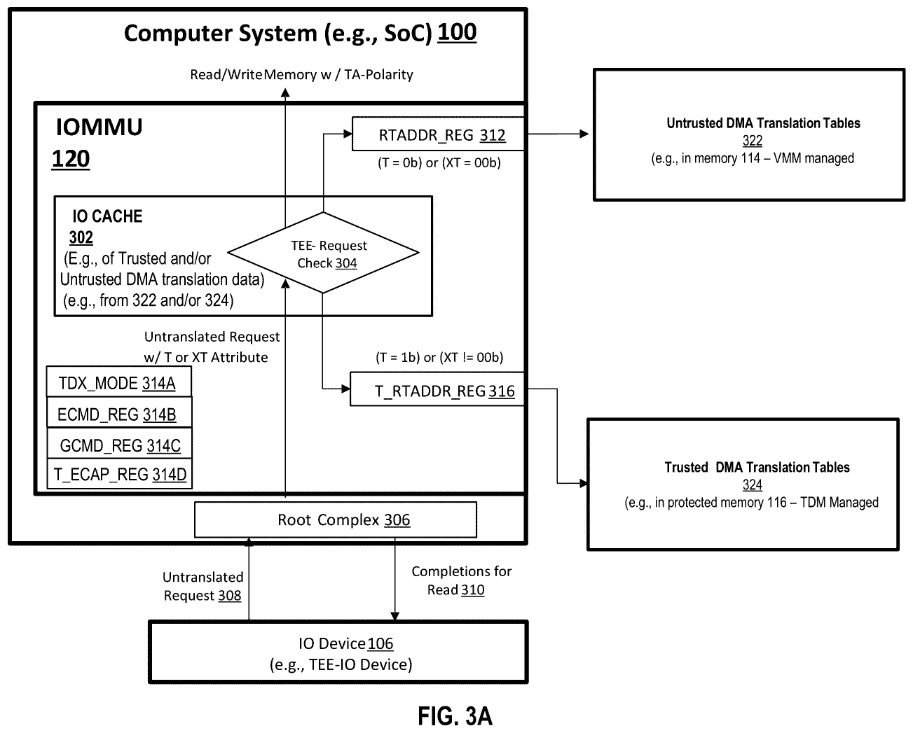

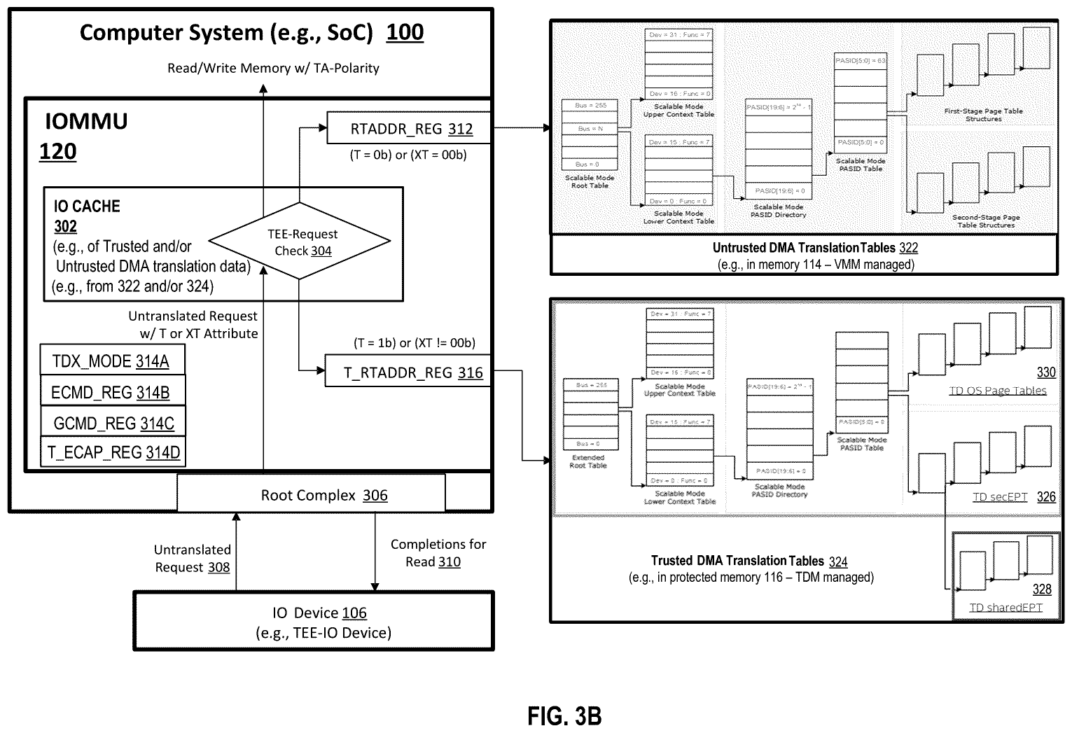

In certain examples, computer system 100 includes an input/output memory management unit (IOMMU) 120 (e.g., circuitry), e.g., coupled between one or more cores 102-0 to 102-N and IO fabric interface 104. In certain examples, IO fabric interface is a Peripheral Component Interface Express (PCIe) interface or a Compute Express Link (CXL) interface. In certain examples, IOMMU 120 provides address translation, for example, from a virtual address to a physical address. In certain examples, IOMMU 120 includes one or more registers 121, for example, data registers and/or control registers (e.g., the registers discussed in reference to FIGS. 3A-45). Example formats for certain registers are discussed below.

A device 106 may include any of the depicted components. For example, with one or more instances of an accelerator circuit 106-0 to 106-N. In certain examples, a job (e.g., corresponding descriptor for that job) is submitted to the device 106 and the device to performs one or more (e.g., decompression or compression) operations. In certain examples, device 106 includes a local memory 134. In certain examples, device 106 is a TEE IO capable device, for example, with the host (e.g., processor including one of more of cores 102-0 to 102-N) being a TEE capable host. In certain examples, a TEE capable host implements a TEE security manager.

In certain examples, a trusted execution environment (TEE) security manager (e.g., implemented by a trust domain manager 101) is to: provide interfaces to the VMM to assign memory, processor, and other resources to trust domains (e.g., trusted virtual machines), (ii) implements the security mechanisms and access controls (e.g., IOMMU translation tables, etc.) to protect confidentiality and integrity of the trust domains (e.g., trusted virtual machines) data and execution state in the host from entities not in the trusted computing base of the trust domains (e.g., trusted virtual machines), (iii) uses a protocol to manage the security state of the trusted device interface (TDI) to be used by the trust domains (e.g., trusted virtual machines), (iv) establishing/managing IDE encryption keys for the host, and, if needed, scheduling key refreshes. TSM programs the IDE encryption keys into the host root ports and communicates with the DSM to configure integrity and data encryption (IDE) encryption keys in the device, (v) or any single or combination thereof.

In certain examples, a device security manager (DSM) 136 is to (i) support authentication of device identities and measurement reporting, (ii) configuring the IDE encryption keys in the device (e.g., where the TSM provide the keys for the initial configuration and subsequent key refreshes to the DSM), (iii) provide device interface management for locking TDI configuration, reporting TDI configurations, attaching, and detaching TDIs to trust domains (e.g., trusted virtual machines), (iv) implements access control and security mechanisms to isolate trust domain (e.g., trusted virtual machine) provided data from entities not in the TCB of a trust domain (e.g., a trusted virtual machine), (v) or any single or combination thereof.

In certain examples, a standard defines a virtual machine monitor (VMM) (e.g., or VM thereof), TSM (e.g., trust domain manager 101), and device security manager (DSM) 136 interaction flow.

In certain examples, IOMMU 120 and trust domain manager(s) 101 cooperate to allow for direct memory access (e.g., directly) between (e.g., to and/or from) IO device(s) 106 and trust domain memory 116 (e.g., a region for only a single trust domain and/or another region shared by a plurality of trust domains).

In order to establish the trust relationship between a device and a TD, certain TDX-IO architectures require the TD and/or a trust domain manager (e.g., circuit and/or code) (e.g., Trusted Execution Environment (TEE) security manager (TSM)) to create a secure communication session between the device and the trust domain manager (e.g., for the trust domain manager to allow a particular trust domain to use the device or a subset of function(s) of the device). In order to establish the trust relationship between a device and a TD, certain TDX-IO architectures require the TD and/or a trust domain manager (e.g., circuit and/or code) (e.g., Trusted Execution Environment (TEE) security manager (TSM)) use (i) a Distributed Management Task Force (DMTF) Secure Protocol and Data Model (SPDM) standard to authenticate the device (e.g., and collect device measurement), and (ii) use a Peripheral Component Interconnect Special Interest Group (PCI-SIG) TEE Device Interface Security Protocol (TDISP) standard (e.g., to communicate with a device security manager (DSM) to manage the device's function(s)).

In certain examples, a SPDM messaging protocol defines a request-response messaging model between two endpoints to perform the message exchanges outlined in SPDM message exchanges, for example, where each SPDM request message shall be responded to with an SPDM response message as defined in the SPDM specification. In certain examples, an endpoint's (e.g., device's) “measurement” describes the process of calculating the cryptographic hash value of a piece of firmware/software or configuration data and tying the cryptographic hash value with the endpoint identity through the use of digital signatures. This allows an authentication initiator to establish that the identity and measurement of the firmware/software or configuration running on the endpoint.

In certain examples, to help enforce the security policies for the TDs, a new mode of a processor called Secure-Arbitration Mode (SEAM) is introduced to host an (e.g., manufacturer provided) digitally signed, but not encrypted, security-services module. In certain examples, a trust domain manager (TDM) 101 is hosted in a reserved, memory space identified by a SEAM-range register (SEAMRR). In certain examples, the processor only allows access to SEAM-memory range to software executing inside the SEAM-memory range, and all other software accesses and direct-memory access (DMA) from devices to this memory range are aborted. In certain examples, a SEAM module does not have any memory-access privileges to other protected, memory regions in the platform, including the System-Management Mode (SMM) memory or (e.g., Intel® Software Guard Extensions (SGX)) protected memory.

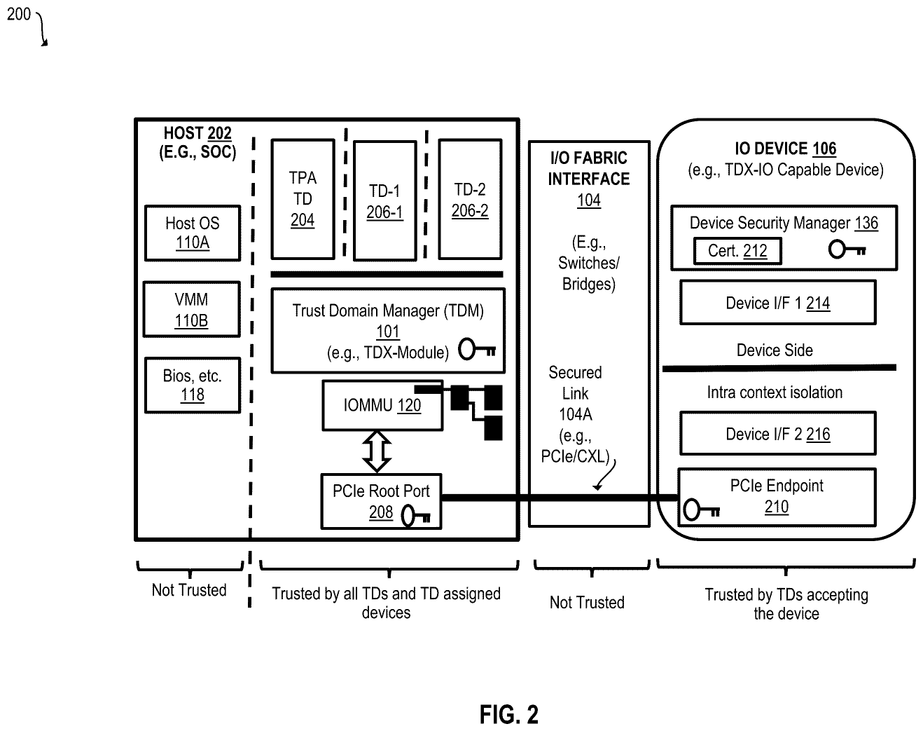

FIG. 2 illustrates a block diagram of a host 202 (e.g., one or more of processor cores 102 in FIG. 1) coupled to an IO device 106 (e.g., TDX-IO capable device) according to examples of the disclosure (e.g., forming a system 200). In certain examples, host 202 implements TDX-IO provisioning agent (TPA) 204 of trust domains, and a plurality of trust domains, shown as trust domain “1” 206-1 and trust domain “2” 206-2, although any single or plurality of trust domains may be implemented. In certain examples, host 202 includes a trust domain manager 101 to manage the trust domains (for example, with the vertical dashed lines indicating isolation therebetween the trust domains, e.g., and host OS 110A, VMM 110B, and BIOS, etc. 118). In certain examples, the virtual machine monitor 110B manages (e.g., generates) one or more virtual machines, e.g., with the trust domain manager 101 isolating a first virtual machine as a first trust domain from a second (or more) virtual machine and second (or more) trust domain(s). In certain examples, the host 202 includes a (e.g., PCIe) root port 208 having a key(s) (shown symbolically) to allow secure communications with the IO device 106, e.g., with the (e.g., PCIe) endpoint 210 thereof (e.g., also having the key(s) (shown symbolically)). In certain examples, the trust domain manager 101 and device security manager 136 are also to have a key(s), e.g., representing a memory protection key(s) and a secure session key(s) respectively.

In certain examples, the host 202 is coupled to device 216 via a coupling 104, e.g., via a secured link 104A (e.g., a link according to a PCIe/Compute Express Link (CXL) standard).

In certain examples, the host 202 is coupled to device 216 according to a transport level (e.g., SPDM) specification and/or an application level (e.g., TDISP) specification. In certain examples, device 106 includes a device security manager (DSM) 136 with a device secret(s), e.g., device certificate 212, session key, device “measurement” values, etc. In certain examples, device 106 implements one or more physical function(s).

In certain examples, device 106 includes a first device interface (I/F) 214 on the device side, and one or more second device interface(s) 216. In certain examples, the device 106 supports intra context isolation between these interfaces.

In certain examples, device 106 (e.g., according to a single-root input/output virtualization (SR-IOV) standard) is shared by a plurality of virtual machines (e.g., trust domains). In certain examples, a physical function has the ability to move data in and out of the device while virtual functions (for example, first virtual function and second virtual function, e.g., where the virtual functions are lightweight (e.g., PCI express (PCIe)) functions that support data flowing but also have a restricted set of configuration resources.

In certain examples, IO device 106 is to perform a direct memory access request to a private memory of a trust domain (e.g., trust domain 206-1 or trust domain 206-2) under the control of the IOMMU 120.

In certain examples, a trust domain has both a private memory (e.g., in trust domain memory 116 in FIG. 1) and a shared memory (e.g., in non-trust domain memory 114 in FIG. 1). In certain examples, DMAs target protected memory (e.g., private memory and shared memory of a trust domain).

Example extensions and changes to the IOMMU 120 with respect to different architectural components are discussed below.

### Trusted Nested DMA-Translation Support in IOMMU

In certain examples, IOMMU 120 (e.g., circuitry) reports Trusted Nested DMA Translation support (TNEST) through a trusted extended capability register (e.g., register 314D).

In certain examples, IOMMU 120 (e.g., circuitry) supports two parallel DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables). In certain examples, DMA-translation tables consist of multi-level tables including scalable-mode root-table, scalable-mode context-table, scalable-mode PASID directory, and scalable-mode PASID table. In a first example, DMA-translation tables are indexed by the PCIe Requester-ID and in a second example, DMA-translation tables are indexed by the PCIe Requester-ID and PASID.

In certain examples, registers (e.g., T_RTADDR_REG) associated with the trusted DMA-translation tables are protected and can only be written with the SEAM Security Attribute of Initiator (SAI). In certain examples, such a protection scheme ensures that only the trust domain manager (e.g., TDX-module) can program these trusted registers and no other untrusted software entities on the platform.

In certain examples, untrusted DMA-translation tables are stored in a regular (e.g., not trust domain) memory and are managed/programmed by the VMM, and trusted DMA-translation tables are stored in the protected memory and are managed/programmed by the trust domain manager (e.g., TDX-module). In certain examples, IOMMU (e.g., circuitry) uses Translation Agent (TA)-polarity of 0b when accessing untrusted DMA-translation tables and TA-polarity of 1b when accessing trusted DMA-translation tables.

In certain examples, DMA-translation tables are programmed with the first-stage page-table pointer, second-stage page-table pointer, or both. In certain examples, first-stage/second-stage page-tables connected via untrusted DMA-translation tables are stored in a regular (e.g., not trust domain) memory and first-stage/second-stage page-tables connected via trusted DMA-translation tables are stored in a protected memory.

In certain examples, IOMMU (e.g., circuitry) uses T attribute of an untranslated request to select between untrusted or trusted DMA-translation tables. For example, where if the T attribute is 0b, IOMMU circuitry translates the untranslated address using the untrusted DMA-translation tables (and/or IO cache 302 that has a copy of the untrusted translation), and if the T attribute is 1b, IOMMU circuitry translates the untranslated address using the trusted DMA-translation tables (and/or IO cache 302 that has a copy of the trusted translation). In certain examples, on the successful translation, the IOMMU circuitry uses the T attribute of request to tag the IOMMU caches and generate final TA-polarity of the DMA read/write request. In certain examples, the final TA-polarity of DMA read/write request is generated as (T attribute of untranslated request & !GPA.SHARED).

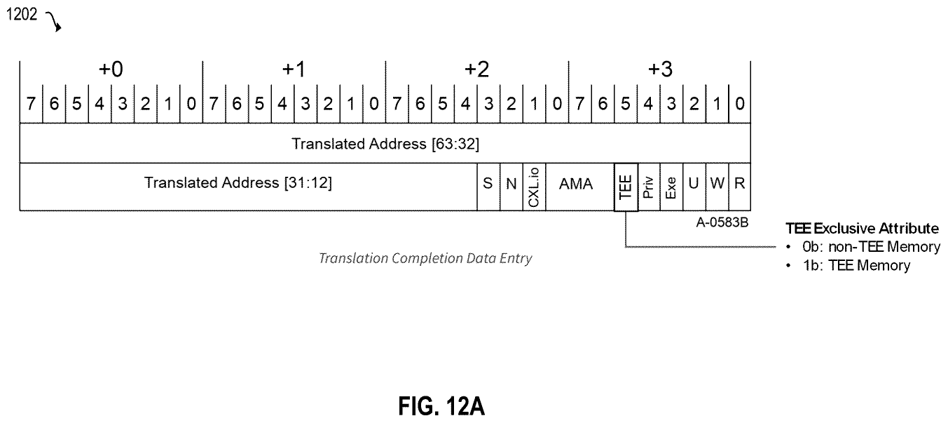

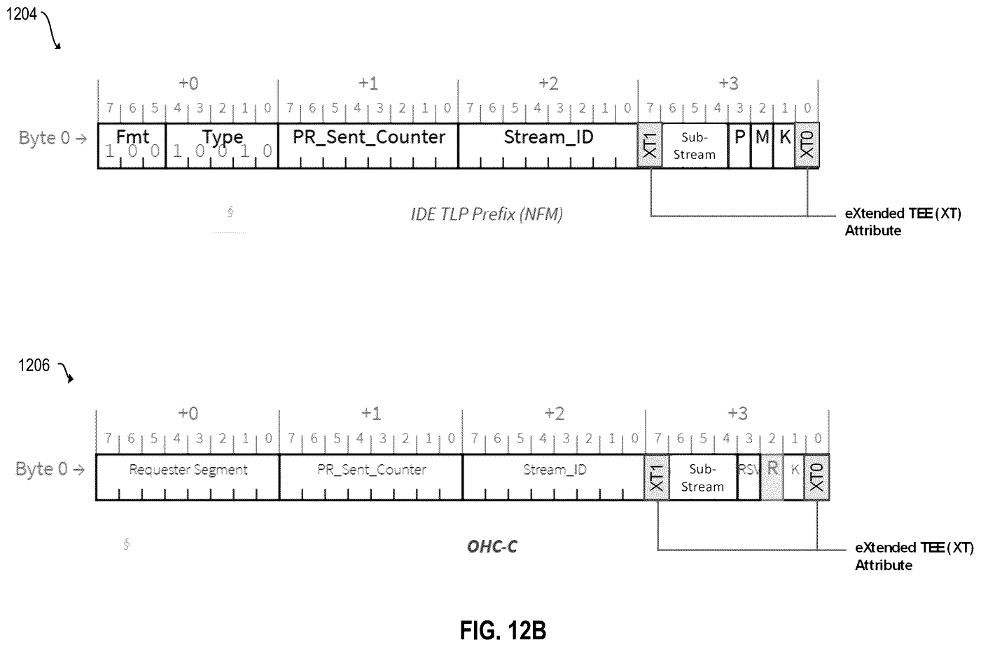

In certain examples, IOMMU (e.g., circuitry) uses an eXtended TEE (XT) attribute (e.g., as shown in FIG. 12B) of an untranslated request to select between untrusted or trusted DMA-translation tables. For example, where if the XT attribute is 00b, IOMMU circuitry translates the untranslated address using the untrusted DMA-translation tables (and/or IO cache 302 that has a copy of the untrusted translation), and if the XT attribute is not 00b, IOMMU circuitry translates the untranslated address using the trusted DMA-translation tables (and/or IO cache 302 that has a copy of the trusted translation). In certain examples, on the successful translation, the IOMMU circuitry uses the XT attribute of the request to tag the IOMMU caches and generate final TA-polarity of the DMA read/write request. In certain examples, the final TA-polarity of DMA read/write request is generated as (Bit-0 of XT attribute of untranslated request & !GPA.SHARED).

In certain examples, the untranslated address is a guest physical address (GPA) which gets translated to a host physical address (HPA) using the trusted DMA-translation tables (e.g., and second-stage page tables).

In certain examples, the untranslated address is a guest virtual address (GVA) which gets translated to a GPA using the (e.g., first-stage) page tables and then gets translated again to a HPA using the (e.g., second-stage) page tables (GVA→GPA→HPA).

In certain examples, the untranslated address is a guest IO virtual address (GIOVA) which gets translated to GPA using (e.g., first-stage) page tables and then gets translated again to HPA using the (e.g., second-stage) page tables (GIOVA→GPA→HPA).

In certain examples, root-complex circuitry uses the same T or XT attribute as the untranslated request to generate the read completions.

FIG. 3A illustrates a block diagram of an IOMMU 120 having an IO cache 302 (e.g., of trusted DMA translation data and/or untrusted DMA translation data) according to examples of the disclosure.

Depicted IO cache 302 includes an input and/or output for a memory access (e.g., read and/or write) request (e.g., from an IO device 106), for example, from root complex 306 of computer system 100. In certain examples, IOMMU utilizes a PCIe root port 208 in FIG. 2.

In certain examples, IO cache 302 is to, for a hit in the IO cache 302 (e.g., its cache of one or more mappings from untrusted DMA translation table 322 and/or from trusted DMA translation tables 324) for an input of an (e.g., virtual) address from the device (e.g., endpoint), output the corresponding host (e.g., physical) address, and/or for a miss in the IO cache 302 (e.g., its cache of mappings) for an input of a (e.g., virtual) address, perform a (e.g., page) walk in memory to determine the corresponding host (e.g., physical) address for that input of address from the device.

However, it may be desirable to not allow an IO device 106 to access protected private memory (e.g., trust domain memory 116 in FIG. 1 and/or any data structure (e.g., mappings and/or translation tables for an IOMMU), register, etc. that has corresponding data for that private memory) unless that request is from (or for) a trusted computing base of the corresponding trust domain. In certain examples, it is desirable to keep a VMM 110B (or OS or other component that is not part of a trust domain) from accessing the private memory as well as any data structure (e.g., mappings and/or translation tables for an IOMMU), register, etc. that has corresponding data for that private memory (e.g., trust domain memory 116 in FIG. 1).

In certain examples, IOMMU 120 maintains a cache 302 of one or more (e.g., a proper subset of) translations from trusted translation tables 324 (e.g., with these cached “trusted” translations also protected by T or XT attribute) and/or one or more (e.g., a proper subset of) translations from untrusted translation tables 322.

In certain examples, a request from TEE-JO device (e.g., marked with T attribute or “ide_t” (e.g., =1) or XT attribute (e.g., !=00b) as discussed herein) (e.g., as checked by check 304) is to be sent to an IO cache 302 of “trusted” translations and/or (e.g., and for a miss in that cache) to a set of trusted translation tables 324 (e.g., also stored within protected memory 116 or within IOMMU 120) (e.g., managed by the trust domain manager 101 (e.g., TDX-module)) that are separate from a set of untrusted translation tables 322 (e.g., in non-trust domain memory 114 or within IOMMU 120) (e.g., managed by the VMM 110B). In certain examples, IOMMU 120 maintains a (e.g., trusted) translation table for each device.

In certain examples, use of separate untrusted translation tables 322 and trusted translation tables 324 means that a separate set of one or more registers is to be utilized for each, for example, with “non-trusted” root table address register 312 storing the pointer for the base address of the non-trusted root table in untrusted translation tables 322 and trusted root table address register (T_RTADDR_REG) 316 storing the pointer for the base address of the trusted root table in trusted translation tables 324 (e.g., where a root table stores a plurality of root entries and each root entry contains a context table pointer to reference the context table for the IO device).

In certain examples, a request for non-TEE-JO device (e.g., marked with T attribute or “ide_t” (e.g., =0) or XT attribute (e.g., =00b) as discussed herein) (e.g., as checked by check 304) is to be sent to an IO cache 302 of “untrusted” translations and/or (e.g., and for a miss in that cache) to be sent to a set of untrusted translation tables 322 (e.g., stored in non-trust domain memory 114).

FIG. 3B illustrates a block diagram of translation tables 322 and trusted translation tables 324 for the IOMMU of FIG. 3A according to examples of the disclosure. In certain examples, the hierarchy of performing a page walk is as shown in FIG. 3B, e.g., to output a corresponding physical address for an input of a virtual address (e.g., guest virtual or physical address for a trust domain). In certain examples, trusted translations tables 324 includes a secure extended page table (secEPT) 326 (for example, per TD key (e.g., TD KeyID)) for a private memory of a trust domain and/or a shared extended page table (sharedEPT) 328 for a protected memory shared (i) between multiple trust domains (e.g., but shared EPT cannot provide TD KeyID) and/or (ii) with the virtual machine monitor 110B.

Certain I/O memory controllers (e.g., IOMMU 120) (e.g., in Scalable Mode as discussed below in reference) allow IO devices to access memory using the virtual address (VA) in the DMA requests (e.g., with or without a process address space identifier (PASID) prefix). In certain examples, I/O memory controller (e.g., IOMMU) translates a VA to a corresponding physical address (PA) using a PASID configured in the translation tables or using a PASID received in the DMA request.

In certain examples, I/O memory controller (e.g., IOMMU 120) pushes a translation into built-in IO cache (e.g., the data storage therein that stores the virtual address to physical address mappings) after a successful page table walk.

In certain examples, translation tables 322 (e.g., a copy thereof stored in IOMMU 120 and/or IO cache 302) includes a DMA remapping structure (e.g., that starts with a root table) according to examples of the disclosure. Depicted (scalable) root table includes a bus entry (e.g., 0 to 255) that points to an entry for a device (e.g., function) in (upper or lower scalable) context table that points to a PASID directory whose entry then points to a PASID table whose entry contains a value that includes a first-stage page table (FSPT) pointer and/or a second-stage page table (SSPT) pointer.

In certain examples, trusted translation tables 324 (e.g., a copy thereof stored in IOMMU 120 and/or IO cache 302) includes a DMA remapping structure (e.g., that starts with a root table) according to examples of the disclosure. Depicted (scalable) root table includes a bus entry (e.g., 0 to 255) that points to an entry for a device (e.g., function) in (e.g., lower or upper scalable) context table that points to PASID directory whose entry then points to a PASID table whose entry contains a value that includes a pointer to a secure extended page table (secEPT) 326 (for example, that maps memory protected using a TD key (e.g., TD KeyID)) or a combination of secEPT and a shared extended page table (sharedEPT) 328 (e.g., that maps TD's private and shared memory).

In certain examples, each inbound request appearing at the address-translation hardware (e.g., IOMMU 120) is required to identify the device originating the request. The (e.g., 16 bit) attribute identifying the originator of an I/O transaction may be referred to as the source ID. In certain examples, for PCI Express (PCIe) devices, the source ID is the requester identifier in the PCI Express transaction layer header in certain examples, e.g., where the requester identifier of a device, which is composed of its PCI Bus number/Device number/Function number, is assigned by configuration software, and uniquely identifies the hardware function that initiated the request.

In certain examples, TDX-IO framework (e.g., as shown in the figures) enables heterogenous confidential computing with secure, efficient, and low-overhead data movement to/from IO-agents. In certain examples, IOMMU enables direct device assignment of PCIe TDIs (Trusted Execution Environment Device Interfaces) to the TDs. In certain examples, the IOMMU supports trusted DMAs to TD's private memory using nested page-tables, supports new architectural states for IOMMU's trusted DMA-translation table entries, supports PCIe Address Translation Services (ATS), support PCIe Page Request Services (PRS), supports TEE-Polarity of Completer (TPC), and/or supports eXtended TEE (XT) mode.

In certain examples, a system (e.g., IOMMU) uses a state machine, e.g., to manage one or more states for an entry in the trusted translation tables of the IOMMU.

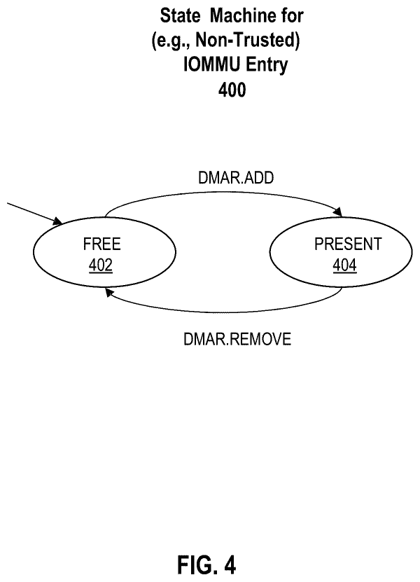

FIG. 4 illustrates a state machine 400, having (e.g., only) a free state 402 and a present (e.g., active) state 404, for an entry of an IOMMU (e.g., IO cache thereof) according to examples of the disclosure. In certain examples, an entry can be in only (i) a “free” state 402 (e.g., the entry is available to be used for a translation) or (ii) a “present” state 404 (e.g., the entry contains a translation). In certain examples, a DMAR.ADD request adds an entry to the trusted translation tables and a DMAR.REMOVE request removes (e.g., invalidates) an entry from the trusted translation tables. In certain examples, the requests are from a virtual machine monitor (VMM).

### Architectural States for IOA&U's Trusted DMA-Translation Table Entry

However, in certain examples, it may be desirable to have different and/or additional states than those states (or their equivalents) shown in FIG. 4. In certain examples, a trust domain (TD) needs to be able to authenticate the IO (e.g., TEE-IO) device (e.g., to check that it should be allowed to have access to a trust domain private memory) and/or verify the device configurations before allowing it to be part of its TCB. In certain examples, trust domain manager (e.g., TDX-module) and IOMMU should not allow TEE-IO device to access TD's private memory without the TD's approval.

In certain examples, once TEE-IO device has been accepted in TD's TCB and performs DMAs, various IOMMU caches 302 will get populated (e.g., an IO TLB, first-stage/second-stage paging structure caches, etc., see, e.g., cache 302 storing a copy of certain (e.g., most recently used) data of the tables 324 in FIG. 3B). In certain examples, a state machine provides states that allow for a secure way for flushing one or more (e.g., all) of these caches when the tables (e.g., tables 324) (e.g., first-stage/second-stage page-tables) are updated and/or when the TEE-IO device is removed from a TD.

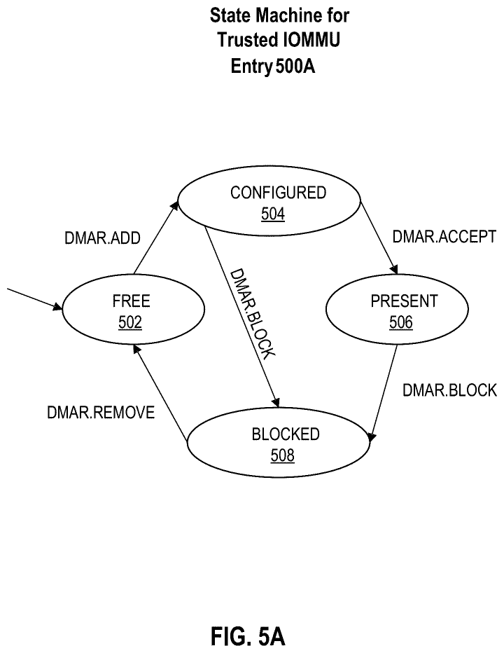

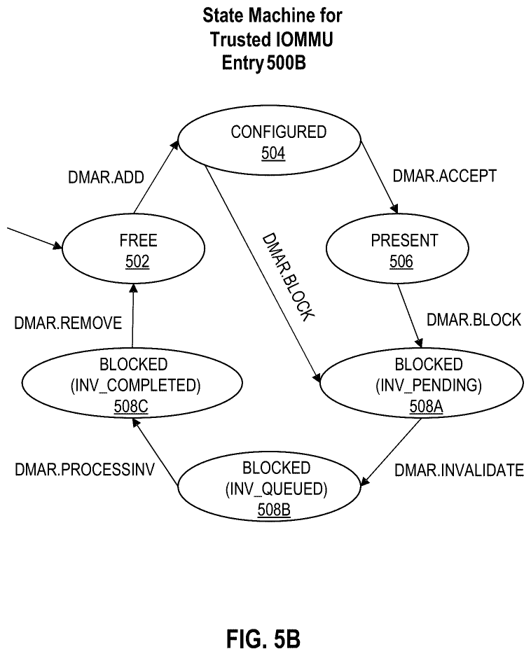

FIG. 5A illustrates a state machine 500A, having a free state 502, configured state 504, present (e.g., active) state 506, and a blocked state 508 for an (e.g., each) entry of a trusted translation tables of the IOMMU according to examples of the disclosure. In certain examples, an entry can be in only one of these states. In certain examples, free state 502 is where the entry is available for use (no translation is present), configured state 504 is where the entry is configured, but is not active/present (e.g., cannot be used to generate a translation), present state 506 is where the entry is active/present, and blocked state 508 is where an entry is blocked (e.g., blocked from certain uses).

In certain examples, a DMAR.ADD request adds an entry to the trusted translation tables of the IOMMU, a DMAR.ACCEPT request transitions a configured entry to active use where the entry can be used to generate a translation, a DMAR.BLOCK request is to block certain uses of a translation, and a DMAR.REMOVE request removes (e.g., invalidates) an entry from the trusted translation tables of the IOMMU. In certain examples, the requests are from a virtual machine monitor (VMM) (e.g., DMAR.ADD request, DMAR,BLOCK request, DMAR.REMOVE request) or from a trust domain (e.g., DMAR.ACCEPT request).

In certain examples, use of a CONFIGURED state enables (i) trust domain manager (e.g., TDX-module) to create and/or configure the corresponding DMA-translation table entry without making it active and/or operational, and/or (ii) a TD to authenticate an IO (e.g., TEE-IO) device and verify configuration of DMA-translation table (e.g., working with trust domain manager) and request the entry to transition to a PRESENT state.

In certain examples, use of one or more BLOCKED states enables trust domain manager (e.g., TDX-module) to (i) block an entry (e.g., block it from being used to provide a translation), (ii) queue invalidations, and/or (iii) process queued invalidations before removing and/or re-purposing an entry.

In certain examples, the entry is cached in the IO cache 302 during the address translation (e.g., page walk) only when in the entry is in the PRESENT state.

FIG. 5B illustrates a state machine 500B, having a free state 502, configured state 504, present (e.g., active) state 506, blocked state (invalidation pending) 508A, blocked state (invalidation queued) 508B, and blocked state (invalidation completed) 508C for an (e.g., each) entry of a trusted IOMMU (e.g., trusted IO cache thereof) according to examples of the disclosure. In certain examples, free state 502 is where the entry is available for use (no translation is present), configured state 504 is where the entry is configured, but is not active/present (e.g., cannot be used to generate a translation), present state 506 is where the entry is active/present, blocked state (invalidation pending) 508A is where the entry is made inactive (e.g., via the trust domain manager) but an invalidation request is not yet queued (e.g., in trusted invalidation queue 1010), blocked state (invalidation queued) 508B is where an invalidation request for an entry is queued (e.g., in trusted invalidation queue 1010) but not yet completed, and blocked state (invalidation completed) 508C where the invalidation of the entry is completed.

In certain examples, a blocked (inv_pending) state 508A is where the entry is blocked, but the invalidations associated with blocking the entry are pending. In certain examples, these invalidations are to invalidate the IO cache and/or to invalidate the cached entries of the trusted translation tables. In certain examples, a blocked (inv_queued) state 508B is where the entry is blocked and invalidations are queued, but the invalidations may not have been processed yet. In certain examples, blocked (inv_completed) state 508C is where the entry is blocked, and invalidations associated with blocking the entry are also completed.

In certain examples, a DMAR.ADD request adds an entry to the trusted translation tables of the IOMMU, a DMAR.ACCEPT request transitions a configured entry to active use where the entry can be used to generate a translation, a DMAR.BLOCK request is to block certain uses of (e.g., access to) a translation (e.g., depending on the status of the invalidation of the entry) (e.g., so that invalidation can begin), DMAR.INVALIDATE request is to queue the invalidation request (e.g., in trusted invalidation queue 1010) and block certain uses of (e.g., access to) a translation (e.g., depending on the status of the invalidation of the entry), DMAR.PROCESSINV request is to process a queued invalidation request (e.g., from trusted invalidation queue 1010) and block any use of (e.g., access to) a translation, and a DMAR.REMOVE request removes (e.g., invalidates) an entry from the trusted translation tables of the IOMMU. In certain examples, the requests are from a virtual machine monitor (e.g., DMAR.ADD request, DMAR.BLOCK request, DMAR.INVALIDATE request, DMAR.PROCESSINV request, DMAR.REMOVE request) or from a trust domain (e.g., DMAR.ACCEPT request).

In certain examples, these states are implemented for a scalable-mode PASID table entry. The following tables 1A and 1B map examples of these states and specifies example IOMMU behavior on an incoming DMA transaction.

TABLE 1A
Scalable-Mode PASID-Table Entry Format

| Scalable-Mode | | |
|---|---|---|
| PASID-Table | | |
| Entry State | Bit Encoding | Remarks |
| FREE | Bit 0-0; | DMAs cannot access TD's memory |
| | Bit 9-0; | (e.g., there is no active translation |
| | Bit 10-0 | through this entry) |
| CONFIGURED | Bit 0-0; | DMAs cannot access TD's memory |
| | Bit 9-1; | (e.g., IOMMU (e.g. circuitry) |
| | Bit 10-0 | cannot use the entry for the |
| | | address translation) |
| PRESENT | Bit 0-1; | DMAs can access TD's memory |
| | Bit 9-0; | (e.g., IOMMU (e.g. circuitry) |
| | Bit 10-0 | can use the entry for the |
| | | address translation) (e.g., |
| | | if valid translation is found) |
| BLOCKED | Bit 0-1; | DMAs may or may not be able to |
| | Bit 9-0; | access TD's memory (e.g., |
| | Bit 10-1 | depending upon invalidation-state) |

TABLE 1B
Scalable-Mode PASID-Table Entry Format
for BLOCKED (e.g., sub) states

| Scalable-Mode | | |
|---|---|---|
| PASID-Table | | |
| Entry (BLOCKED | | |
| Sub-State) | Bit Encoding | Remarks |
| BLOCKED | Bit 80-0; | DMAs can access TD's |
| (INV_PENDING) | Bit 81-0 | memory (e.g., IOMMU (e.g., |
| | | circuitry) can use the |
| | | entry for the address |
| | | translation if the cached |
| | | entry is found) |
| BLOCKED | Bit 80-1; | DMAs can access TD's |
| (INV_QUEUED) | Bit 81-0 | memory (e.g., IOMMU (e.g., |
| | | circuitry) can use the |
| | | entry for the address |
| | | translation if the cached |
| | | entry is found) |
| BLOCKED | Bit 80-1; | DMAs cannot access TD's |
| (INV_COMPLETED) | Bit 81-1 | memory (e.g., IOMMU (e.g., |
| | | circuitry) cannot use the |
| | | entry for address translation) |

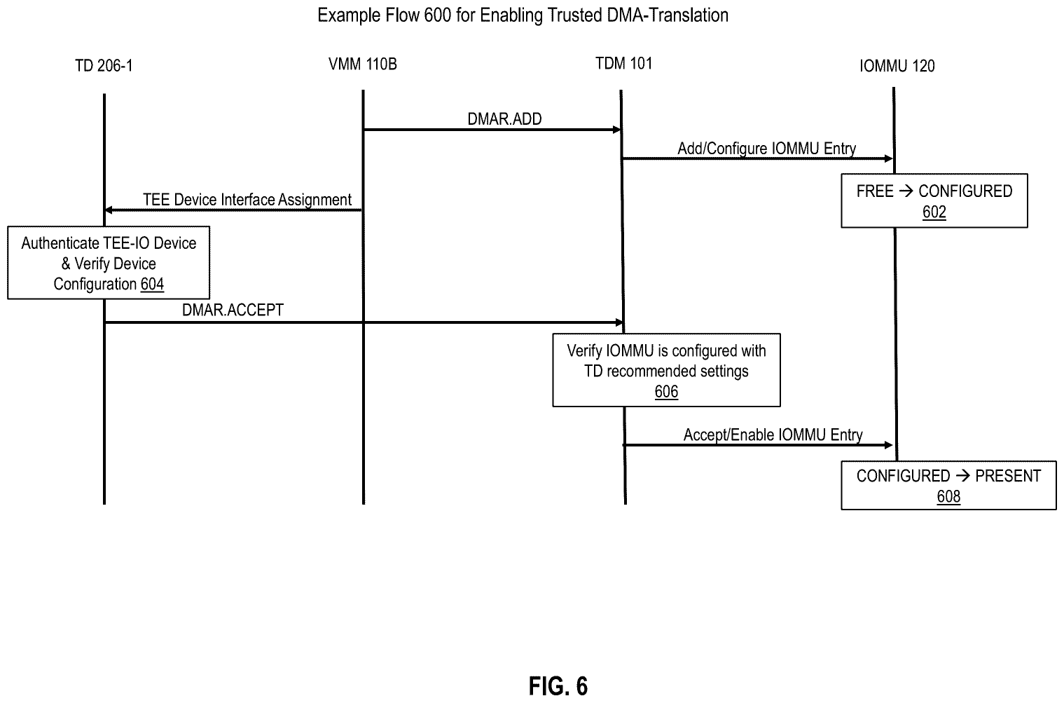

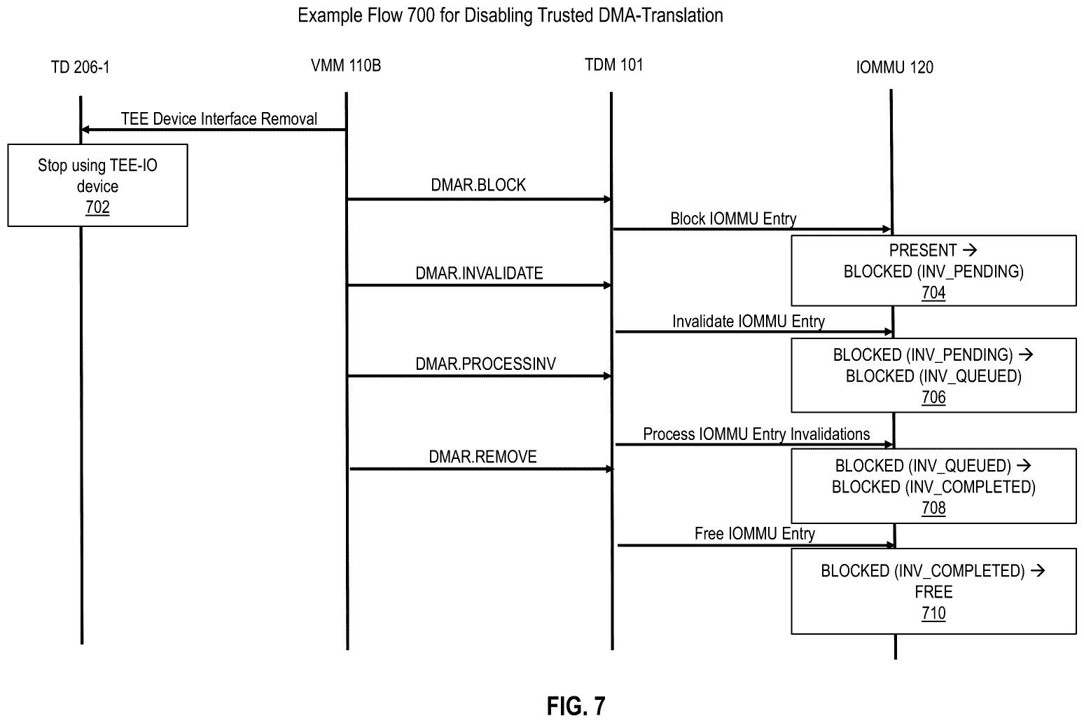

The following discussion of FIGS. 6-7 shows example flows for enabling and disabling Trusted DMA-Translation and state transitions for the IOMMU entry, respectively.

In certain examples, the trust domain (TD) is required to communicate with the VMM 110B (e.g., the TD is not allowed direct communication with the IOMMU), so the VMM 110B is to send requests to the TDM, and the TDM is then to communicate with the IOMMU on behalf of the VMM and/or TD.

FIG. 6 is a flow 600 diagram for enabling a trusted direct memory access (trusted DMA) translation for an IO device according to examples of the disclosure. Depicted flow 600 includes VMM 110B sending an add entry request (e.g., DMAR.ADD) from VMM 110B to trust domain manager (TDM) 101, and, in response, the TDM 101 adding/configuring an IOMMU entry based on this request for IOMMU 120 (e.g., and a corresponding transition for that entry from free to configured at 602). Depicted flow 600 includes VMM 110B sending (e.g., concurrently with the DMAR.ADD) an indication to the trust domain (TD) 206-1 to cause the TD 206-1 to authenticate an IO (e.g., TEE-IO) device and/or verify that device's configuration at 604), and, in response to authentication/verification, the TD 206-1 sending an indication (e.g., DMAR.ACCEPT) that the IO device is to be accepted into the trust domain (e.g., to allow the IO device to access that TD's memory/caches) to the TDM 101 (and if not authenticated/verified, to not proceed with the enabling of this trusted DMA translation entry). Depicted flow 600 includes, in response to the indication (e.g., DMAR.ACCEPT) that the IO device is to be accepted into the trust domain, the TDM 101 verifying if the IOMMU is configured with the TD's recommended settings at 602, and if verified, to accept/enable IOMMU entry for the translation for the IOMMU 120 (e.g., and a corresponding transition for that entry from configured to present at 606) (and if not verified, to not proceed with the enabling of this trusted DMA translation entry).

FIG. 7 is a flow 700 diagram for disabling a trusted direct memory access (trusted DMA) translation for an IO device according to examples of the disclosure. Depicted flow 700 includes VMM 110B sending a “block entry” request (e.g., DMAR.BLOCK) from VMM 110B to trust domain manager (TDM) 101, and, in response, the TDM 101 blocking an IOMMU entry based on this request for IOMMU 120 (e.g., and a corresponding transition for that entry from present to blocked (invalidation pending) at 704), then the VMM 110B sending an invalidate entry request (e.g., DMAR.INVALIDATE) from VMM 110B to trust domain manager (TDM) 101, and, in response, the TDM 101 sending an invalidate the IOMMU entry request to IOMMU 120 (e.g., and a corresponding transition for that entry from blocked (invalidation pending) to blocked (invalidation queued) at 706), then the VMM 110B sending a process the invalidation of the entry request (e.g., DMAR.PROCESSINV) from VMM 110B to trust domain manager (TDM) 101, and, in response, the TDM 101 then processing the completed IOMMU entry invalidation request for IOMMU 120 (e.g., and a corresponding transition for that entry from blocked (invalidation queued) to blocked (invalidation completed) at 708), and then the VMM 110B sending a remove entry request (e.g., DMAR.REMOVE) from VMM 110B to trust domain manager (TDM) 101, and, in response, the TDM 101 then freeing the IOMMU entry based on this request for IOMMU 120 (e.g., and a corresponding transition for that entry from blocked (invalidation completed) to free at 710). Depicted flow 700 includes VMM 110B sending (e.g., concurrently with the DMAR.BLOCK) an indication to the trust domain (TD) 206-1 to cause the TD 206-1 to stop using the IO (e.g., TEE-JO) device at 702.

In certain examples, a state machine does not include the configured state. In certain examples, IOMMU's (e.g., IO cache's) non-leaf entries (e.g., scalable-mode root-table entry, scalable-mode context-table entry, and scalable-mode PASID directory entry, e.g., as shown in trusted DMA translation tables 324 in FIG. 3B) do not utilize a configured state, e.g., since the PRESENT state for these entries does not implicitly provide access to TD's memory unless the leaf entry (e.g. scalable-mode PASID-table entry, e.g., as shown in trusted DMA translation tables 324 in FIG. 3B) is also PRESENT, the TDM (e.g., TDX-module) is allowed to configure and make these entries present and only make the leaf entry present after the TD's approval. In certain examples, a blocked state is used for non-leaf entries to be able to track invalidations for them, as they may be cached in the IOMMU's caches. In certain examples, a leaf entry (e.g., the scalable-mode PASID-table entry) utilizes a state machine as discussed in FIGS. 5A-5B (e.g., utilizing a configured state).

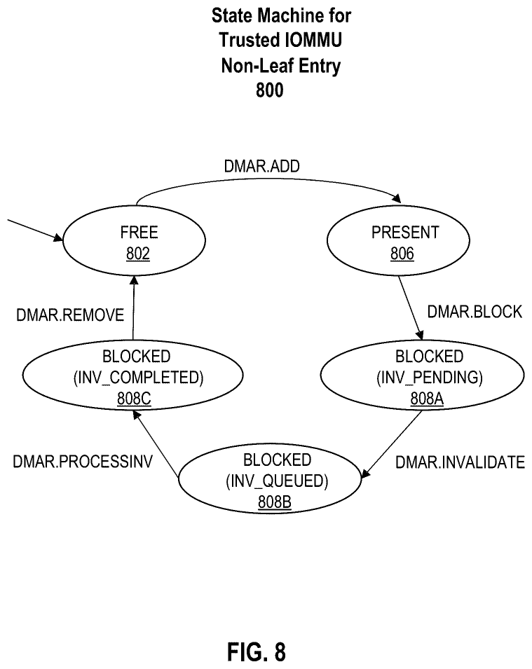

FIG. 8 illustrates a state machine 800, having a free state 802, present state 806, and a plurality of blocked states 808A-808B, for a non-leaf entry of a trusted IOMMU according to examples of the disclosure. In certain examples, free state 802 is where the entry is available for use (no translation is present), present state 806 is where the entry is active/present, blocked state (invalidation pending) 808A is where the entry is made inactive (e.g., via the trust domain manager) but an invalidation request is not yet queued (e.g., in trusted invalidation queue 1010), blocked state (invalidation queued) 808B is where an invalidation request for an entry is queued (e.g., in trusted invalidation queue 1010) but not yet completed, and blocked state (invalidation completed) 808C where the invalidation of the entry is completed.

In certain examples, a blocked (inv_pending) state 808A is where the entry is blocked, but the invalidations associated with blocking the entry are pending. In certain examples, these invalidations are to invalidate the IO cache and/or to invalidate the cached entries of the trusted translation tables. In certain examples, a blocked (inv_queued) state 808B is where the entry is blocked and invalidations are queued, but the invalidations may not have been processed yet. In certain examples, blocked (inv_completed) state 808C is where the entry is blocked, and invalidations associated with blocking the entry are also completed.

In certain examples, a DMAR.ADD request adds an entry to the trusted translation tables, a DMAR.BLOCK request is to block certain uses of (e.g., access to) a translation (e.g., depending on the status of the invalidation of the entry) (e.g., so that invalidation can begin), DMAR.INVALIDATE request is to queue the invalidation request (e.g., in trusted invalidation queue 1010) and block certain uses of (e.g., access to) a translation (e.g., depending on the status of the invalidation of the entry), DMAR.PROCESSINV request is to process a queued invalidation request (e.g., from trusted invalidation queue 1010) and block any use of (e.g., access to) a translation, and a DMAR.REMOVE request removes (e.g., invalidates) an entry from the trusted translation tables. In certain examples, the requests are from a virtual machine monitor (VMM).

### Trusted ATS Support in IOMMU

In certain examples, IOMMU 120 (e.g., circuitry) reports Trusted ATS Translation support (TDT) through a trusted extended capability register (e.g., register 314D).

In certain examples, IOMMU 120 (e.g., circuitry) supports two parallel DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables).

In certain examples, DMA-translation tables are programmed with the first-stage page-table pointer, second-stage page-table pointer, or both. In certain examples, first-stage/second-stage page-tables connected via untrusted DMA-translation tables are stored in a regular (e.g., not trust domain) memory and first-stage/second-stage page-tables connected via trusted DMA-translation tables are stored in a protected memory.

In certain examples, IOMMU (e.g., circuitry) uses the T attribute of an ATS translation request to select between untrusted or trusted DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables). In certain examples, if the T attribute is 0b, IOMMU (e.g., circuitry) translates the untranslated address using the untrusted DMA-translation tables 322 (and/or IO cache 302 that has a copy of the untrusted translation). In certain examples, if T attribute is 1b, IOMMU (e.g., circuitry) translates the untranslated address using the trusted DMA-translation tables 324 (and/or IO cache 302 that has a copy of the trusted translation).

In certain examples, IOMMU (e.g., circuitry) uses the XT attribute of an ATS translation request to select between untrusted or trusted DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables). In certain examples, if the XT attribute is 00b, IOMMU (e.g., circuitry) translates the untranslated address using the untrusted DMA-translation tables 322 (and/or IO cache 302 that has a copy of the untrusted translation). In certain examples, if the XT attribute is not 00b, IOMMU (e.g., circuitry) translates the untranslated address using the trusted DMA-translation tables 324 (and/or IO cache 302 that has a copy of the trusted translation).

In certain examples, IOMMU (e.g., circuitry) uses the same T or XT attribute as an ATS translation request to generate the ATS translation completion.

In certain examples, IOMMU (e.g., circuitry) uses T attribute of ATS translated request to select between the untrusted or trusted DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables). In certain examples, on the successful translation enable check, IOMMU (e.g., circuitry) to generate the final TA-polarity of the DMA read/write request. In certain examples, the final TA-polarity of DMA read/write request is generated as (T attribute of translated request & IS_TEE_PAGE(HPA)).

In certain examples, IOMMU (e.g., circuitry) uses untrusted host physical address (HPA) permission table (HPT) to validate ATS translated request with the T attribute of 0b and trusted HPA permission table (HPT) to validate ATS translated request with the T attribute of 1b.

In certain examples, IOMMU (e.g., circuitry) uses XT attribute of ATS translated request to select between the untrusted or trusted DMA-translation tables, e.g., table 322 representing the device interfaces assigned to certain VMs (e.g., referred to as untrusted DMA-translation tables) and table 324 representing the device interfaces assigned to TDs (e.g., referred to as trusted DMA-translation tables). In certain examples, on the successful translation enable check, IOMMU (e.g., circuitry) to generate the final TA-polarity of the DMA read/write request. In certain examples, the final TA-polarity of DMA read/write request is generated as (Bit-0 of XT attribute of untranslated request & IS_TEE_PAGE(HPA)).

In certain examples, IOMMU (e.g., circuitry) uses untrusted host physical address (HPA) permission table (HPT) to validate ATS translated request with the XT attribute as 00b and trusted HPA permission table (HPT) to validate ATS translated request with the XT attribute as not 00b.

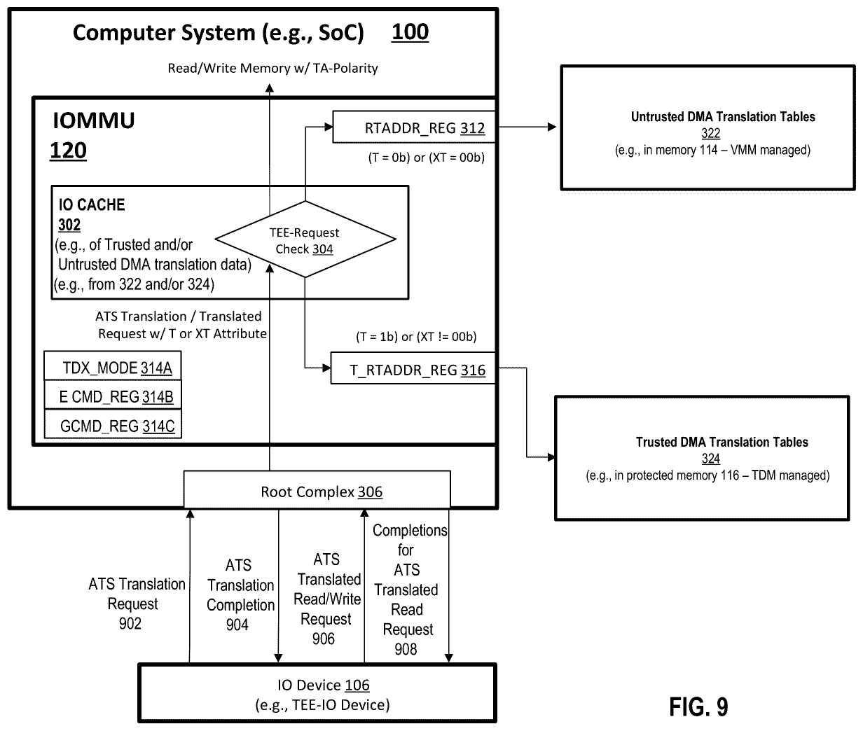

FIG. 9 illustrates a block diagram of an IOMMU 120 that supports trusted address translation services (trusted ATS) according to examples of the disclosure. In certain examples, IO device 106 sends an ATS translation request 902 (e.g., with T or XT attribute and/or the guest (e.g., virtual) address for data to be accessed by the IO device 106) to computer system 100 (e.g., IOMMU 120 thereof), computer system 100 (e.g., IOMMU 120) sends an ATS translation completion 904 to IO device 106 (e.g., indicating the host (e.g., physical) address of that data to be accessed by the IO device 106). In certain examples, IO device 106 sends an ATS translated access (e.g., read and/or write) request 906 (e.g., with T or XT attribute and/or the host (e.g., physical) address for data to be accessed by the IO device 106) to computer system 100 (e.g., IOMMU 120 thereof), computer system 100 (e.g., IOMMU 120) performs the access check for the request, and then sends completion(s) for the ATS translated access (e.g., read) request 908 to IO device 106.

In certain examples, register's access policy groups are changed for security, e.g., when in the TDX_MODE of operation. In certain examples, an IOMMU includes a trusted root table address register (T_RTADDR_REG) 316, a register (TDX_MODE_REG) 314A to set the IOMMU 120 into (or out of) TDM (e.g., TDX) mode, an enhanced command register (ECMD_REG) 314B as an interface to submit an enhanced command (e.g., to place it into or out of TDX mode) to the IOMMU, and/or a global command register (GCMD_REG) 314C to submit global commands for IOMMU memory.

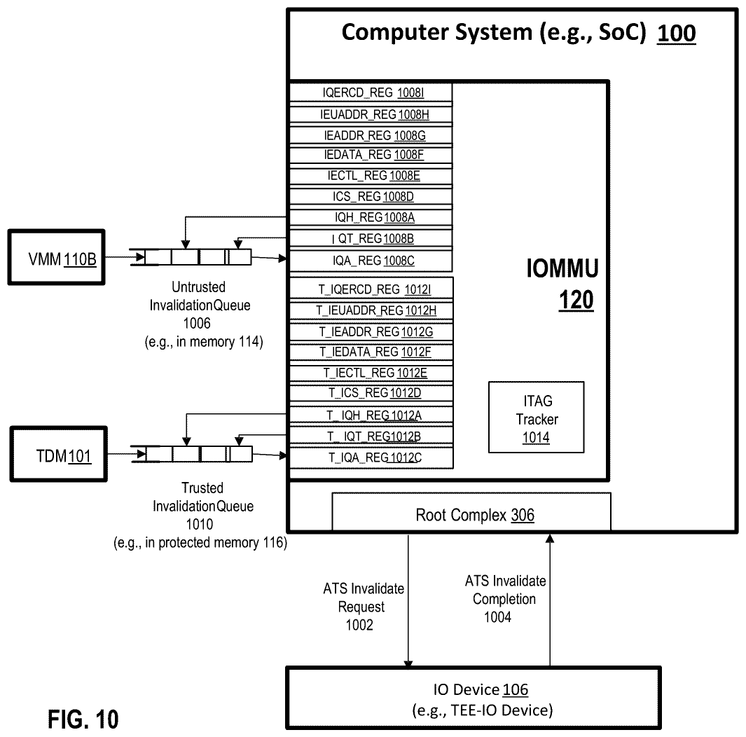

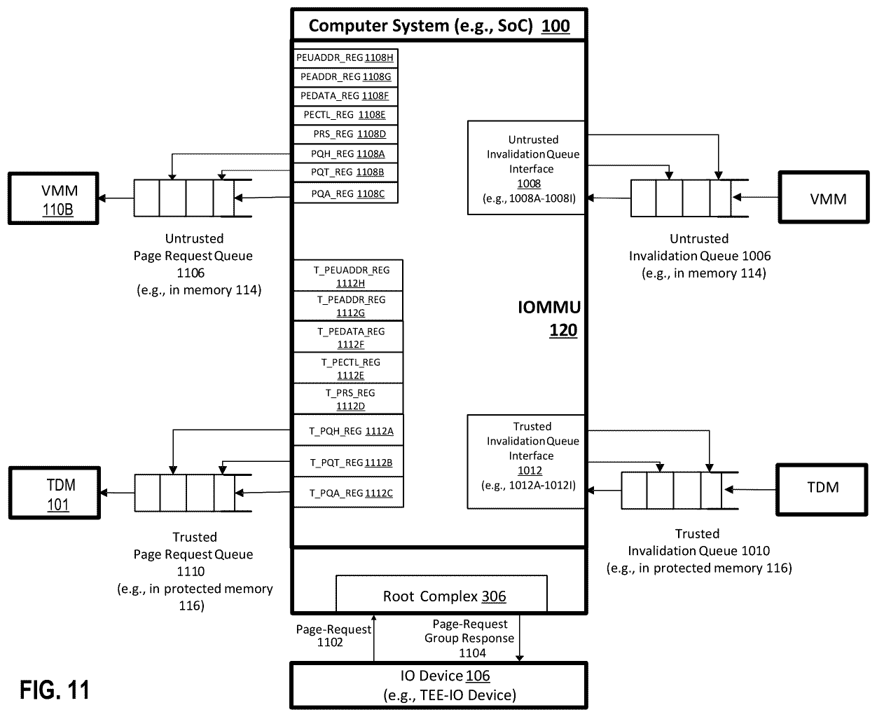

In certain examples, registers include a control register (TDX_MODE) 314A (e.g., within IOMMU 120) to set the IOMMU 120 within TDM (e.g., TDX) mode, e.g., to use register 316, registers in FIG. 10, registers in FIG. 11, and/or trusted tables 324 (e.g., when the T attribute is 1b or the XT attribute is not 00b). In certain examples, registers include a command register (ECMD_REG) 314B (e.g., within IOMMU 120) to send (e.g., and store) a command to the IOMMU 120, e.g., a command to enable/disable the TDX-mode, etc. In certain examples, registers include a global command register (GCMD_REG) 314C (e.g., within IOMMU 120) to store a global command to the IOMMU 120, e.g., a command to perform a global reset (e.g., to clear all the blocks (e.g., pages) in memory).

In certain examples, a “standard” command, register, etc. refers to a command, register, etc. that is not used for a trust domain, e.g., not used to implement input/output extensions for trust domains.

### Trusted Invalidation Support in IOMMU

In certain examples, IOMMU 120 (e.g., circuitry) supports two parallel invalidation queues, e.g., untrusted invalidation queue 1006 (e.g., stored in memory 114) for queuing invalidations associated with the device interfaces assigned to certain (e.g., legacy) VMs and trusted invalidation queue 1010 (e.g., stored in memory 116) for queuing invalidations associated with device interfaces assigned to trust domains (e.g., trusted VMs).

In certain examples, the untrusted invalidation queue 1006 is stored in a regular (e.g., not trust domain) memory and is managed by the VMM 110B, and the trusted invalidation queue 1010 is stored in a protected (e.g., trust domain) memory and is managed by the trust domain manager 101 (e.g., TDX-module).

In certain examples, the IOMMU 120 (e.g., circuitry) supports two separate sets of registers that are associated with each invalidation queue. In certain examples, registers associated with the trusted invalidation queue are protected and can only be written by the trust domain manager (e.g., with the SEAM SAI).

In certain examples, the IOMMU 120 (e.g., circuitry) uses the T attribute of 0b (or XT attribute of 00b) on ATS invalidate request, when processing the DevTLB invalidation descriptor queued in the untrusted invalidation queue 1006 and uses the T attribute of 1b (or XT attribute of 01b) on ATS invalidate request, when processing the DevTLB invalidation descriptor queued in the trusted invalidation queue 1010.

In certain examples, the IOMMU 120 (e.g., circuitry) compares the T (or XT attribute) of ATS invalidate completion against the original T (or XT attribute) of ATS invalidate request, and only treats it as a valid completion when the attributes are matching. In certain examples, this is achieved by maintaining/storing a T (or XT attribute) associated with each of the Invalidation Tag (ITag) (e.g., stored in the ITAG tracker 1014) specified in an ATS invalidate request and comparing this T (or XT attribute) along with comparing ITag on ATS invalidate completion.

In certain examples, the IOMMU 120 (e.g., circuitry) uses trusted registers associated with the trusted invalidation queue 1010 to log the DevTLB invalidation timeouts or other errors.

FIG. 10 illustrates a block diagram of an IOMMU 120, coupled to an untrusted invalidation queue 1006 and a trusted invalidation queue 1010, that supports untrusted and trusted invalidation according to examples of the disclosure. In certain examples, registers 1008A-1008I are used for untrusted invalidation queue 1006 (e.g., as requested directly by the VMM 110B) and registers 1012A-1012I are used for trusted invalidation queue 1010 (e.g., as requested directly by the TDM 101).

In certain examples, IOMMU 120 includes a set of registers for an invalidation queue. In certain examples, it is desirable to keep a VMM 110B (or OS or other component that is not part of a trust domain) from invalidating private memory as well as reading any data structure, register, etc. that has corresponding data for invalidating that private memory (e.g., in trust domain memory 116 in FIG. 1). In certain examples, IOMMU 120 keeps anything except for a trust domain manager 101 from having access to the trusted IOMMU registers and/or trusted translations tables 324.

In certain examples, different trust domains are mapped through one or more corresponding trusted translation tables 324 and/or corresponding IOMMU registers 1012A-1012I.

In certain examples, a request (e.g., command) for an invalidation of (e.g., a page of) protected private memory 116 as discussed herein) is to be sent (e.g., by the trust domain manager 101 (e.g., TDX-module)) to trusted invalidation queue 1010. In certain examples, trusted invalidation queue tail register (T_IQT_REG) 1012B (e.g., for TDX-IO) is to store an indication of the tail (e.g., last valid) entry in trusted invalidation queue 1010, trusted invalidation queue head register (T_IQH_REG) 1012A (e.g., for TDX-IO) is to store an indication of the head (e.g., first valid) entry in trusted invalidation queue 1010, and trusted invalidation queue address register (T_IQA_REG) 1012C (e.g., for TDX-IO) is to store an indication of the base address (e.g., and size) of the trusted invalidation queue 1010, e.g., with these registers accessible (e.g., only) by the trust domain manager 101 and/or these registers within the IOMMU 120.

In certain examples, a request (e.g., command) for an invalidation of (e.g., a page of) non-private memory 114 as discussed herein) is to be sent (e.g., by the virtual machine monitor 110B) to untrusted invalidation queue 1006. In certain examples, “non-trusted” invalidation queue tail register (IQT_REG) 1008B (e.g., not for TDX-IO) is to store an indication of the tail (e.g., last valid) entry in untrusted invalidation queue 1006, “non-trusted” invalidation queue head register (IQH_REG) 1008A (e.g., not for TDX-IO) is to store an indication of the head (e.g., first valid) entry in untrusted invalidation queue 1006, and “non-trusted” invalidation queue address register (IQA_REG) 1008C (e.g., not for TDX-IO) is to store an indication of the base address (e.g., and size) of the untrusted invalidation queue 1006, e.g., with these registers accessible (e.g., only) by the VMM 110B and/or these registers within the IOMMU 120.

In certain examples, the invalidation requests are serviced, e.g., and the corresponding register(s) are updated, for example, updating the head and tail pointers accordingly. In certain examples, an invalidation request is (i) to take memory (e.g., a page) from a first virtual machine (e.g., or trust domain) and give it to another virtual machine (e.g., or trust domain) (e.g., after clearing the data of the first virtual machine from that memory), (ii) to delete a virtual machine (e.g., or trust domain), and/or (iii) in response to a global reset request.

In certain examples (e.g., as shown in FIGS. 3A-3B and 9) registers include a control register (TDX_MODE) 314A (e.g., within IOMMU 120) to set the IOMMU 120 within TDM (e.g., TDX) mode, e.g., to use registers 1012A-1012I, register 316, and/or trusted tables 324 (e.g., when the T attribute is 1b or XT attribute is not 00b). In certain examples, registers include a command register (ECMD_REG) 314B (e.g., within IOMMU 120) to send (e.g., and store) a command to the IOMMU 120, e.g., a command to enable/disable the TDX-mode, etc. In certain examples, registers include a global command register (GCMD_REG) 314C (e.g., within IOMMU 120) to store a global command to the IOMMU 120, e.g., a command to perform a global reset (e.g., to clear all the blocks (e.g., pages) in memory).

In certain examples, trust domain manager 101 (e.g., TDX-module) manages trusted IOMMU registers 1012A-1012I, register 316, and trusted translations tables 324.

In certain examples, VMM 110B 101 manages other IOMMU registers 1008A-1008I, register 312, and other translations tables 322.

In certain examples, computer system 100 (e.g., IOMMU 120 thereof) sends an ATS invalidate request 1002 to IO device 106, and, on completion of the invalidation, the IO device 106 sends an ATS invalidate completion 1004 indication to computer system 100 (e.g., IOMMU 120).

### Trusted PRS Support in IOMMU

FIG. 11 illustrates a block diagram of an IOMMU 120, coupled to an untrusted invalidation queue 1006, a trusted invalidation queue 1010, an untrusted page request queue 1106, and a trusted page request queue 1110, that supports untrusted and trusted page request services (PRS) according to examples of the disclosure.

In certain examples, IOMMU 120 (e.g., circuitry) reports Trusted PRS support (TPRS) through a trusted extended capability register (e.g., register 314D).

In certain examples, IOMMU 120 (e.g., circuitry) supports two parallel page-request queues, e.g., untrusted page-request queue 1106 (e.g., in memory 114) utilized for storing page-requests associated with the device interfaces assigned to certain (e.g., legacy) VMs and trusted page-request queue 1110 (e.g., in memory 116) utilized for storing page-requests associated with device interfaces assigned to trust domains (e.g., trusted VMs).

In certain examples, the untrusted page-request queue 1106 is stored in a regular (e.g., not trust domain) memory and is managed by the VMM 110B, and the trusted page-request queue 1110 is stored in a protected (e.g., trust domain) memory and is managed by the TDM 101 (e.g., TDX-module).

In certain examples, IOMMU (e.g., circuitry) support two separate set of registers that are associated with each page-request queue, e.g., registers 1108A-1108H for untrusted page-request queue 1106 and registers 1112A-H for trusted page-request queue 1110.

In certain examples, the registers associated with the trusted page-request queue 1110 are protected and can only be written by the trust domain manager (e.g., with the SEAM SAI).

In certain examples, IOMMU (e.g., circuitry) populates the untrusted page-request queue 1106, when the page-request message is received with T attribute of 0b (or XT attribute of 00b) and populates trusted page-request queue 1110 when the page-request message is received with T attribute of 1b (or XT attribute of 01b).

In certain examples, software services the page requests, e.g., by handling the page-fault and generating a page-response with a success or a failure code.

In certain examples, IOMMU (e.g., circuitry) to generates page-request group response message with T attribute of 0b (or XT attribute of 00b), when software queues page-response to the untrusted invalidation queue (e.g., untrusted page-response queue), and to generate page-request group response with T attribute of 1b (or XT attribute of 01b), when software queues page-response to the trusted invalidation queue (e.g., trusted page-response queue).

### TEE-Polarity of Completer (TPC) Support in IOMMU

In certain examples, trusted execution environments (TEEs) have access to TEE resources (e.g., protected memory and/or memory mapped IO (MMIO) of TEE-TO device) and non-TEE resources (e.g., shared memory and/or MMIO of legacy device).

In certain examples, an IO device may be interested to figure-out if the translated address is associated with the TEE memory or the non-TEE memory (e.g., sharing a cache line between TEE and non-TEE domains and/or support direct peer-to-peer between IO devices and/or enable efficient data-sharing across the trusted and untrusted device contexts). Certain examples herein are directed to an extension to IOMMU circuitry to return the TEE-polarity of DMA-Target/Completer as part of ATS Translation Completion.

In certain examples, IOMMU (e.g., circuitry) reports TEE-Polarity of Completer support (TPCS) through the trusted extended capability register (e.g., register 314D).

In certain examples, a new bit (e.g., TPCE-bit) is utilized in an IOMMU's scalable-mode context table entry that enables generation of TPC-bit as “TEE Exclusive” attribute in ATS Translation Completion.

In certain examples, when TPCE-bit in IOMMU's scalable-mode context table entry is 0b, the TPC-bit is always generated as 0b. In certain examples, when TPCE-bit in IOMMU's scalable-mode context table entry is 1b (e.g., enabled), on a successful processing of ATS Translation Request, TPC-bit is generated as (T (or Bit-0 of XT attribute) of ATS Translation Request & (!GPA.SHARED)). In certain examples, a TPC-bit is generated as (T (or Bit-0 of XT attribute) of ATS Translation Request & IS_TEE_PAGE (HPA)), e.g., where this results in TPC-bit being generated as 1b for TEE resources (e.g., protected memory and/or TEE Device Interface) and 0b for non-TEE resources (e.g., shared memory and/or legacy device interface) assigned to TEE.

In certain examples, IOMMU caches are also tagged with TPC-bit along with TEE-bit.

FIG. 12A illustrates example format of address translation services (ATS) packet 1202 including a “TEE Exclusive” attribute through which the trusted polarity of completer (TPC) field is conveyed according to examples of the disclosure.

In certain examples, a standard (e.g., PCI-SIG) defines mechanisms to convey TPC-bit as part of ATS Translation Completion. In example ATS packet 1202, the TPC-bit is conveyed as part of (e.g., payload for) ATS Translation Completion through the “TEE Exclusive” attribute, e.g., TEE Exclusive attribute to replace the global field (when enabled via ATS registers on the IO device).

eXtended TEE (XT) Mode Support in the IOMMU

In certain examples, trusted execution environments (TEEs) have access to TEE memory (e.g., protected memory and/or memory mapped IO (MMIO) of TEE-JO device) and non-TEE memory (e.g., shared memory and/or MMIO of legacy device).

In certain examples, an IO device may be interested in explicitly targeting TEE memory or non-TEE memory (e.g., conveying an intent to store digital-rights management (DRM) content to only TEE memory). In certain examples, this intent is conveyed through an eXtended TEE (XT) attribute on the memory request (e.g., untranslated request, ATS translation request, ATS translated request). For example, if the XT attribute is 00b, the request originated from non-TEE (e.g., not trust domain or not TEE-JO device) and must target the non-TEE memory. If the XT attribute is 01b, the request originated from TEE (e.g., trust domain or TEE-JO device) and can target TEE or non-TEE memory based on the address translation performed by the IOMMU. If the XT attribute is 10b, the request originated from TEE (e.g., trust domain or TEE-JO device) and must target non-TEE memory. If the XT attribute is 11b, the request originated from TEE (e.g., trust domain or TEE-JO device) and must target TEE memory. Certain examples herein are directed to an extension to IOMMU circuitry to process the memory requests received with the XT attribute.

In certain examples, the host (e.g., processor) may be interested in learning the requested TEE-polarity of the Completer (e.g., keyID look-up for Scalable Multi-Key TME and/or direct peer-to-peer between IO devices). Certain examples herein allow an IO device to fill the XT attribute on the ATS translated request based on the TEE-polarity of Completer received in the ATS Translation Completion. If the TEE Exclusive attribute is 0b (e.g., TPC=0b), the IO device generates ATS Translated Request with the XT attribute of 10b. If the TEE Exclusive attribute is 1b (e.g., TPC=1b), the IO device generates ATS Translated Request with the XT attribute of 11b.

In certain examples, IOMMU (e.g., circuitry) reports support for XT mode (XTS) through the trusted extended capability register (e.g., register 314D).

In certain examples, a new bit (e.g., XTE-bit) is utilized in an IOMMU's scalable-mode context table entry that enables processing of XT attribute from the memory requests.

In certain examples, when XTE-bit in IOMMU's scalable-mode context table entry is 0b, only XT0 bit is used for address translation and XT1 bit is treated as Reserved (and must be 0b). In certain examples, when XTE-bit in IOMMU's scalable-mode context table entry is 1b (e.g., enabled), on a successful address translation, TEE-polarity of Target/Completer is checked against the incoming XT attribute. For example, if the XT attribute is 00b or 10b, the target must be non-TEE memory. If the XT attribute is 1b, the target must be TEE memory. If the XT attribute is 01b, the target can be TEE or non-TEE memory. If the request is ATS translated request, the XT attribute must not be 01b. The memory request failing any of these checks is blocked by the IOMMU 120 (e.g., circuitry).

In certain examples, IOMMU caches are also tagged with the XT attribute.

In certain examples, Table 2A describes the meaning of XT attribute and Table 2B, 2C and 2D describe the IOMMU (e.g., circuitry) processing for the untranslated request, the ATS translation request, and the ATS translated request respectively.

TABLE 2A
XT Attribute Definition

| eXtended TEE | | |
|---|---|---|
| (XT) Attribute | | |
| XT1 | XT0 | Description |
| 0 | 0 | The memory request originated from non-TEE |
| | | (e.g., not trust domain or not TEE-IO device) |
| | | and must target the non-TEE memory |
| 0 | 1 | The memory request originated from TEE (e.g., |
| | | trust domain or TEE-IO device) and can target |
| | | TEE or non-TEE memory based on the address} |
| | | translation performed by the IOMMU |
| 1 | 0 | The memory request originated from TEE (e.g., |
| | | trust domain or TEE-IO device) and must target |
| | | non-TEE memory |
| 1 | 1 | The memory request originated from TEE (e.g., |
| | | trust domain or TEE-IO device) and must target |
| | | TEE memory |

TABLE 2B
Untranslated Request - XT Attribute Processing by the IOMMU

| eXtended TEE | | | |
|---|---|---|---|
| (XT) Attribute | | | IOMMU Behavior |
| XT1 | XT0 | Target Memory | (Untranslated Request) |
| 0 | 0 | non-TEE | Allow the request on a successful |
| | | | address translation |
| 0 | 0 | TEE | Reject/Block the request |
| 0 | 1 | non-TEE | Allow the request on a successful |
| | | | address translation |
| 0 | 1 | TEE | Allow the request on a successful |
| | | | address translation |
| 1 | 0 | non-TEE | Allow the request on a successful |
| | | | address translation |
| 1 | 0 | TEE | Reject/Block the request |
| 1 | 1 | non-TEE | Reject/Block the request |
| 1 | 1 | TEE | Allow the request on a successful |
| | | | address translation |

TABLE 2C
ATS Translation Request - XT Attribute
Processing by the IOMMU

| eXtended TEE | | | |
|---|---|---|---|
| (XT) Attribute | | | IOMMU Behavior |
| XT1 | XT0 | Target Memory | (ATS Translation Request) |
| 0 | 0 | non-TEE | Process the request normally |
| 0 | 0 | TEE | Return Success with R = W = 0 |
| 0 | 1 | non-TEE | Process the request normally |
| 0 | 1 | TEE | Process the request normally |
| 1 | 0 | non-TEE | Process the request normally |
| 1 | 0 | TEE | Return Success with R = W = 0 |
| | | | and TPC-bit (when enabled) in TEE |
| | | | Exclusive attribute |
| 1 | 1 | non-TEE | Return Success with R = W = 0 |
| | | | and TPC-bit (when enabled) in TEE |
| | | | Exclusive attribute |
| 1 | 1 | TEE | Process the request normally |

TABLE 2D
ATS Translated Request - XT Attribute Processing by the IOMMU

| eXtended TEE | | | |
|---|---|---|---|
| (XT) Attribute | | | IOMMU Behavior |
| XT1 | XT0 | Target Memory | (ATS Translated Request) |
| 0 | 0 | non-TEE | Allow the request if the |
| | | | access checks pass |
| 0 | 0 | TEE | Reject/Block the request |
| 0 | 1 | non-TEE | Reject/Block the request |
| 0 | 1 | TEE | Reject/Block the request |
| 1 | 0 | non-TEE | Allow the request if the |
| | | | access checks pass |
| 1 | 0 | TEE | Reject/Block the request |
| 1 | 1 | non-TEE | Reject/Block the request |
| 1 | 1 | TEE | Allow the request if the |
| | | | access checks pass |

In example PCIe packet 1204, the XT attribute is conveyed as part of the Integrity and Data Encryption (IDE) TLP prefix.

In example PCIe packet 1206, the XT attribute is conveyed as part of the OHC-C (Orthogonal Header Content—C) field.

### Interface Level Changes

### Primary Interface

In certain examples, the IOMMU 120 gets a new input (e.g., T attribute or “ide_t” as the state of the T bit in the IDE prefix of TLP (e.g., not a control packet) received, e.g., where the T attribute, when set, indicates the TLP originated from within a trust domain) from devices. In certain examples, for a TLP received without the IDE prefix, this input is 0b.

In certain examples, the IOMMU 120 gets a new input (e.g., XT attribute (XT0/XT1 bits) in the IDE TLP prefix or OHC-C field received, e.g., where the XT attribute, when not 00b, indicates the TLP originated from within a trust domain) from devices. In certain examples, for a TLP received without the IDE TLP prefix or OHC-C field, this input is 00b.

In certain examples, the IOMMU 120 generates an output (“TA-Polarity”) which indicates if the physical address at the final applicable output can have a trust domain (e.g., TDX) KeyID (kid).

### Secondary Interface

In certain examples, to signal the setting of the T (or XT) attribute to be sent in the PCIe TLP, the IOMMU 120 outputs a signal T (or XT) attribute which is forwarded by the HIOP (e.g., OTC thereof) to the on-chip system fabric (OSF) agent. In certain examples, the IOMMU 120 sets T attribute to 1b (or XT attribute to 01b) when the message was generated in response to descriptors from the trusted invalidation queue (e.g., trusted invalidation queue 1010 in FIG. 10) and sets T attribute to 0b (or XT attribute to 00b) for messages generated in response to descriptors from the “normal” invalidation queue (e.g., untrusted invalidation queue 1006 in FIG. 10).

In certain examples, the secondary interface is also used to generate Message Signaled Interrupts (MSI) writes, e.g., writes to special memory ranges and the TA-Polarity for these writes is assumed to be 0.

In certain examples, the secondary interface is also used to generate writes to store the value obtained “Status Data” field of invalidation wait descriptor to address specified by the “Status Address” field of an invalidation wait descriptor. In certain examples, the TA-Polarity for these writes is always 0 irrespective of which invalidation queue (normal or trusted) the invalidation wait descriptor was processed from.

### Memory Interface

In certain examples, a new signal (value) called TA-Polarity is added to this interface to indicate if the physical address of the access to the memory subsystem can have a TDM (e.g., TDX) KeyID.

In certain examples, the memory interface is used by the IOMMU 120: (i) for fetches to translation table entries as part of page walk originating from the untrusted as well as trusted translation tables, (ii) to perform address/data (A/D) bit updates atomically in first and second stage paging structures, (iii) to perform atomic updates to the posted interrupt descriptor (PID), (iv) for fetches to invalidation descriptor from the untrusted as well as trusted invalidation queue, and/or (v) writes to the untrusted as well as trusted page request queue.

In certain examples, one or more registers are used to implement the disclosure herein. For example, by decoding and executing an instruction that stores a (e.g., control) value into one or more registers.

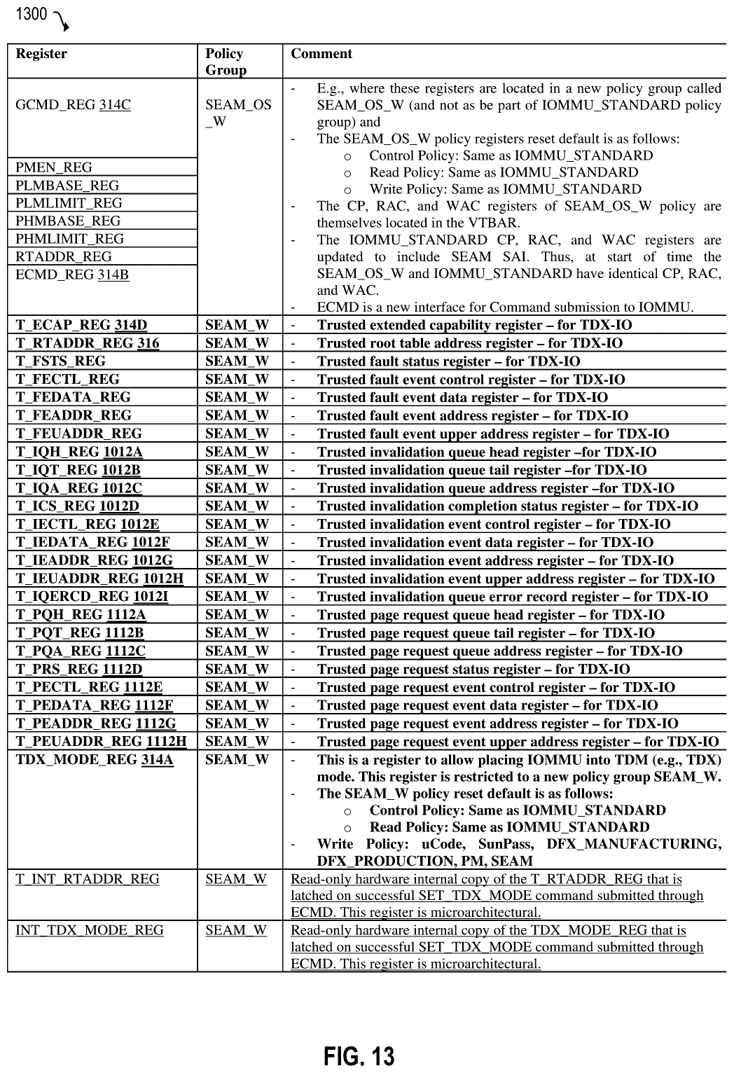

FIG. 13 is a table of IOMMU (e.g., and VT-d) registers 1300 according to examples of the disclosure. In FIG. 13, certain architectural registers used to implement input/output extensions for trust domains are shown in bold, and micro-architectural level register additions are depicted in underline. In certain examples, register's access policy groups are changed for security, e.g., when in the TDX_MODE of operation. In certain examples, an IOMMU includes a trusted extended capability register (T_ECAP_REG) 314D, a trusted root table address register (T_RTADDR_REG) 316, trusted fault reporting registers, trusted invalidation queue tail register (T_IQT_REG) 1012B (e.g., for TDX-IO), trusted invalidation queue head register (T_IQH_REG) 1012A (e.g., for TDX-IO), trusted invalidation queue address register (T_IQA_REG) 1012C (e.g., for TDX-IO), a trusted page request queue tail register (T_PQT_REG) 1112B, a trusted page request queue head register (T_PQH_REG) 1112A, a trusted page request queue address register (T_PQA_REG) 1112C, a register (TDX_MODE_REG) 314A to set the IOMMU 120 into (or out of) TDM (e.g., TDX) mode, and/or a command register (ECMD_REG) 314B as an interface to submit a command (e.g., to place it into or out of TDX mode) to the IOMMU. In certain examples, a “standard” command, register, etc. refers to a command, register, etc. that is not used for a trust domain, e.g., not used to implement input/output extensions for trust domains.

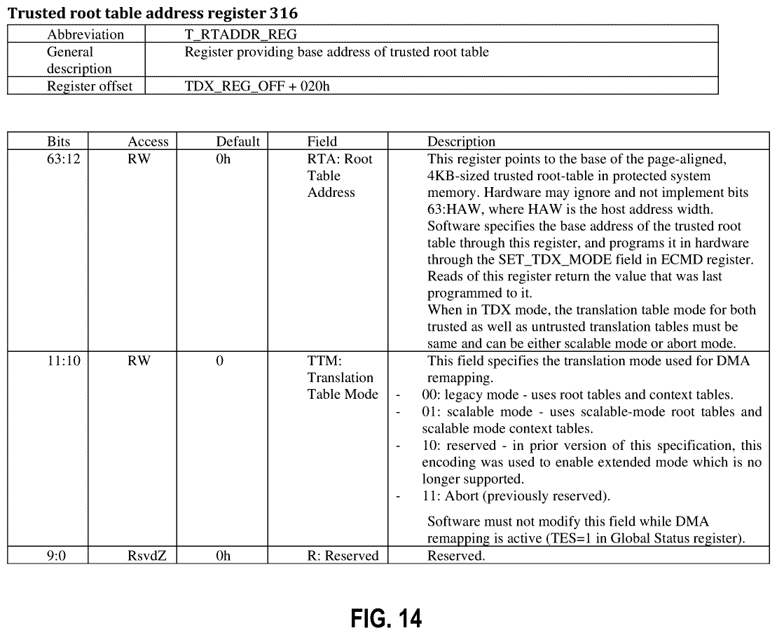

FIG. 14 is an example format of a trusted root table address register 316 according to examples of the disclosure, for example, for storing a base address to a trusted root table (e.g., trusted extended root table in trusted translation tables 324 in FIG. 3B).

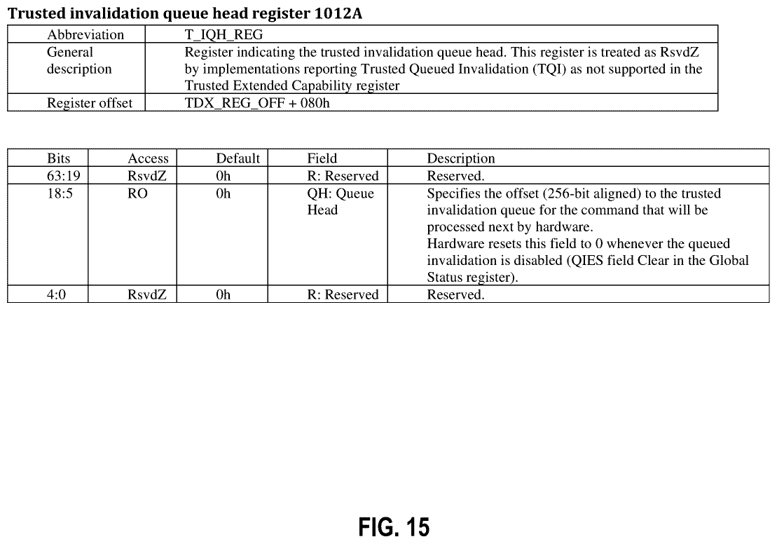

FIG. 15 is an example format of a trusted invalidation queue head register 1012A according to examples of the disclosure, for example, for storing an indication of a head (e.g., head element of a plurality of elements) of a trusted invalidation queue (e.g., trusted invalidation queue 1010 in FIG. 10).

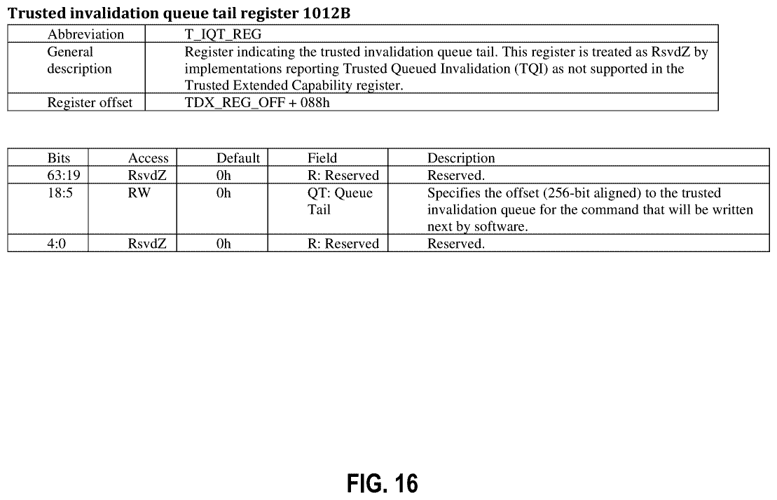

FIG. 16 is an example format of a trusted invalidation queue tail register 1012B according to examples of the disclosure, for example, for storing an indication of a tail (e.g., tail element of a plurality of elements) of a trusted invalidation queue (e.g., trusted invalidation queue 1010 in FIG. 10).

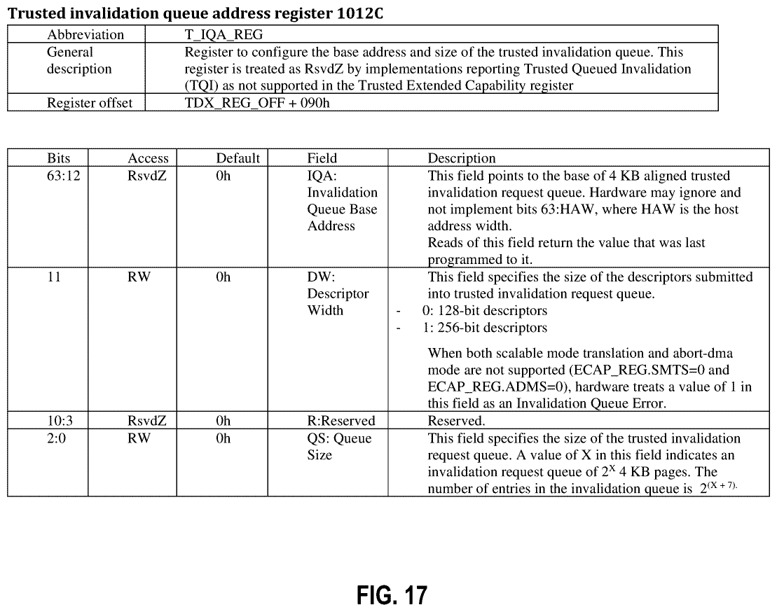

FIG. 17 is an example format of a trusted invalidation queue address register 1012C according to examples of the disclosure, for example, to store an indication of the base address (e.g., and size) of the trusted invalidation queue (e.g., trusted invalidation queue 1010 in FIG. 10).

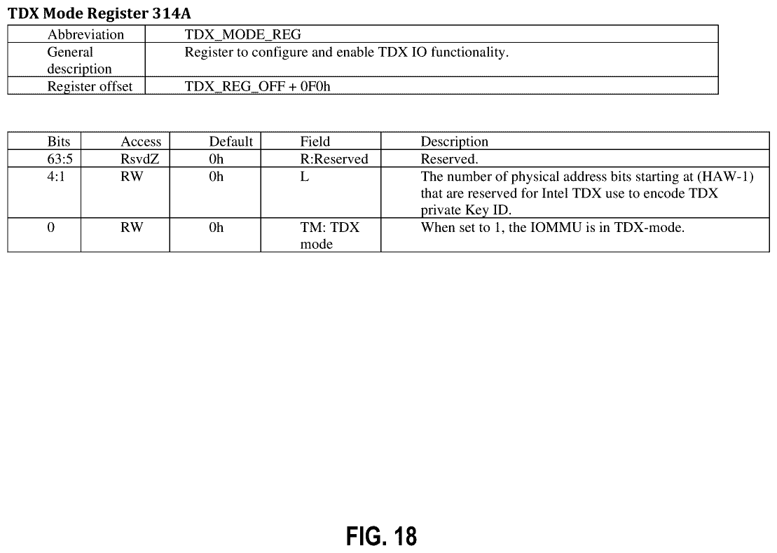

FIG. 18 is an example format of a trust domain (e.g., trust domain extensions (TDX)) mode register 314A according to examples of the disclosure, for example, to store a (e.g., command) value that controls if the IOMMU is in trust domain mode (e.g., TDX-mode).

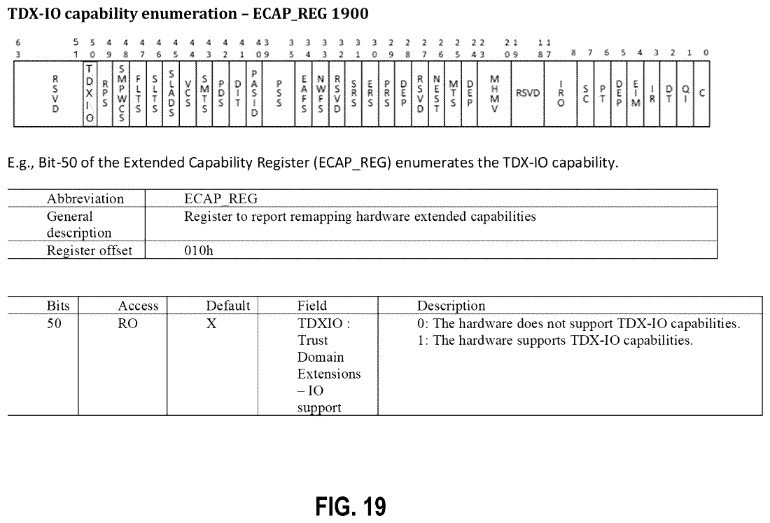

FIG. 19 is an example format of an extended capability register 1900 (e.g., as one of the registers in a processor and/or IOMMU) having trust domain IO capability enumeration according to examples of the disclosure, for example, in response to an enumeration request, is to store a value(s) that indicates if the hardware supports trust domain extension —input/output (IO) support (e.g., TDX-IO) capabilities (e.g., and if those registers are reserved (e.g., invalid) or otherwise).

In certain examples, if an implementation cannot ensure that the registers (e.g., trusted IOMMU registers 1012A-1012I and 316) are reserved and store zero values (RsvdZ) when ECAP_REG.TDXIO 1100 is 0, it should be guaranteed the writing of these registers (where applicable) are effectively no-operations (No-Ops) from the IOMMU operation point of view.

In certain examples, the ECAP_REG.TDXIO is 1 only when all the following qualifications/dependencies are satisfied: (i) default hardware reset of ECAP_REG.TDXIO is 1, (ii) ECAP_REG.SMTS=1 (scalable mode support present), (iii) Effective Host Address Width (e.g., after hardware autonomous width (HAW) defeature inclusion with the maximum physical platform address (MAX_PA)) is 52 bit, and (iv) TDX-IO Defeature (see below) is OFF. In certain examples, the TDX-IO feature can be fully defeatured using a bit (e.g., bit 3 for TDX-IO) of a Capability Defeature Register (e.g., as one of the registers in a processor and/or IOMMU).

In certain examples, a set of registers is used for command submission (e.g., called “Enhanced Command”) to an IOMMU with appropriate success/failure and thereby fault reporting, for examples, with these extended as below to support the SET_TDX_MODE command in TDX-IO

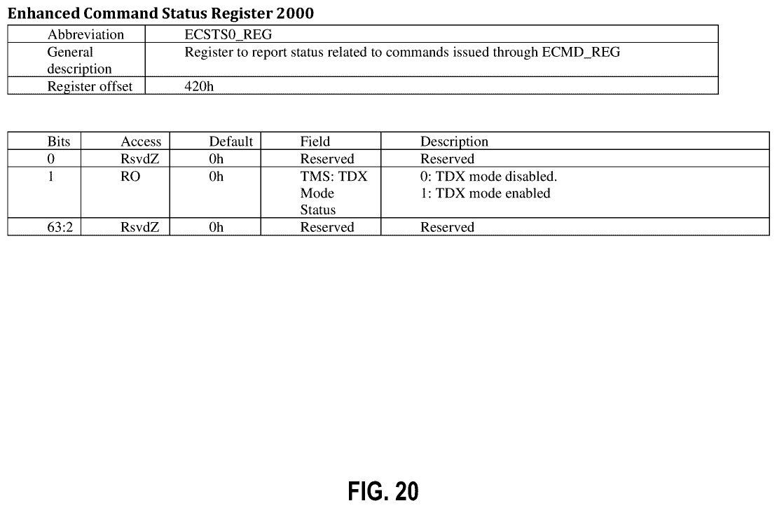

FIG. 20 is an example format of an enhanced command status register 2000 (e.g., as one of the registers in a processor and/or IOMMU) according to examples of the disclosure, for example, for the IOMMU to report status(es) related to commands issued through the enhanced command register (ECMD_REG) 314B.

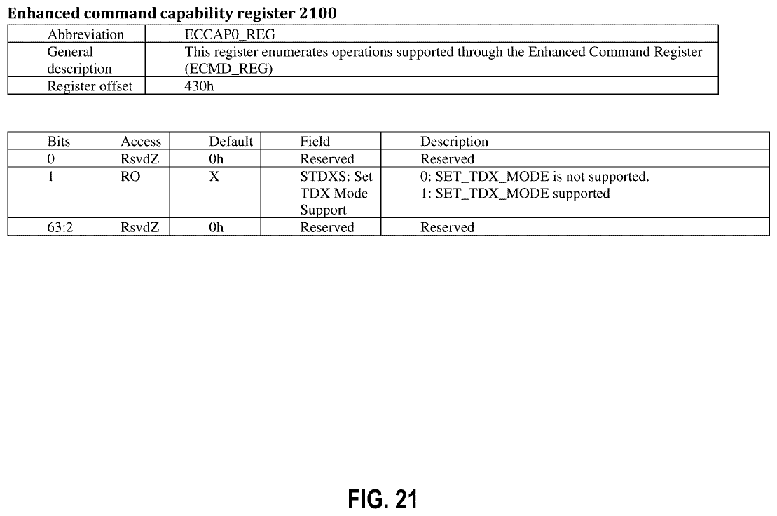

FIG. 21 is an example format of an enhanced command capability register 2100 (e.g., as one of the registers in a processor and/or IOMMU) according to examples of the disclosure, for example, in response to an enumeration request, is to store a value(s) that indicates if the hardware supports the (e.g., SET_TDX_MODE) through the enhanced command register (ECMD_REG) 314B.

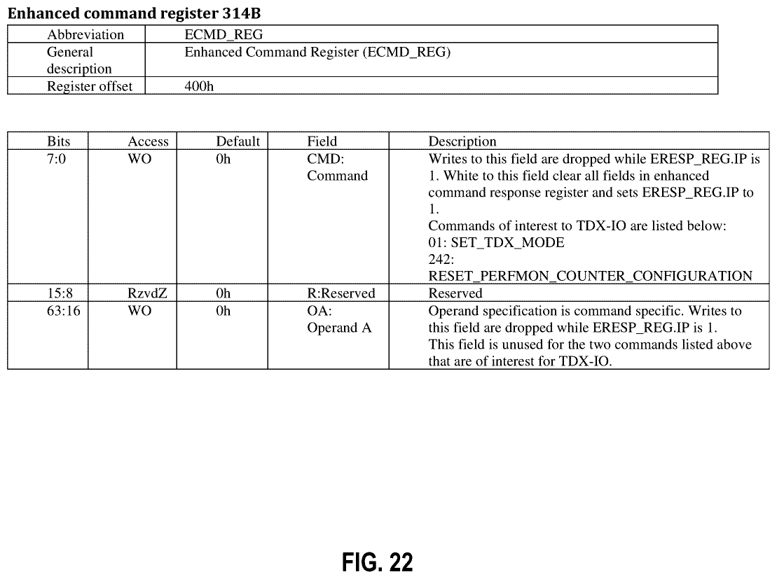

FIG. 22 is an example format of an enhanced command register 314B according to examples of the disclosure, for example, to store a (e.g., command) value that controls the operation(s) the IOMMU performs for trust domain mode (e.g., TDX-mode), e.g., setting the IOMMU into (or out of) TDX-IO mode.

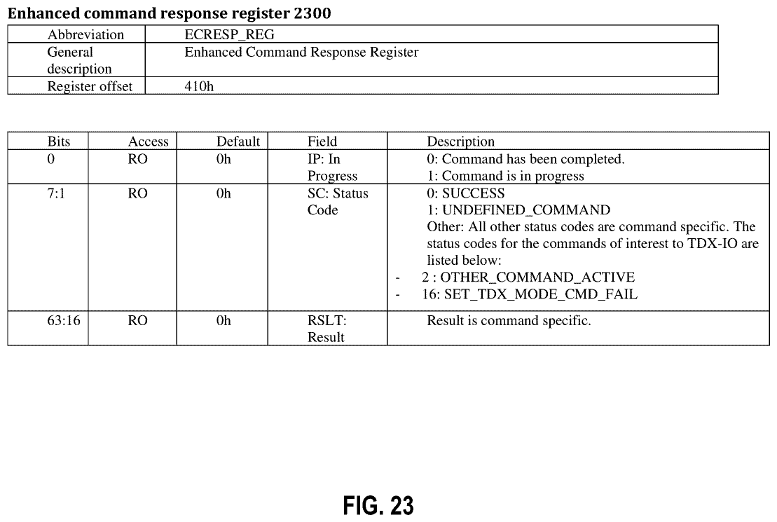

FIG. 23 is an example format of an enhanced command response register 2300 (e.g., as one of the registers in a processor and/or IOMMU) according to examples of the disclosure, for example, for the IOMMU to report responses related to commands issued through the enhanced command register (ECMD_REG) 314B, e.g., is a command in progress or has it been completed.

In certain examples, separate Trusted Enhanced Command Register (T_ECMD_REG), Trusted Enhanced Command Extended Operand Register (T_ECEO_REG), Trusted Enhanced Command Status 0-1 Register (T_ECSTS0_REG, T_ECSTS1_REG), Trusted Enhanced Command Capability Register 0-3 (T_ECCAP0_REG, T_ECCAP1_REG, T_ECCAP2_REG, T_ECCAP3_REG), and Trusted Enhanced Command Response Register (T_ECRESP_REG) are used to send/receive Trusted Commands (e.g., TDX-IO Commands) to the IOMMU.

### Placement of Registers (e.g., SEAM_OS_W Policy Group Registers) in VT Base Address Register (VTBAR)

In certain examples, the registers include Protected Memory Enable Register (PMEN), Protected Low-Memory Base Register (PLMBASE), Protected Low-Memory Limit Register (PLMLIMIT), Protected High-Memory Base Register (PHMBASE), and Protected High-Memory Limit Register (PHMLIMIT). In certain examples, the PMEN, when set, is to enable DMA-protected memory regions setup through the PLMBASE, PLMLIMT, PHMBASE, PHMLIMIT registers.

In certain examples, PMEN, PLMBASE, PLMLIMIT, PHMBASE, and PHMLIMIT registers are shadowed in the HIOP, for example, where the HIOP also shadows the IOMMU SAI policy group registers of the IOMMU. In certain examples, the IOMMU SAI policy group registers are located at offset 0xF10 in the IOMMU VTBAR.

In certain examples, TDX-IO makes these registers into protected registers (e.g., covered by the SEAM_OS_W policy group). In certain examples, to avoid having to add new policy groups to the HIOP shadow logic and to avoid the HIOP shadow logic from having to use a different offset (e.g., than 0xF10), the IOMMU locate the SEAM_OS_W policy group registers of read access control (RAC), write access control (WAC), and control policy (CP) at certain offsets (e.g., offsets 0xF10, 0xF18, and 0xF20, respectively).

### Global Command Register—Processing Set Root Table Pointer (SRTP) Bit

In certain examples, setting Set Root Table Pointer (SRTP) bit via global command register (GCMD_REG) 314C is unchanged from a non-JO VT-d specification definition, for example, it latches the legacy root pointer to an internal copy (e.g., along with the internal/external drain, global invalidation, etc.) with no other side effects from unexpected register values etc.

In certain examples, when in TDX mode, the trust domain manager (e.g., TDX-module) takes ownership of the RTADDR_REG as well as the GCMD_REG (write access controlled to SEAM), e.g., such that the trust domain manager (e.g., TDX-module) ensures that the RTADDR_REG programmed by the VMM has translation mode set to either scalable mode or abort.

### Enhanced Command (Ecmd) Addition—Support ‘Set_Tdx_Mode’ Command

In certain examples, an Enhanced Command (ECMD) register (e.g., enhanced command register (ECMD_REG) 314B) is a new VT-d command submission interface to the IOMMU 120 with corresponding response (e.g., success/failure) feedback to S/W based on the applicable error/compatibility checks. This is a cleaner contract between H/W and S/W as compared to other register-based commands (e.g., SRTP via GCMD) where the commands always execute irrespective of error checks and involved side effects on other IOMMU states that would ultimately invoke failure/fault detection in the data path operations. In certain examples, software is updated about the erroneous/incompatible command processing by the IOMMU.

In certain examples (e.g., along with architectural support for various performance monitoring (Perfmon) commands for IOMMU), ECMD supports new command “Set TDX Mode” (e.g., architectural) for enabling/disabling TDX Mode on an IOMMU. In certain examples, flows (e.g., SRTP, Set Interrupt Remap Table Pointer (SIRTP), etc.) transfer over to the ECMD. In certain examples, the ECMD register (used for submitting commands) is placed in the SEAM_OS_W policy group. In certain examples, in addition to the ECMD, GCMD, Protected Memory Range (PMR) related registers, and RTADDR are in SEAM_OS_W policy group.

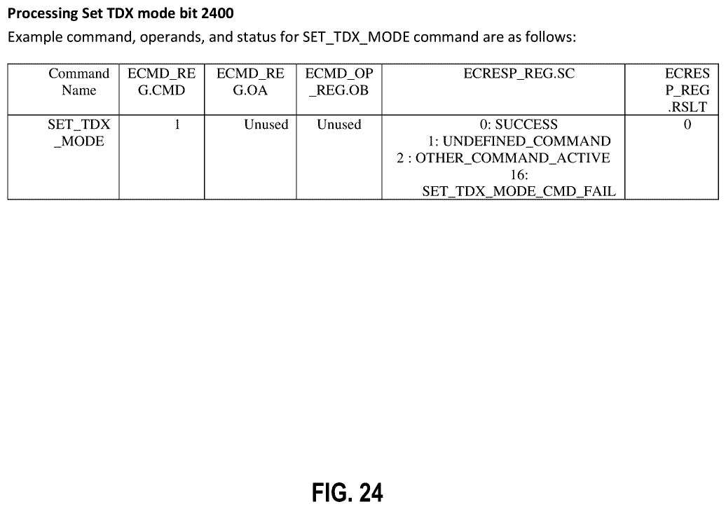

FIG. 24 is an example format of a processing set trust domain (e.g., trust domain extensions (TDX)) mode bit 2400 according to examples of the disclosure.

In certain examples, the ECMD_REG.CMD=SET_TDX_MODE command processing in the IOMMU (e.g., along with all associated operations) is as in the following pseudocode (where // is before comments/notes):

IF ECRESP.IP = 1
GOTO END // NOP if any ECMD op is ongoing.
ECRESP.IP = 1
TM = TDX_MODE_REG.TM
T_TTM = T_RTADDR.TTM
TTM = RTADDR.TTM
If any GCMD command (SRTP, SIRTP, SFL, WBF) or
PMR Enabling flow in progress in
IOMMU.
ECRESP.SC = OTHER_COMMAND_ACTIVE
ECRESP.IP = 0
GOTO END
IF ECCAP0_REG.STDXS == 0 // If SET_TDX_MODE not supported
ECRESP.SC = UNSUPPORTED COMMAND
ECRESP.IP = 0
GOTO END
// If request is to set TDX mode, then command fails if
// a) Trusted and untrusted TTMs are not equal
// b) Both TTMs are not in Scalable mode and in Abort DMA mode
IF ((TM == 1) & (TTM != T_TTM ∥ TTM ==
LEGACY ∥ TTM == EXTENDED )
ECRESP.SC = SET TDX MODE CMD FAIL
ECRESP.IP = 0
GOTO END
// Success Path
Block i/p primary interface and flush pipeline to make IOMMU empty.
Globally invalidate TLB, caches.
Latch register below values:
HARDWARE_T_RTADDR.RTA = T_RTADDR.RTA
HARDWARE_RTADDR.RTA = RTADDR.RTA
HARDWARE_T_RTADDR.TTM = T_TTM
HARDWARE_RTADDR.TTM = TTM
HARDWARE_TDX_MODE.L = TDX_MODE_REG.L
HARDWARE_TDX_MODE.TM = TM
Perform interface unblock and External Drain for GO and wait for Ack.
// Update state of TM in ECSTS0_REG.TM
ECSTS0_REG.TM = HARDWARE_TDX_MODE.TM
ECRESP.SC = SUCCESS
ECRESP.IP = 0
END:

In certain examples, ECCAP0.STDXS is dependent/qualified on ECAP_REG.TDXIO being 1, e.g., without TDX-IO capability, there is no Set TDX Mode command support. In certain examples, for TDX-IO, the trust domain manager (e.g., TDX Module) is to also reset the performance counter configurations as part of IOMMU initialization steps for transitioning to TDX_MODE, e.g., through the ECMD command ‘RESET_PERFORMANCE_COUNTER_CONFIGURATION” which results in all counters being disabled and all configuration, filter, freeze, and overflow status registers set to their default value (e.g., to prevent any telemetry based attacks on trusted DMA request translations).

### Invalidation Queue Processing

In certain examples, for supporting TDX-IO capability, an IOMMU has two sets of invalidation queues (IQ), for example, a non-trust domain (e.g., “normal”) IQ maintained by the VMM (e.g., untrusted invalidation queue 1006 in FIG. 10) and an architectural trusted invalidation queue (TIQ) (e.g., trusted invalidation queue 1010 in FIG. 10), for example, in SEAM_OS_W PG and thereby in SEAM control in TDX_MODE of operation. In certain examples, for TIQ, separate base address, head and tail pointers are present architecturally.

In certain examples, when ECAP_REG.TDXIO is 1, the IOMMU round robins between the trusted and the untrusted invalidation queues independent of the INT_TDX_MODE_REG.TM value, e.g., if ECAP_REG.TDXIO is 0, then the IOMMU defaults to fetching only from the existing untrusted IQ.

In certain examples with TDX-IO capability, if there is one active IQ (untrusted or trusted) being fetched and processed at a time, and there is an associated fault, it would be recorded, and actions taken as per the IQ fault related registers. In certain examples, no security is associated with fault reporting as MSIs are handled by VMM/host OS. In certain examples, a pending fault will stop all IQ/TIQ related processing until it is dealt with by software.

In certain examples, the IOMMU operations when ECAP_REG.TDXIO=1 can be summarized as follows:

IQA_HAS_ENTRIES = (IQH_REG != IQT_REG)
T_IQA_HAS_ENTRIES = (T_IQH_REG != T_IQT_REG)
IF ECAP_REG.TDXIO && IQA_HAS_ENTRIES &&
(LAST_PROCESSED_QUEUE ==
T_IQ ∥ ~T_IQA_HAS_ENTRIES)
IQ_DESC_BASE = IQA_REG.IQA
IQ_OFFSET = IQH_REG.QH
IQ_DW = IQA.DW
LAST_PROCESSED_QUEUE = IQ
ELIF ECAP_REG.TDXIO && T_IQA_HAS_ENTRIES &&
(LAST_PROCESSED_QUEUE == IQ ∥ ~IQA_HAS_ENTRIES)
IQ_DESC_BASE = T_IQA_REG.IQA
IQ_OFFSET = T_IQH_REG.QH
IQ_DW = T_IQA.DW
LAST_PROCESSED_QUEUE = T_IQ
ENDIF
DESC_WIDTH = IQ_DW ? 256b : 128b
Load descriptor of DESC_WIDTH from offset
IQ_OFFSET in IQ at IQ_DESC_BASE

In certain examples, the round robin behavior is kept irrespective of TDX Mode to simplify the hardware. In certain examples, when ECAP_REG.TDXIO=1, if TDX Mode=0, trusted IQ is always empty as per TDX-module expected behavior/requirements and hence only the first IF condition will be satisfied if applicable.

### Iommu Support for Trusted Translation Walks

The following discuses architecture level changes in certain IOMMUs to support trusted translations/walks for requests coming in with T attribute=1b or XT attribute !=00b.

### Caches/TLB Extensions

### IO Cache

In certain examples, an IO cache (e.g., IO TLB) is extended with a new tag bit “trusted”. In certain examples, when the IO cache is filled, this tag bit is set to (ECAP_REG.TDXIO & INT_TDX_MODE_REG.TM & T or XT0). In certain examples, when IO cache is looked up, the (ECAP_REG.TDXIO & INT_TDX_MODE_REG.TM & T or XT0) of the transaction is compared to the trusted bit to detect a match. In certain examples, the parity generation and/or verification on IO cache tags includes the Trusted bit. In certain examples, the same behavior also applies to translation type cache (TTC) (e.g., at the micro-architectural level) read and/or match as well in the IO cache pipeline.

### PASID Table Entry Cache

In certain examples, a PASID table entry cache (PTC) is extended with a new tag bit—Trusted. In certain examples, when PTC is filled, this tag bit is set to (ECAP_REG.TDXIO & INT_TDX_MODE_REG.TM & T or XT0). In certain examples, when PTC is looked up, the (ECAP_REG.TDXIO & INT_TDX_MODE_REG.TM & T or XT0) of the transaction is compared to the Trusted bit to detect a match. In certain examples, the parity generation and verification on PTC tags should include the Trusted bit.

### Context Entry Cache

In certain examples, context entry cache (CTC) is extended with a new tag bit —Trusted. In certain examples, when CTC is filled, this tag bit is set to (ECAP_REG.TDXIO & INT_TDX_MODE_REG.TM & T or XT0). In certain examples, when CTC is looked up, the (ECAP_REG.TDXIO & INT_TDX_MODE_REG.TM & T or XT0) of the transaction is compared to the TDX bit to detect a match. In certain examples, the parity generation and verification on CTC tags should include the Trusted bit. In certain examples, this logically extends to TTC as well when the tag/lookup array is shared with the CTC.

### Root Table Selection

In certain examples, on an IO cache miss (e.g., the mapping is not in the IO cache, so a walk is to be performed from the translation tables), when IOMMU is to access the root table to perform an operation, the IOMMU selects between the HARDWARE_RTADDR_REG and the HARDWARE_T_RTADDR_REG based on (ECAP_REG.TDXIO & INT_TDX_MODE_REG.TM & T or (XT0|XT1)) of the associated incoming request. In certain examples, when in TDX mode, if the request received for translation was with T attribute of 1b or XT attribute of not 00b, then the HARDWARE_T_RTADDR_REG is selected else the HARDWARE_RTADDR_REG is selected in all other cases.
RTADDR=(ECAP_REG.TDXIO & INT_TDX_MODE_REG.TM & Tor (XT0|XT1))?HARDWARE_T_RTADDR_REG.RTA:HARDWARE_RTADDR_REG.RTA

### New VT-d Faults & Associated Checks for TDX-IO Trusted Translations

In certain examples, UR is an unsupported request, CA is completer abort, IR is interrupt remapping, and NA is not applicable.

In certain examples, if the remapping hardware is not able to successfully process the translation-request (e.g., with or without PASID), a translation-completion without data is returned, for example, with a status code of UR (Unsupported Request) returned in the completion if the remapping hardware is configured to not support translation requests from this endpoint, and/or a status code of CA (Completer Abort) is returned if the remapping hardware encountered errors when processing the translation-request.

### PASID Table Entry Walk—Enforcement of Domain ID Partitioning & PGTT Values

In certain examples, in TDX_MODE, the domain ID is partitioned between TD VMs and non-TD VMs. In certain examples, non-TD VMs use domain IDs with bit L of domain ID set to 0 and TD VMs use domain IDs with bit L of domain ID set to 1. In certain examples, L is the most significant bit (MSB) of the effective domain ID width as enumerated by ECAP.ND field. In certain examples, the ECAP.ND enumerates a (e.g., 16-bit wide) domain ID (e.g., not accounting for de-feature) and hence L bit will be that MSB (e.g., bit 15 of bits 15-0). In certain examples, in TDX mode, when a page walk is being performed for untrusted requests (e.g., request with T attribute of 0b or XT attribute of 00b), if a PASID table entry is found with domain ID bit L set to 1 then it is treated as a terminal fault and such PASID table entries are not cached. In certain examples, this prevents a VMM from maliciously re-using a domain ID allocated to TDs and PASID allocated to TDs with an untrusted device to trigger a first/second stage paging structure entry cache hit which is looked up by domain-ID, PASID (e.g., for first-stage caches), and address. In certain examples, as Domain ID partitioning is done, no separate “Trusted” bit tags are required for the set of FS and SS caches. In certain examples, the following fault check is used for TDX-IO security:
Fault check→IF “ECAP_REG.TDXIO & INT_TDX_MODE.TM & ˜T (or ˜XT) & Domain-id [L]”, and if 1, then cause terminal fault as bit L is reserved for untrusted walks in PASID table entry in TDX_MODE.

In certain examples, the error reporting for this terminal fault is like error reporting for reserved bits.

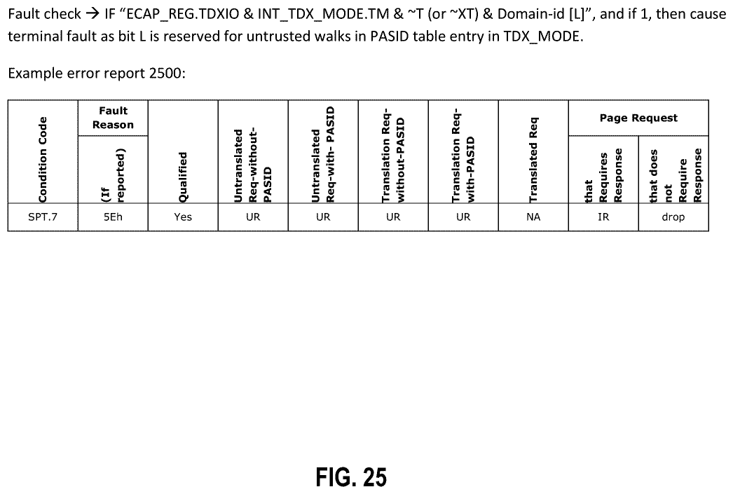

FIG. 25 is an example format of an example error report 2500 according to examples of the disclosure. In certain examples, certain (e.g., VT-d) faults are stored in a different category than other faults, e.g., where an SPT fault (e.g., condition code thereof) is a fault detected in a Scalable Mode PASID Table (SPT) entry (e.g., the Scalable Mode PASID Table in the trusted translation tables 324 shown in FIG. 3B) and an SCT fault (e.g., condition code thereof) is a fault detected in a Scalable Mode Context Table (SCT) entry (e.g., the Scalable Mode (e.g., lower) Context Table in the trusted translation tables 324). In certain examples, the priority of condition code SPT.7 is just after SPT.3 and before SPT.4.

In certain examples, the following fault check is used for TDX-IO security: when ECAP_REG.TDXIO is 1, if TDX mode is enabled and the walk is for T or (XT0|XT1)=1, then the PASID Granular Translation Type (PGTT) is (e.g., must be) a certain value or values, e.g., 010b (e.g., 2^{nd} level only) or 011b (e.g., nested), and if not one of those values (e.g., those two values), then cause a terminal fault.

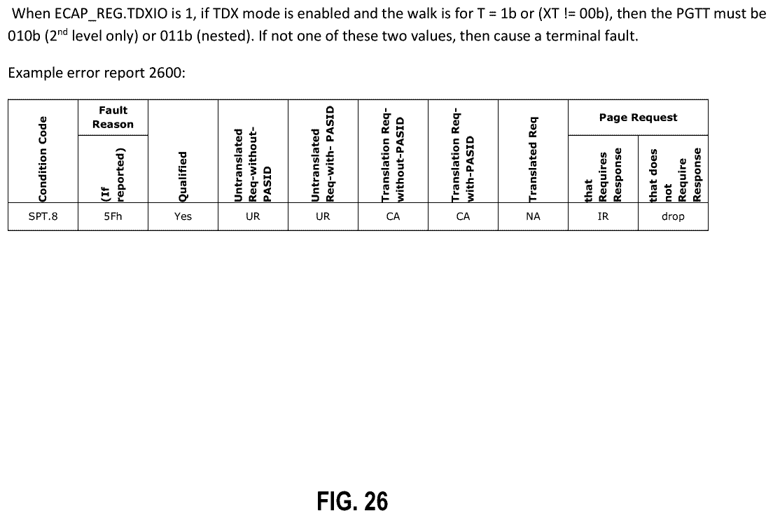

FIG. 26 is an example format of an example error report 2600 according to examples of the disclosure. In certain examples, the priority of condition code SPT.8 is just after SPT.4.4 and before SPT.5. In certain examples, this fault is introduced for increased robustness of operations and preventing any chances of a walk with PGTT values other than the ones mentioned for trusted requests in the tdx_mode (e.g., TDX Module expected behavior is to set PGTT in trusted PASID table entry as 2^{nd} level or nested).

### Page Walks in TDX Mode

In certain examples, remapping hardware includes an indication of a field that indicates the maximum DMA virtual addressability supported by the remapping hardware. In certain examples, the Maximum Guest Address Width (MGAW) is computed as (N+1), where N is the value reported in this field. For example, a hardware implementation supporting 48-bit MGAW reports a value of 47 (101111b) in this field. In certain examples, if the value in this field is X, untranslated and translated DMA requests to addresses above 2\hat{ }(x+1)−1 are always blocked by hardware and translations requests to address above 2\hat{ }(x+1)−1 from allowed devices return a null Translation Completion Data Entry with R=W=0.

In certain examples, guest addressability for a given DMA request is limited to the minimum of the value reported through this field and the adjusted guest address width of the corresponding page-table structure, e.g., and adjusted guest address widths supported by hardware are reported through the SAGAW field.

In certain examples, implementations support a MGAW at least equal to the physical addressability (e.g., host address width) of the platform.

In certain examples, remapping hardware includes an indication of a (e.g., 5-bit field) the supported adjusted guest address widths (SAWAG), e.g., which represents the levels of page-table walks for the (e.g., 4 KB) base page size supported by the hardware implementation. In certain examples, a value of 1 in any of these bits indicates the corresponding adjusted guest address width is supported, e.g., where the adjusted guest address widths corresponding to various bit positions within this field are:
0: 30-bit AGAW (2-level page table)
1: 39-bit AGAW (3-level page table)
2: 48-bit AGAW (4-level page table)
3: 57-bit AGAW (5-level page table)
4: 64-bit AGAW (6-level page table)

In certain examples, software is to ensure that the adjusted guest address width used to setup the page tables is one of the supported guest address widths reported in this field.

### SHARED Bit

In certain examples, for TDs, guest physical addresses (GPA) with most significant bit set to 1 are called shared GPA and with most significant bit set to 0 are private GPA. In certain examples, the SHARED bit is evaluated as follows:
S_BIT=(PASIDTE.AW==′011b) ? 51: 47 SHARED=ECAP_REG.TDXIO & INT_TDX_MODE_REG.TM & T or (XT0|XT1) & GPA[S_BIT]

In certain examples, the S_BIT calculation does not need to include SAGAW and MGAW as these are separate VT-d checks and would raise fault if AW and SAGAW did not comply with each other and/or input GPA width is greater than what is allowed by MGAW and AW. In certain examples, the expected S/W behavior is that TDX-module would verify SAGAW and MGAW from a capabilities (CAP) register to support multiple (e.g., 4 and/or 5) level EPT before setting TDX Mode=1.

### Faults During First-Stage Page Table (FSPT) Walk

In certain examples, the SHARED bit being 1 in first-stage paging entry (e.g., FS-PML5E, FS-PML4E, FS-PDPE with PS bit 0, FS-PDE with PS bit 0) with Present (P) field set are treated as terminal fault. In certain examples, for data read and write, FS-PDPE can have SHARED bit 1 if PS is set to 1 i.e., maps a 1 GB page and FS-PDE can have SHARED bit 1 if PS is set to 1 i.e., maps a 2 MB page and FS-PTE can have SHARED bit 1. In certain examples, for instruction fetches, if SHARED bit is set to 1 in FS-PDPE with page size (PS) set to 1, maps a 1 GB page, or FS-PDE with PS set to 1, maps a 2 MB page, or in FS-PTE, then cause a terminal fault. In certain examples, this fault check enforces that a TD can locate FSPT paging structures only in private GPA and data read/write can be done to shared memory but not instruction fetches. In certain examples, the fault is a terminal fault and signaled as set fault-log (SFS) SFS.11 (e.g., for both leaf and non-leaf paging structures). In certain examples, SHARED will always evaluate to 0 if TDX mode is not enabled or if the walk is for a transaction with T or (XT0|XT1)=0.

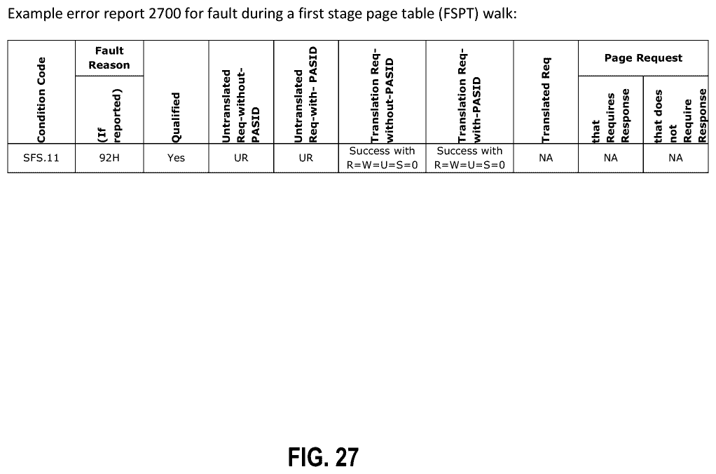

FIG. 27 is an example format of an example error report 2700 for a fault during a first-stage page table (FSPT) walk according to examples of the disclosure. In certain examples, the priority of scalable mode first-stage (SFS) SFS.11 is just after SFS.3. In certain examples, this fault is introduced to catch bad TD behavior, e.g., to avoid core side accesses.

### Faults During Second-Stage Page Table (SSPT) Walk

In certain examples, SSPT walks require that all second-stage (SS) paging structure entries (e.g., except the root SS paging structure entry and the final address of the translation) do not (e.g., must not) have TD private KeyID if the walk was started with a GPA with SHARED set to 1. In certain examples, this fault check prevents a VMM from locating SS paging structure entries or final translation from SS paging to be mapped to TD private memory. In certain examples, the TDX_MODE_REG.L indicates the number of physical address bits starting at HAW-1 that are reserved for encoding TDX Key IDs. If, for example, HAW is 46 and L is 6, the bits 45:40 if set in a physical address indicate that the physical address has a private Key ID.

In certain examples, this is evaluated as follows:

### KM=0

### FOR K=0; K<L; K++

KM[HAW-1-K]=1

### ENDFOR

### IF (SHARED==1 &&

((SS-PML5E[51:40] & KM && sspt_walk_state==PROCESS_PML5E) ∥
((SS-PML4E[51:40] & KM && sspt_walk_state==PROCESS_PML4E)
((SS-PDPE[51:40] & KM && sspt_walk_state==PROCESS_PDPE)
(SS-PDE[51:40] & KM && sspt_walk_state==PROCESS_PDE) ∥
(SS-PTE[51:40] & KM && sspt_walk_state==PROCESS_PTE)) THEN SSS.7 fault

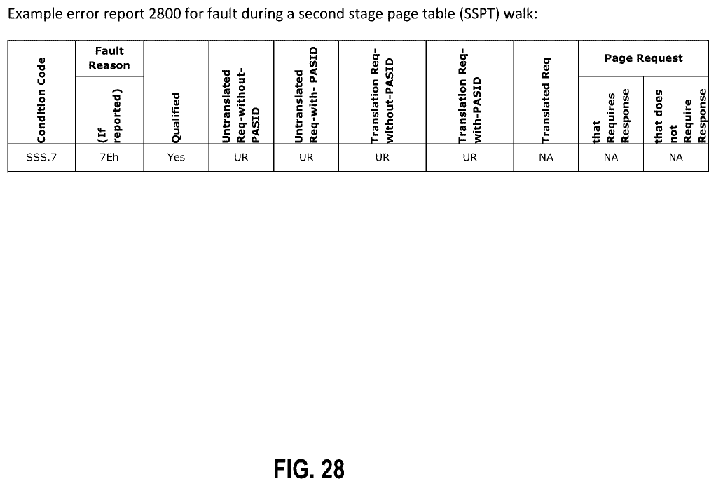

FIG. 28 is an example format of an example error report 2800 for a fault during a second stage page table (SSPT) walk according to examples of the disclosure. In certain examples, the priority of scalable mode second stage (SSS) SSS.7 is just after SSS.3. In certain examples, this fault is introduced to achieve TDX-IO security.

### TA-Polarity Generation

In certain examples, the IOMMU relies on the KeyID filter to abort a memory request from the device or an access from the IOMMU itself to access its translation structures with TDX KeyID unless the IOMMU allows memory request to have a TDX KeyID. In certain examples, this is accomplished by a logical signal from the IOMMU called TA-Polarity.

In certain examples, the TA-Polarity value is driven by the IOMMU as follows to indicate whether the access can have a TDX KeyID as follows:
1. The IOMMU sets TA-Polarity to 0 for memory requests that cannot be to private memory in the TDX-IOMMU architecture. This includes following memory requests:
   Interrupt Remap Table Entry
   Posted interrupt descriptor.
   Untrusted invalidation queue entry
   Untrusted page request queue entry
   Legacy mode root entry
   Legacy mode context entry
   Writes to the interrupt address range—0xFEEx_xxxx—for a device originated interrupt write, e.g., for these TA-Polarity is 0 whether interrupt remapping is enabled, disabled, or bypassed.
   Interrupt writes generated by the IOMMU itself like fault event, page request event, invalidation event, etc.
   Status writes on invalidation wait descriptor processing (irrespective of the queue from which the descriptor was processed).
2. IOMMU translation structures that are always in private memory when TDX_MODE is 1 and the translation is for a T or (XT0| XT1)==1 request. For these requests TA-Polarity is set to TDX_MODE & T or (XT0| XT1). This includes memory request to following structures:
   Scalable mode root entry
   Scalable mode context entry
   Scalable mode PASID directory entry
   Scalable mode PASID table entry
   First-stage paging structure entries
   HPT table entries
3. IOMMU translation structures that can be in private or shared memory based on the SHARED bit (for T or (XT0|XT1)=1 and TDX_MODE=1) associated with the walk. Here TA-Polarity is set as TDX_MODE & T or (XT0|XT1) as fault check (SSS.7) is used to detect private keyID in shared SS structures in the IOMMU SS page walker (e.g., it does not depend on keyID filter to catch this. TA−Polarity=1 allows private or shared keyIDs):
   Second-stage paging structure entries
4. The trusted invalidation queue and trusted page request queue is always in private memory. Thus, IOMMU drives TA-Polarity to 1 for the following accesses in the TDX_MODE:
   Trusted invalidation queue entry
   Trusted page request queue entry

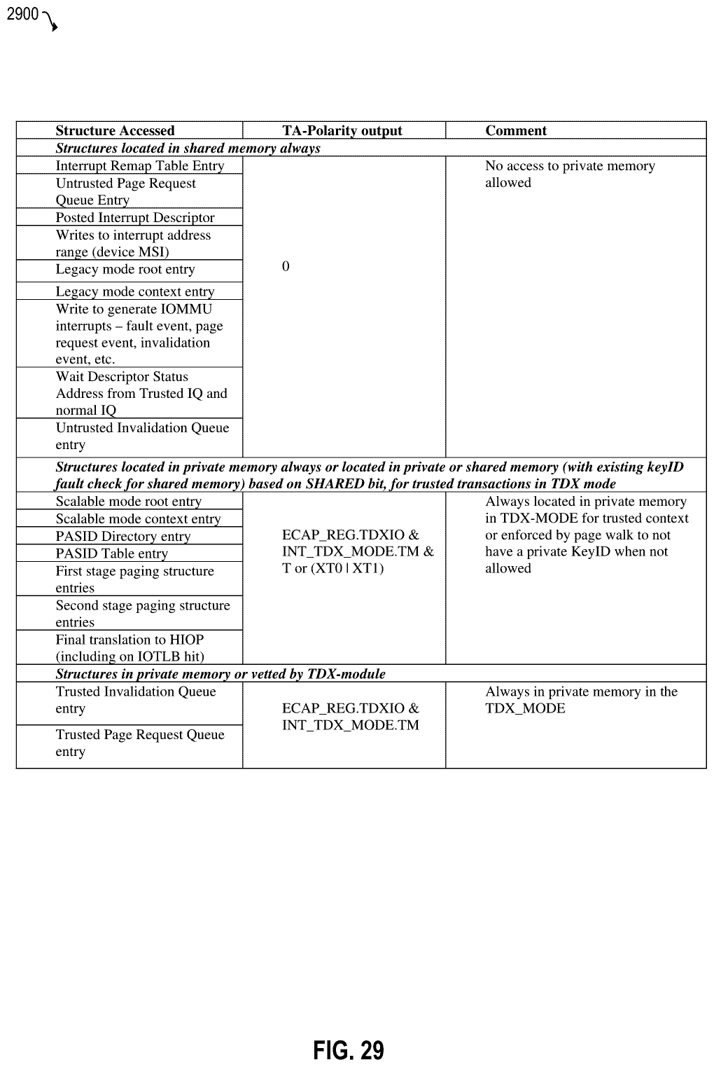

FIG. 29 is a table of translation structures 2900 according to examples of the disclosure.

### Trust Domain Manager (e.g., TDX-Module) Restrictions and Requirements

In certain examples, a VMM hands control of the IOMMU to the trust domain manager (e.g., TDX-module) if it discovers TDX-IO capable device(s) in the scope of the IOMMU, e.g., by invoking a function in the TDX-module. The following sections specify an example programming sequence and restrictions the TDX-module is to (e.g., must) observe for:
1. Placing IOMMU in TDX mode
2. VMM programming of registers in SEAM_OS_W
3. Configuring trusted translation tables
4. Clearing TDX mode for an IOMMU

### Placing IOMMU in TDX Mode:

1. Remove BOOT_BIOS, POST_BOOT, and SMM SAI from the SEAM_OS_W policy group, e.g., make the SEAM_OS_W policy group registers restricted to SEAM SAI.
2. Fail if any of the following errors are detected:
   a. ECAP_REG.TDXIO is 0—TDX-IO capability not supported.
   b. CAP_REG.SAGAW[10] is 0—4-level page table not supported.
   c. CAP_REG.SAGAW[11] is 0 and CPU EPT supports 5-level page tables—If CPU supports 5-level page tables then IOMMU is to (e.g., must) also support 5-level page tables.
   d. If CAP_REG.SAGAW[11] is 1 and CAP_REG.MGAW is not 52 bits
   e. If CAP_REG.SAGAW[10] is 1 and CAP_REG.MGAW is less than 48 bits
   f. ECRESP_REG.IP is 1—there is an enhanced command in progress.
   g. ECSTS0_REG.TMS is 1—IOMMU is already in in TDX mode.
   h. GSTS_REG.TES is 0—IOMMU translations are not enabled.
   i. GSTS_REG.QIES is 0—Queued Invalidations are not enabled.
   j. PMEN_REG.EPM or PMEN_REG.PRS are not 0—protected memory ranges are (e.g., must) be disabled.
   k. ECAP_REG.TDXIO is 0—TDX mode is not supported.
   l. RTADDR_REG.TTM is not scalable mode (e.g., is not 01b).
3. Configure T_RTADDR_REG with address of trusted translation table root page and the translation table mode, e.g., root table address is to (e.g., must) have a TDX Key ID inserted and/or TTM is to (e.g., must) be set to Scalable Mode (e.g., 01b).
4. Configure T_IQA_REG with address of trusted invalidation queue base page, e.g., this address is to (e.g., must) have TDX Key ID inserted and/or the T_IQA_REG is to (e.g., must) be configured with 256-bit descriptor width.
5. Initialize T_IQT_REG to value of T_IQH_REG, e.g., make tail equal to head to indicate empty queue.
6. Configure T_PQA_REG with address of trusted page request queue base page, e.g., this address is to (e.g., must) have TDX Key ID inserted.
7. Initialize T_PQT_REG to value of T_PQH_REG, e.g., make tail equal to head to indicate empty queue.
8. Configure TDX_MODE_REG.L with the value of .TDX_RESERVED_KEYID_BITS field from IA32_TME_ACTIVATE MSR and set TDX_MODE_REG.TM to 1.
9. Write ECMD_REG.CMD=SET_TDX_MODE
10. Wait for command completion i.e., ECRSP_REG.IP to become 0. Note this step can be done by the VMM.
11. Verify that the TDX mode was enabled by reading ECSTS0_REG.TMS and checking that it is 1.
12. Write ECMD_REG.CMD=RESET_PERFMON_COUNTER_CONFIGURATION
13. Wait for command completion i.e., ECRSP_REG.IP to become 0. Note this step can be done by the VMM.
   On completion of this sequence, in certain examples, the TDX mode is enabled and the root as well as trusted root address registers are latched into the IOMMU hardware. In certain examples, TDX_MODE_REG.L is to (e.g., must) not be changed once TDX mode has been enabled, e.g., changing the L can lead to undefined behavior in the IOMMU and affect TDX security.
   SEAM_OS_W Re,Ister Accesses from VMM

In certain examples, when TDX mode is enabled, the SEAM_OS_W registers are not writeable by the VMM, e.g., the VMM is provided an application programming interface (API) function to program the following registers if needed:
RTADDR_REG—enforce the following restrictions.
Address value provided by the VMM does not have a TDX Key ID.
TTM value provided by the VMM is to (e.g., must) be scalable mode.
GCMD_REG—enforce the following restrictions.
Queued invalidation cannot be disabled.
Translation Enable cannot be set to 0.

### Confizurinz Trusted Translation Tables

1. Read CAP_REG.ND to determine the IOMMU supported domain with. The MSB of the supported domain ID is the L bit. For example, if domain ID width is 16-bit then L bit is bit 15. This configuration can be read out and cached as part of placing IOMMU in TDX mode.
2. Observe following restrictions when configuring PASID table entry in trusted translation table.
   Set L bit of DID field to 1.
   Set address width (AW) to either 010b (4-level) or 011 (5-level).
   Set PGTT to either 010b (second-stage translation only) or 011b (nested)
3. Observe following restrictions on the SSPT configured into the trusted PASID table entry.
   Store the HKID assigned to the TD in the secure EPT entries (e.g., TD secEPT in FIG. 3). These are not consumed by the CPU PMH but will be consumed by the IOMMU.
   Allow VMM to configure private EPT PML4 (e.g., when 4 level EPT is enabled) or EPT PML5 (e.g., when 5 level EPT is enabled) to next level shared EPT paging structures (e.g., TD sharedEPT in FIG. 3). Ensure that the address provided by the VMM does not have a TDX Key ID
4. Make PASID table entry intrusted translation tables present only when the TD has accepted the PASID or device interface.

### Clearing TDX Mode

In certain examples, the VMM may request that an IOMMU TDX mode be cleared, e.g., where the TDX module follows the following sequence.
1. Fail if the following conditions are detected:
   a. ECSTS0_REG.TMS is 0—IOMMU is not in TDX mode.
   b. T_IQH_REG is not equal to T_IQT_REG—there are invalidations in progress.
   c. There are valid mappings in the trusted translation table.
   d. ECRESP_REG.IP is 1—there is an enhanced command in progress.
2. Set following trusted registers to 0 i.e., their reset default values.
   a. T_RTADDR_REG
   b. T_IQA_REG
   c. T_PQA_REG
   d. TDX_MODE_REG—both L and TM set to 0.
3. Set ECMD_REG.CMD=SET_TDX_MODE.
4. Add back BOOT_BIOS, POST_BOOT, and SMM SAI to SEAM_OS_W policy group.
5. Wait for command completion, e.g., ECRSP_REG.IP to become 0. Note this step can be done by the VMM.
   On completion of this sequence, the TDX mode is disabled in certain examples.

In certain examples, an IOMMU includes a set of registers for untrusted components and a separate set of (e.g., protected) registers for trusted components. The following discussed certain examples registers, but it should be understood that an untrusted and trusted (“T”) instance of each can be utilized in the same IOMMU.

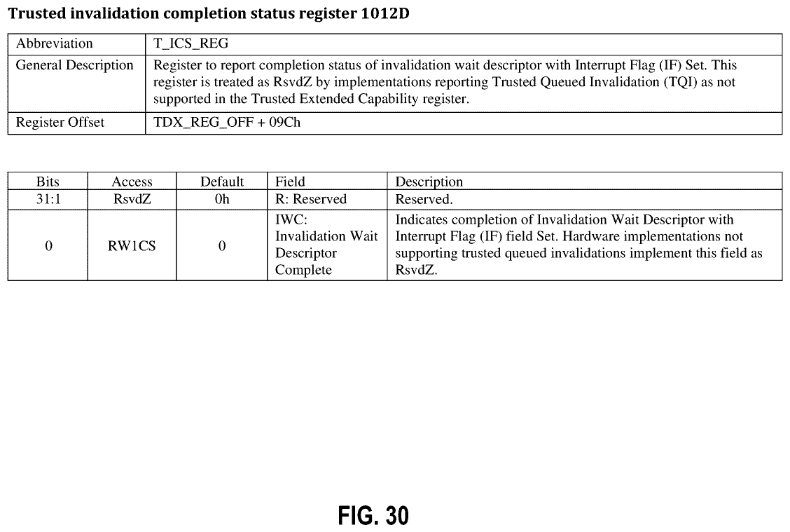

FIG. 30 is an example format of a trusted invalidation completion status register 1012D according to examples of the disclosure.

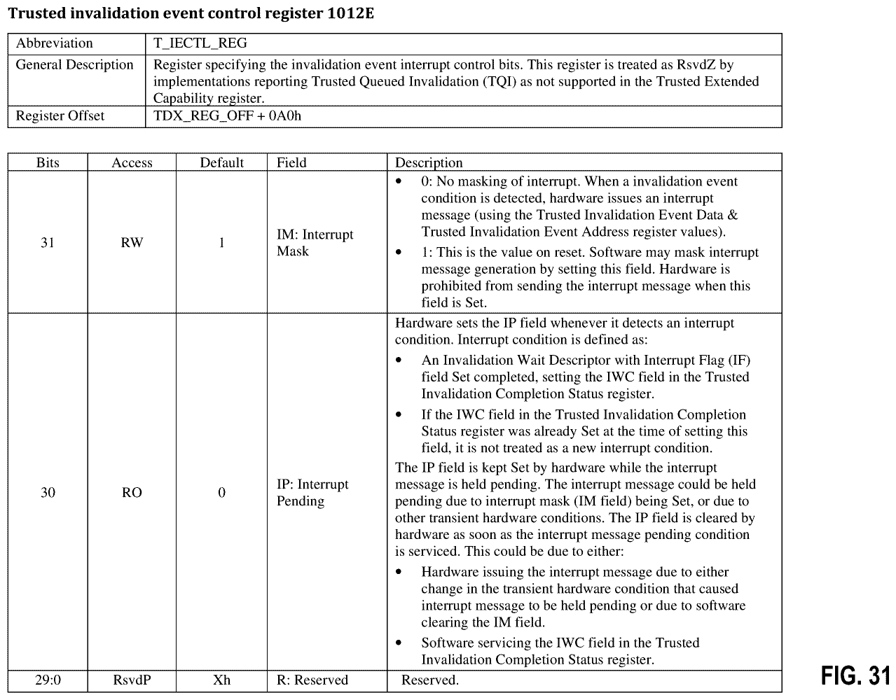

FIG. 31 is an example format of a trusted invalidation event control register 1012E according to examples of the disclosure.

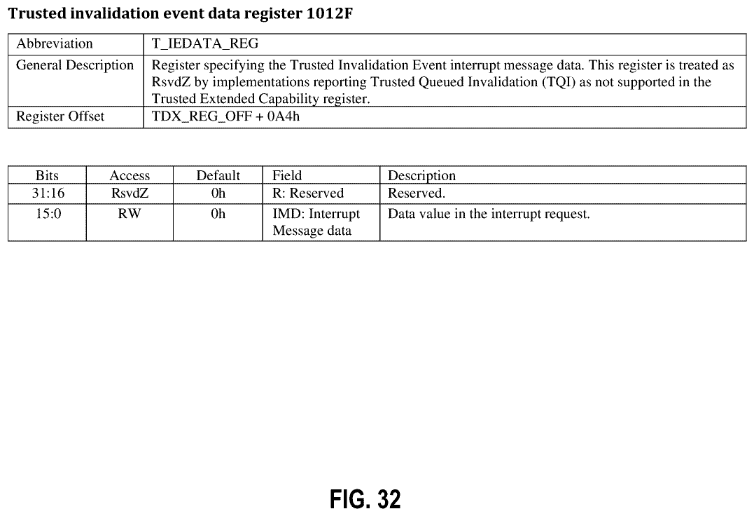

FIG. 32 is an example format of a trusted invalidation event data register 1012F according to examples of the disclosure.

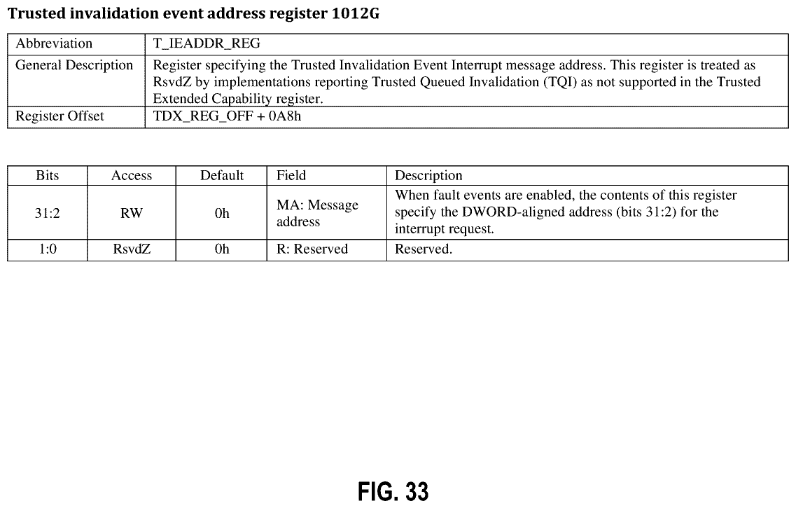

FIG. 33 is an example format of a trusted invalidation event address register 1012G according to examples of the disclosure.

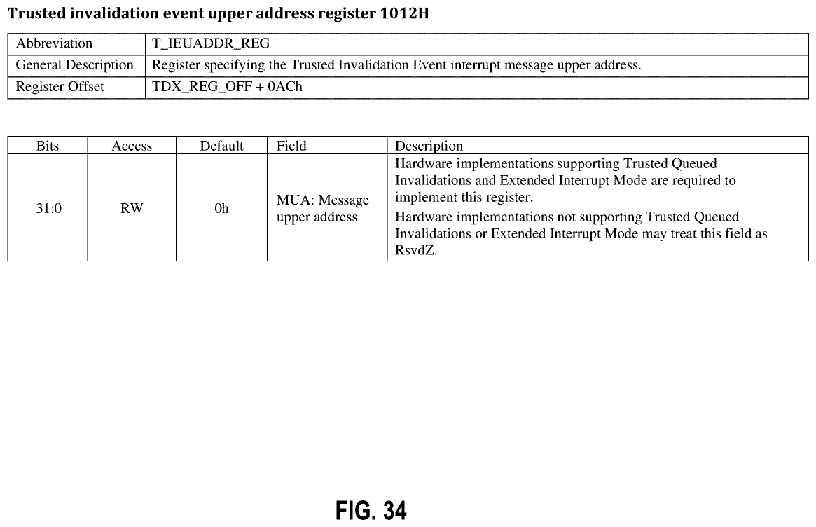

FIG. 34 is an example format of a trusted invalidation event upper address register 1012H according to examples of the disclosure.

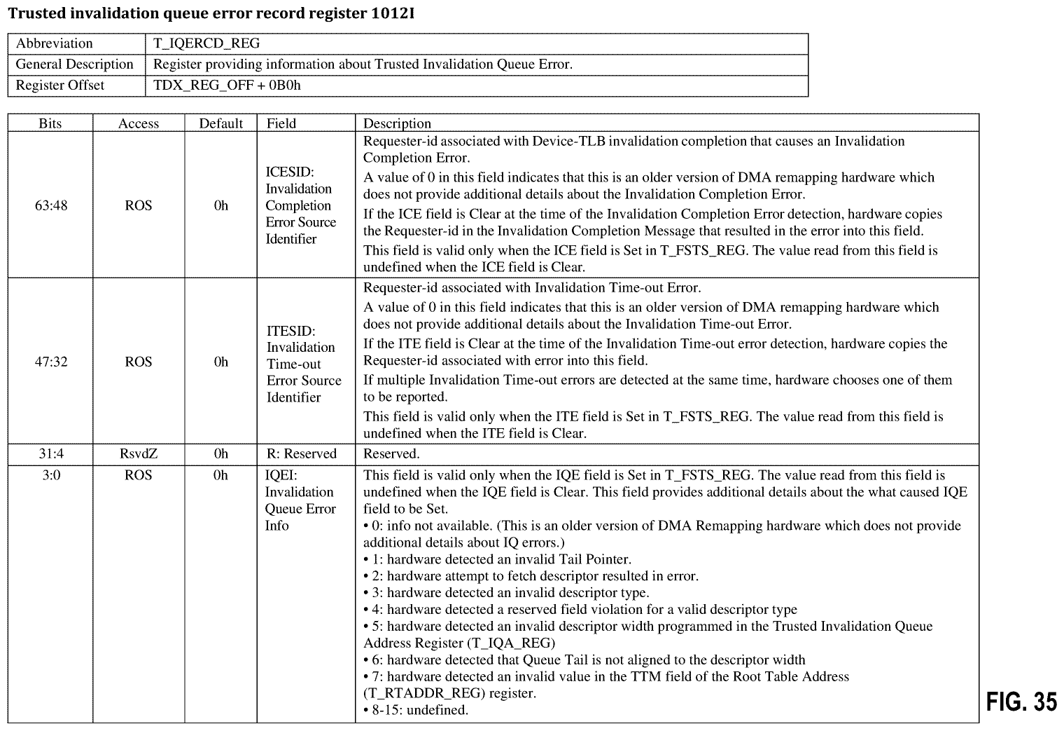

FIG. 35 is an example format of a trusted invalidation queue error record register 1012I according to examples of the disclosure.

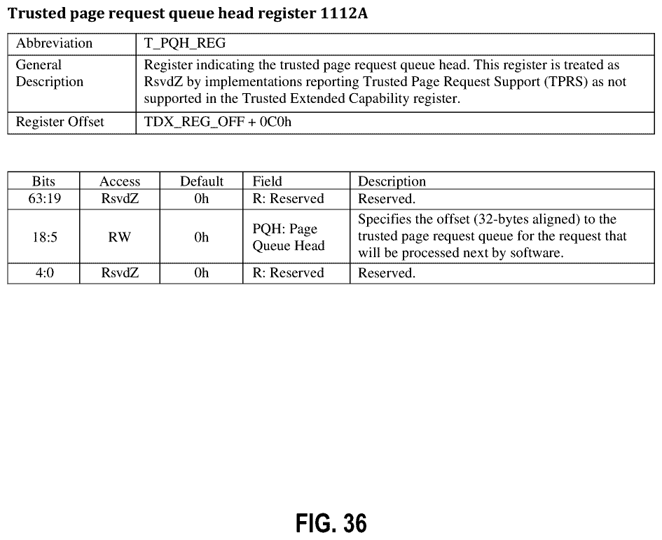

FIG. 36 is an example format of a trusted page request queue head register 1112A according to examples of the disclosure.

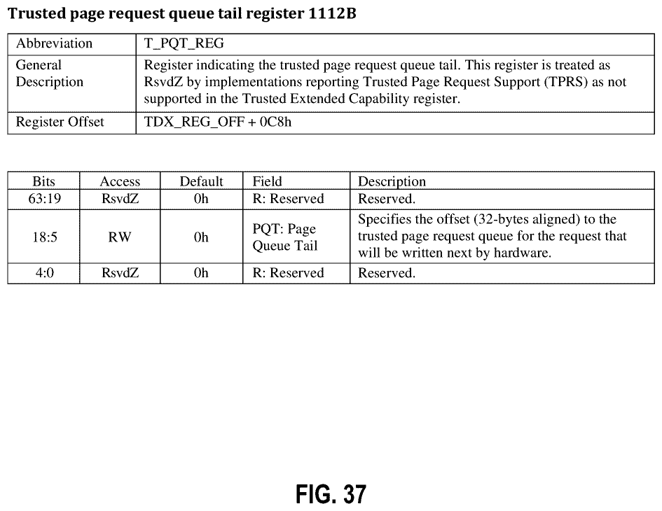

FIG. 37 is an example format of a trusted page request queue tail register 1112B according to examples of the disclosure.

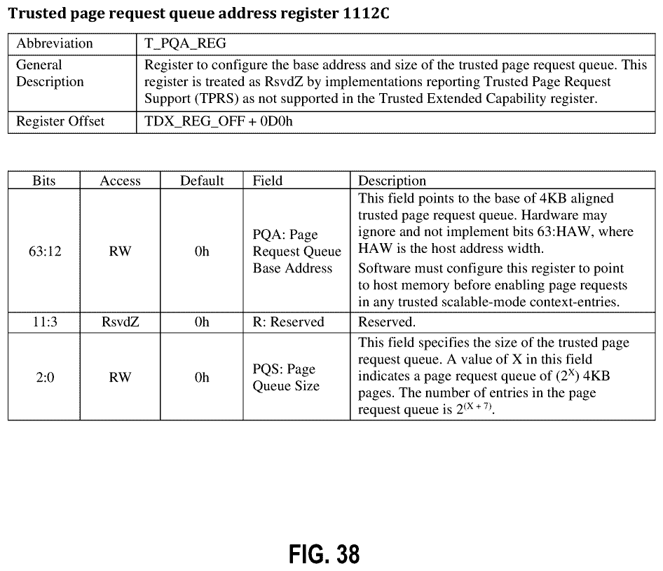

FIG. 38 is an example format of a trusted page request queue address register 1112C according to examples of the disclosure.

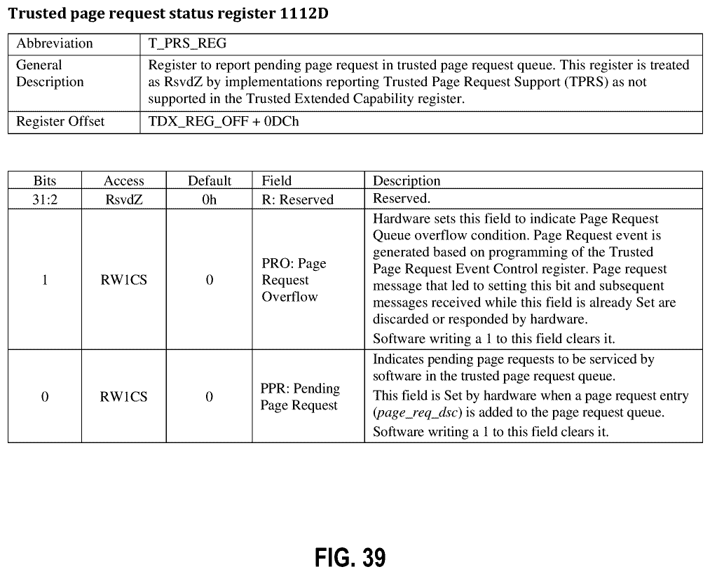

FIG. 39 is an example format of a trusted page request status register 1112D according to examples of the disclosure.

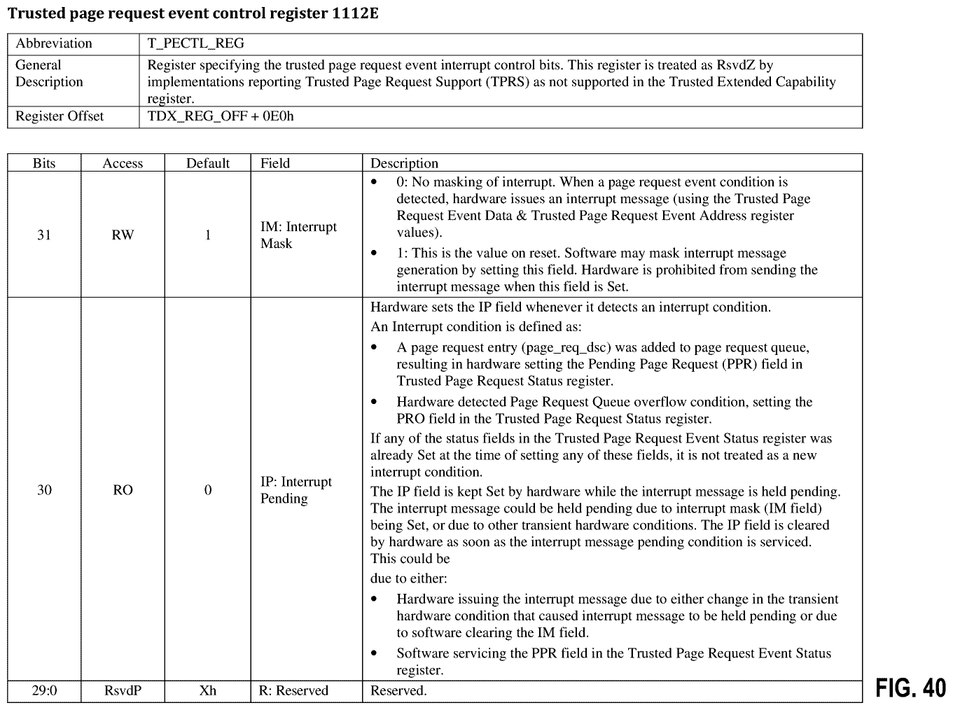

FIG. 40 is an example format of a trusted page request event control register 1112E according to examples of the disclosure.

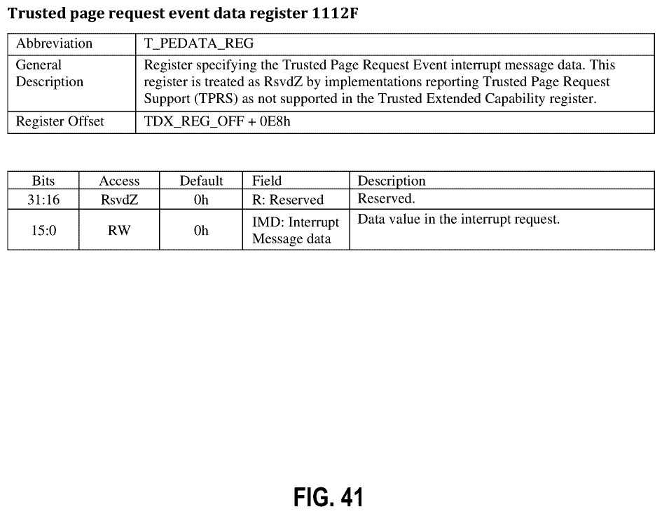

FIG. 41 is an example format of a trusted page request event data register 1112F according to examples of the disclosure.

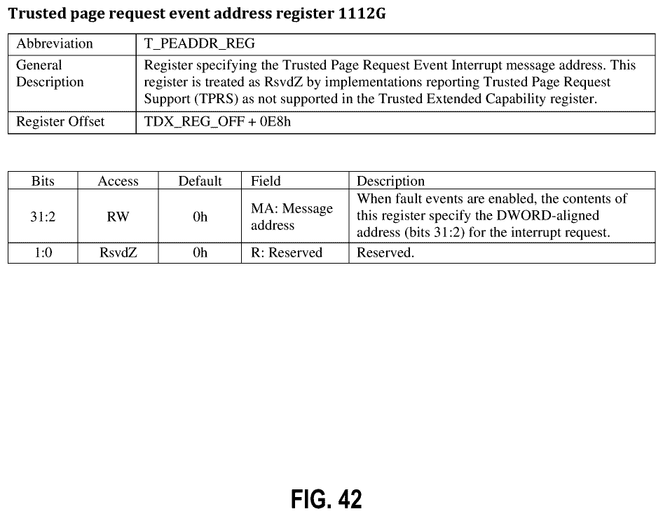

FIG. 42 is an example format of a trusted page request event address register 1112G according to examples of the disclosure.

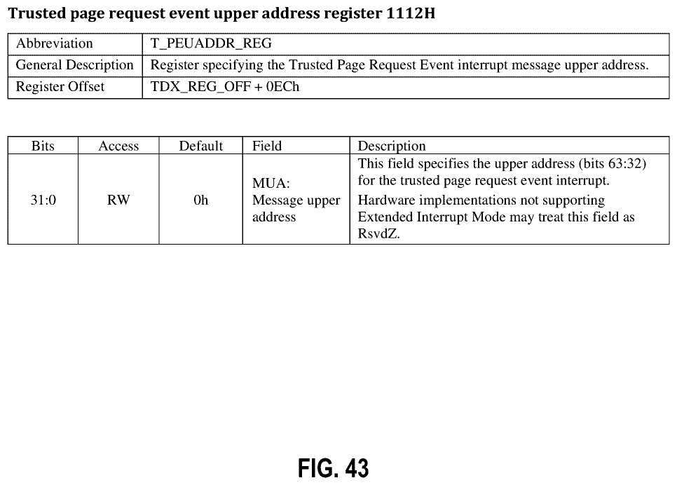

FIG. 43 is an example format of a trusted page request event upper address register 1112H according to examples of the disclosure.

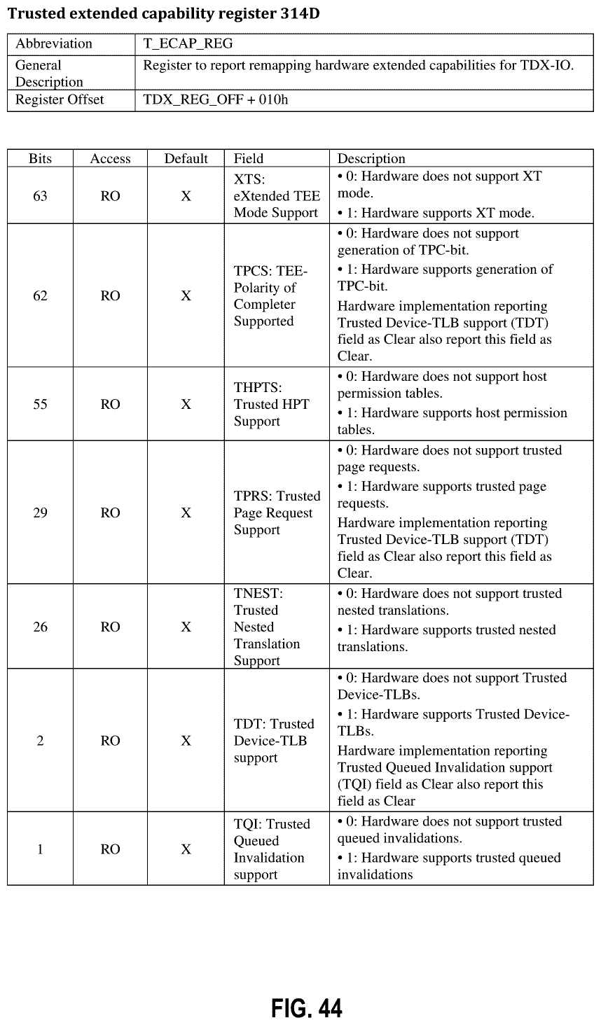

FIG. 44 is an example format of a trusted extended capability register 314D according to examples of the disclosure.

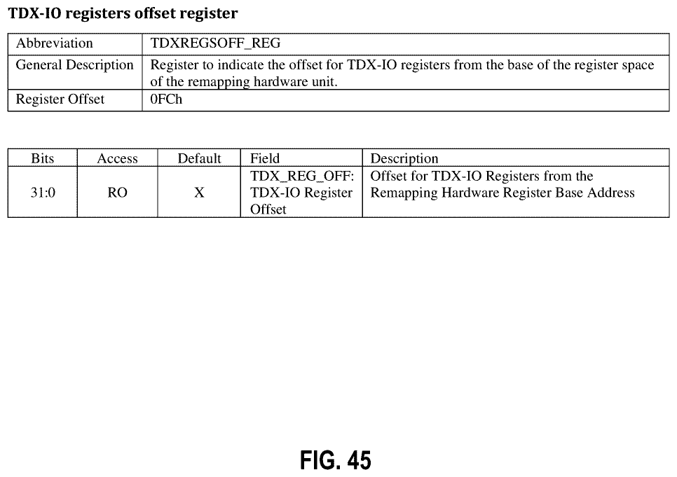

FIG. 45 is an example format of a TDX-IO registers offset register according to examples of the disclosure.

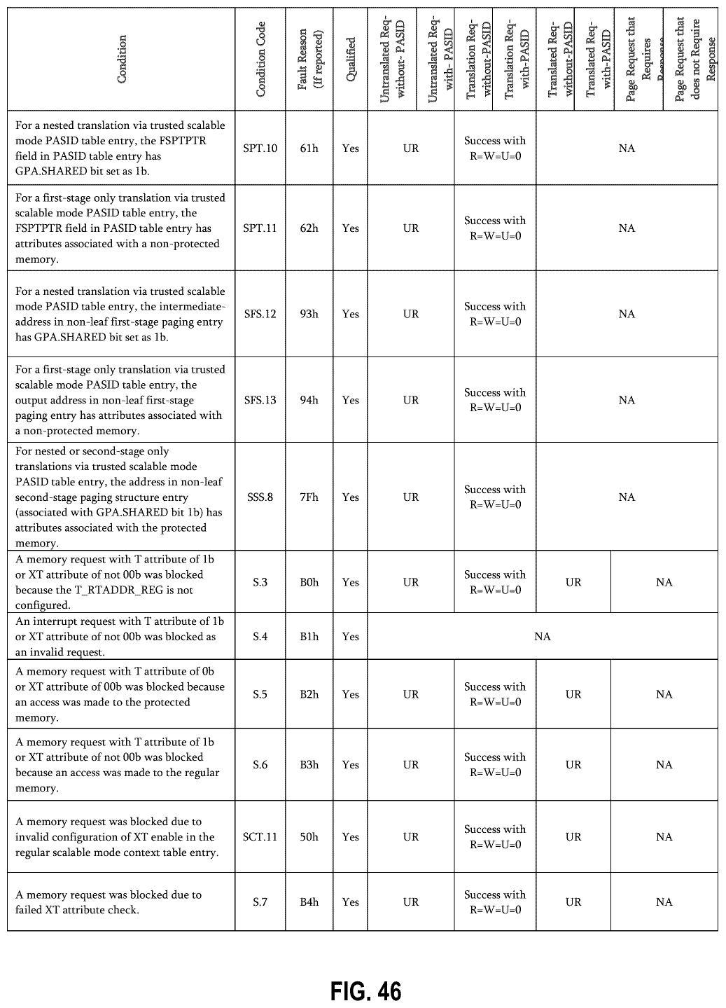

FIG. 46 is an example of new IOMMU error report associated with TDX-IO according to examples of the disclosure.

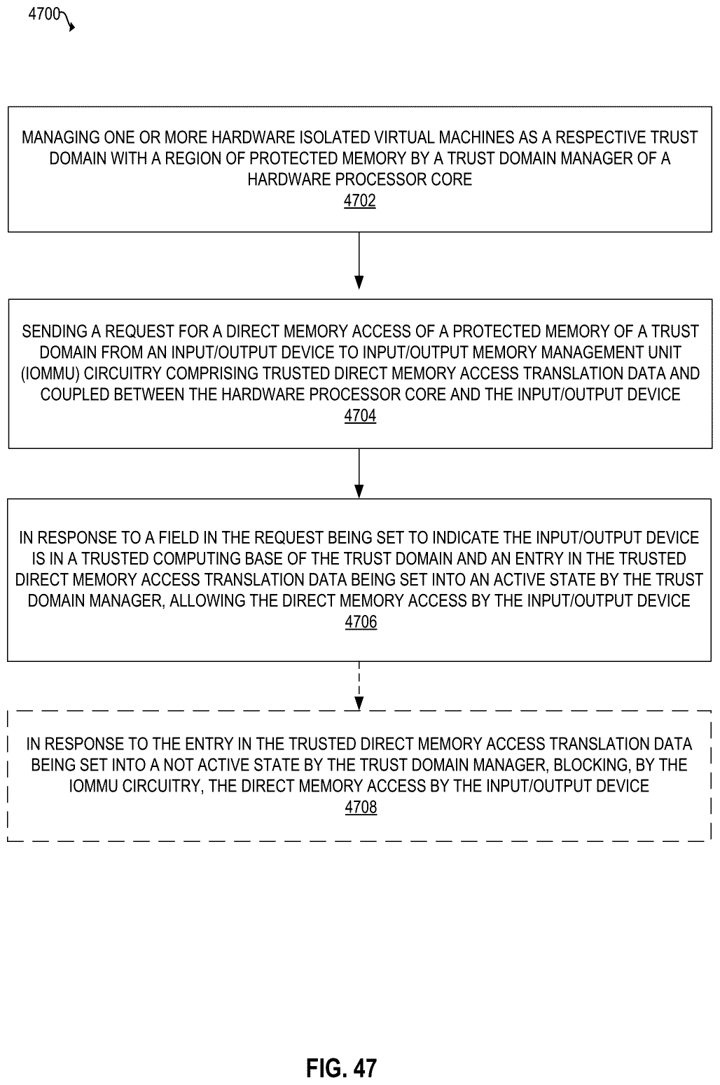

FIG. 47 is a flow diagram illustrating operations 4700 of a method for processing a request for a direct memory access of a protected memory of a trust domain from an input/output device according to examples of the disclosure. Some or all of the operations 4700 (or other processes described herein, or variations, and/or combinations thereof) are performed under the control of a trust domain manager and/or IOMMU as implemented herein and/or one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 4700 are performed by IOMMU 120 (e.g., and/or trust domain manager 101) of the other figures.

The operations 4700 include, at block 4702, managing one or more hardware isolated virtual machines as a respective trust domain with a region of protected memory by a trust domain manager of a hardware processor core. The operations 4700 further include, at block 4704, sending a request for a direct memory access of a protected memory of a trust domain from an input/output device to input/output memory management unit (IOMMU) circuitry comprising trusted direct memory access translation data and coupled between the hardware processor core and the input/output device. The operations 4700 include, at block 4706, in response to a field in the request being set to indicate the input/output device is in a trusted computing base of the trust domain and an entry in the trusted direct memory access translation data being set into an active state by the trust domain manager, allowing the direct memory access by the input/output device. The operations 4700 (optionally) include, at block 4708, in response to the entry in the trusted direct memory access translation data being set into a not active state by the trust domain manager, blocking, by the IOMMU circuitry, the direct memory access by the input/output device.

In certain examples, a (e.g., TDX-IO) register (e.g., in an IOMMU) is read and/or written to by an instruction, for example, according to a method for processing a register instruction according to examples of the disclosure. A processor (e.g., or processor core) may perform operations of a method, e.g., in response to receiving a request to execute an instruction from software. Operations may include processing a “TDX-IO” instruction by performing a: fetch of an instruction (e.g., having an instruction opcode corresponding to the command mnemonic), decode of the instruction into a decoded instruction, retrieve data associated with the instruction, (optionally) schedule the decoded instruction for execution, execute the decoded instruction to set the register, and thus control the functionality of the TDX-IO commands, and commit a result of the executed instruction.

Exemplary architectures, systems, etc. that the above may be used in are detailed below. Exemplary instruction formats that may cause any of the operations herein are detailed below.

At least some examples of the disclosed technologies can be described in view of the following examples:
Example 1. An apparatus comprising:
a hardware processor core to implement a trust domain manager to manage one or more hardware isolated virtual machines as a respective trust domain with a region of protected memory; and
input/output memory management unit (IOMMU) circuitry comprising a cache (e.g., separate from any cache within the hardware processor core) of trusted direct memory access translation data and coupled between the hardware processor core and an input/output device, wherein the IOMMU circuitry is to, for a request from the input/output device for a direct memory access of a guest address of a protected memory of a trust domain:
in response to a field in the request being set to indicate the input/output device is in a trusted computing base of the trust domain and an entry in the cache of trusted direct memory access translation data for the guest address being set into an active (e.g. PRESENT) state by the trust domain manager, determine a host physical address corresponding to the guest address from the entry in the cache of trusted direct memory access translation data, and allow the direct memory access to the host physical address by the input/output device, and
in response to the entry in the cache of trusted direct memory access translation data for the guest address being set into a blocked state for a completed invalidation of the entry by the trust domain manager, block the direct memory access to the host physical address by the input/output device.

Example 2. The apparatus of example 1, wherein the IOMMU circuitry is to, in response to the entry in the cache of trusted direct memory access translation data for the guest address being set into a blocked state for a pending, but not yet queued, invalidation of the entry by the trust domain manager, allow the determination of the host physical address corresponding to the guest address from the entry in the cache of trusted direct memory access translation data, and the direct memory access to the host physical address by the input/output device.

Example 3. The apparatus of any one of examples 1-2, wherein the IOMMU circuitry is to, in response to the entry in the cache of trusted direct memory access translation data for the guest address being set into a blocked state for a queued, but not yet completed, invalidation of the entry by the trust domain manager, allow the determination of the host physical address corresponding to the guest address from the entry in the cache of trusted direct memory access translation data, and the direct memory access to the host physical address by the input/output device.
Example 4. The apparatus of any one of examples 1-3, wherein the entry in the cache of trusted direct memory access translation data for the guest address is set into the blocked state for the completed invalidation of the entry by the trust domain manager in response to the trust domain manager removing the input/output device from the trust domain.
Example 5. The apparatus of any one of examples 1-4, wherein:
the IOMMU circuitry is coupled to a trusted invalidation queue and an untrusted invalidation queue;
a virtual machine monitor of the one or more hardware isolated virtual machines is permitted to cause an indication of invalidation (e.g., request for invalidation) of one or more blocks of memory separate from the protected memory of the trust domain to be stored in the untrusted invalidation queue; and
the trust domain manager, and not the virtual machine monitor of the one or more hardware isolated virtual machines, is permitted to cause an indication of invalidation of one or more blocks of the protected memory of the trust domain to be stored in the trusted invalidation queue.
Example 6. The apparatus of example 5, wherein:
the IOMMU circuitry is coupled to a trusted page request queue and an untrusted page request queue;
the virtual machine monitor of the one or more hardware isolated virtual machines is permitted to cause a page request of a page of memory separate from the protected memory of the trust domain to be read from the untrusted page request queue; and
the trust domain manager, and not the virtual machine monitor of the one or more hardware isolated virtual machines, is permitted to cause a page request of a page of memory of the protected memory of the trust domain to be read from the trusted page request queue.
Example 7. The apparatus of any one of examples 1-6, wherein the guest address is a guest virtual address, and the IOMMU circuitry is to, based at least in part on the entry in the cache of trusted direct memory access translation data, determine a guest physical address corresponding to the guest virtual address, and determine the host physical address based at least in part on the guest physical address.
Example 8. The apparatus of any one of examples 1-7, wherein the IOMMU circuitry comprises untrusted direct memory access translation data, and the untrusted direct memory access translation data is accessed in response to the field being set to another value.
Example 9. A method comprising:
managing one or more hardware isolated virtual machines as a respective trust domain with a region of protected memory by a trust domain manager of a hardware processor core;
sending a request for a direct memory access of a guest address of a protected memory of a trust domain from an input/output device to input/output memory management unit (IOMMU) circuitry comprising a cache of trusted direct memory access translation data and coupled between the hardware processor core and the input/output device;
in response to a field in the request being set to indicate the input/output device is in a trusted computing base of the trust domain and an entry in the cache of trusted direct memory access translation data for the guest address being set into an active state by the trust domain manager, determining a host physical address corresponding to the guest address from the entry in the cache of trusted direct memory access translation data, and allowing the direct memory access to the host physical address by the input/output device; and
in response to the entry in the cache of trusted direct memory access translation data for the guest address being set into a blocked state for a completed invalidation of the entry by the trust domain manager, blocking the direct memory access to the host physical address by the input/output device.
Example 10. The method of example 9, further comprising, in response to the entry in the cache of trusted direct memory access translation data for the guest address being set into a blocked state for a pending, but not yet queued, invalidation of the entry by the trust domain manager, allowing, by the IOMMU circuitry, the determination of the host physical address corresponding to the guest address from the entry in the cache of trusted direct memory access translation data, and the direct memory access to the host physical address by the input/output device.
Example 11. The method of any one of examples 9-10, further comprising, in response to the entry in the cache of trusted direct memory access translation data for the guest address being set into a blocked state for a queued, but not yet completed, invalidation of the entry by the trust domain manager, allowing, by the IOMMU circuitry, the determination of the host physical address corresponding to the guest address from the entry in the cache of trusted direct memory access translation data, and the direct memory access to the host physical address by the input/output device.
Example 12. The method of any one of examples 9-11, further comprising:
removing, by the trust domain manager, the input/output device from the trust domain; and
setting the entry in the cache of trusted direct memory access translation data for the guest address into the blocked state for the completed invalidation of the entry by the trust domain manager in response to the removing the input/output device from the trust domain.
Example 13. The method of any one of examples 9-12, wherein the IOMMU circuitry is coupled to a trusted invalidation queue and an untrusted invalidation queue, and the method further comprises:
permitting, by the IOMMU circuitry, a virtual machine monitor of the one or more hardware isolated virtual machines to cause an indication of invalidation of one or more blocks of memory separate from the protected memory of the trust domain to be stored in the untrusted invalidation queue; and
permitting, by the IOMMU circuitry, the trust domain manager, and not the virtual machine monitor of the one or more hardware isolated virtual machines, to cause an indication of invalidation of one or more blocks of the protected memory of the trust domain to be stored in the trusted invalidation queue.
Example 14. The method of example 13, wherein the IOMMU circuitry is coupled to a trusted page request queue and an untrusted page request queue, and the method further comprises:
permitting, by the IOMMU circuitry, the virtual machine monitor of the one or more hardware isolated virtual machines to cause a page request of a page of memory separate from the protected memory of the trust domain to be stored in the untrusted page request queue; and
permitting, by the IOMMU circuitry, the trust domain manager, and not the virtual machine monitor of the one or more hardware isolated virtual machines, to cause a page request of a page of memory of the protected memory of the trust domain to be stored in the trusted page request queue.
Example 15. The method of any one of examples 9-14, wherein the guest address is a guest virtual address, and the determining the host physical address comprises:
determining, by the IOMMU circuitry, a guest physical address corresponding to the guest virtual address based at least in part on the entry in the cache of trusted direct memory access translation data; and
determining, by the IOMMU circuitry, the host physical address based at least in part on the guest physical address.
Example 16. The method of any one of examples 9-15, wherein the IOMMU circuitry comprises untrusted direct memory access translation data, and the method further comprises accessing the untrusted direct memory access translation data in response to the field being set to another value.
Example 17. A system comprising:
a hardware processor core to implement a trust domain manager to manage one or more hardware isolated virtual machines as a respective trust domain with a region of protected memory;
an input/output device coupled to the hardware processor core; and
input/output memory management unit (IOMMU) circuitry comprising a cache of trusted direct memory access translation data and coupled between the hardware processor core and the input/output device, wherein the IOMMU circuitry is to, for a request from the input/output device for a direct memory access of a guest address of a protected memory of a trust domain:
in response to a field in the request being set to indicate the input/output device is in a trusted computing base of the trust domain and an entry in the cache of trusted direct memory access translation data for the guest address being set into an active state by the trust domain manager, determine a host physical address corresponding to the guest address from the entry in the cache of trusted direct memory access translation data, and allow the direct memory access to the host physical address by the input/output device, and
in response to the entry in the cache of trusted direct memory access translation data for the guest address being set into a blocked state for a completed invalidation of the entry by the trust domain manager, block the direct memory access to the host physical address by the input/output device.
Example 18. The system of example 17, wherein the IOMMU circuitry is to, in response to the entry in the cache of trusted direct memory access translation data for the guest address being set into a blocked state for a pending, but not yet queued, invalidation of the entry by the trust domain manager, allow the determination of the host physical address corresponding to the guest address from the entry in the cache of trusted direct memory access translation data, and the direct memory access to the host physical address by the input/output device.
Example 19. The system of any one of examples 17-18, wherein the IOMMU circuitry is to, in response to the entry in the cache of trusted direct memory access translation data for the guest address being set into a blocked state for a queued, but not yet completed, invalidation of the entry by the trust domain manager, allow the determination of the host physical address corresponding to the guest address from the entry in the cache of trusted direct memory access translation data, and the direct memory access to the host physical address by the input/output device.
Example 20. The system of any one of examples 17-19, wherein the entry in the cache of trusted direct memory access translation data for the guest address is set into the blocked state for the completed invalidation of the entry by the trust domain manager in response to the trust domain manager removing the input/output device from the trust domain.
Example 21. The system of any one of examples 17-20, wherein:
the IOMMU circuitry is coupled to a trusted invalidation queue and an untrusted invalidation queue;
a virtual machine monitor of the one or more hardware isolated virtual machines is permitted to cause an indication of invalidation of one or more blocks of memory separate from the protected memory of the trust domain to be stored in the untrusted invalidation queue; and
the trust domain manager, and not the virtual machine monitor of the one or more hardware isolated virtual machines, is permitted to cause an indication of invalidation of one or more blocks of the protected memory of the trust domain to be stored in the trusted invalidation queue.
Example 22. The system of example 21, wherein:
the IOMMU circuitry is coupled to a trusted page request queue and an untrusted page request queue;
the virtual machine monitor of the one or more hardware isolated virtual machines is permitted to cause a page request of a page of memory separate from the protected memory of the trust domain to be read from the untrusted page request queue; and
the trust domain manager, and not the virtual machine monitor of the one or more hardware isolated virtual machines, is permitted to cause a page request of a page of memory of the protected memory of the trust domain to be read from the trusted page request queue.
Example 23. The system of any one of examples 17-22, wherein the guest address is a guest virtual address, and the IOMMU circuitry is to, based at least in part on the entry in the cache of trusted direct memory access translation data, determine a guest physical address corresponding to the guest virtual address, and determine the host physical address based at least in part on the guest physical address.
Example 24. The system of any one of examples 17-23, wherein the IOMMU circuitry comprises untrusted direct memory access translation data, and the untrusted direct memory access translation data is accessed in response to the field being set to another value.
Example 25. An apparatus comprising:
a hardware processor core to implement a trust domain manager to manage one or more hardware isolated virtual machines as a respective trust domain with a region of protected memory; and
input/output memory management unit (IOMMU) circuitry comprising trusted direct memory access translation data and coupled between the hardware processor core and an input/output device, wherein the IOMMU circuitry is to, for a request from the input/output device for a direct memory access of a protected memory of a trust domain:
in response to a field in the request being set to indicate the input/output device is in a trusted computing base of the trust domain and an entry in the trusted direct memory access translation data being set into an active state by the trust domain manager, allow the direct memory access by the input/output device.
Example 26. The apparatus of example 25, wherein the IOMMU circuitry is to, in response to the entry in the trusted direct memory access translation data being set into a not active state by the trust domain manager, block the direct memory access by the input/output device.
Example 27. The apparatus of example 25, wherein the IOMMU circuitry is to perform a protection check for an address in the request, and
in response to a successful protection check, allow the direct memory access by the input/output device, and
in response to an unsuccessful protection check, block the direct memory access by the input/output device.
Example 28. The apparatus of example 25, wherein the IOMMU circuitry is to perform an address translation to determine a host physical address corresponding to a guest address in the request, and
in response to a successful address translation, allow the direct memory access by the input/output device, and
in response to an unsuccessful address translation, block the direct memory access by the input/output device.
Example 29. The apparatus of example 28, wherein the guest address is a guest virtual address, and the IOMMU circuitry is to, based at least in part on the entry in the trusted direct memory access translation data, determine a guest physical address corresponding to the guest virtual address, and determine the host physical address based at least in part on the guest physical address.
Example 30. The apparatus of example 25, wherein the IOMMU circuitry is coupled to a trusted data structure and an untrusted data structure; and
in response to the field in the request being set to indicate the input/output device is in the trusted computing base of the trust domain, the IOMMU circuitry is to access the trusted data structure; and
in response to the field in the request being set to another value, the IOMMU circuitry is to access the untrusted data structure.
Example 31. The apparatus of example 25, wherein the IOMMU circuitry comprises a trusted interface and an untrusted interface, and the IOMMU circuitry is to permit access to the trusted interface from the trust domain manager, and not another software agent (e.g., a VMM).
Example 32. The apparatus of example 25, wherein the IOMMU circuitry comprises a trusted interface and an untrusted interface; and
a virtual machine monitor of the one or more hardware isolated virtual machines is permitted to access the untrusted interface; and
the trust domain manager, and not the virtual machine monitor of the one or more hardware isolated virtual machines, is permitted to access the trusted interface.
Example 33. The apparatus of example 25, wherein the IOMMU circuitry is coupled to a trusted data structure and an untrusted data structure; and
a virtual machine monitor of the one or more hardware isolated virtual machines is permitted to access the untrusted data structure; and
the trust domain manager, and not the virtual machine monitor of the one or more hardware isolated virtual machines, is permitted to access the trusted data structure.
Example 34. The apparatus of example 25, wherein the IOMMU circuitry comprises untrusted direct memory access translation data, and the untrusted direct memory access translation data is accessed in response to the field being set to another value.
Example 35. The apparatus of example 25, wherein:
the IOMMU circuitry is coupled to a trusted invalidation queue and an untrusted invalidation queue;
a virtual machine monitor of the one or more hardware isolated virtual machines is permitted to cause an indication of invalidation of one or more blocks of memory separate from the protected memory of the trust domain to be stored in the untrusted invalidation queue; and
the trust domain manager, and not the virtual machine monitor of the one or more hardware isolated virtual machines, is permitted to cause an indication of invalidation of one or more blocks of the protected memory of the trust domain to be stored in the trusted invalidation queue.
Example 36. The apparatus of example 35, wherein:
the IOMMU circuitry is coupled to a trusted page request queue and an untrusted page request queue;
the virtual machine monitor of the one or more hardware isolated virtual machines is permitted to cause a page request of a page of memory separate from the protected memory of the trust domain to be read from the untrusted page request queue; and
the trust domain manager, and not the virtual machine monitor of the one or more hardware isolated virtual machines, is permitted to cause a page request of a page of memory of the protected memory of the trust domain to be read from the trusted page request queue.
Example 37. The apparatus of example 28, wherein the IOMMU circuitry, in response to a field in the request being set to indicate the request is targeting the protected memory of trust domain and the host physical address is corresponding to a not trust domain memory, block the direct memory access by the input/output device.
Example 38. The apparatus of example 28, wherein the IOMMU circuitry, in response to a field in the request being set to indicate the request is targeting a not trust domain memory and the host physical address is corresponding to the protected memory of the trust domain, block the direct memory access by the input/output device.
Example 39. A method comprising:
managing one or more hardware isolated virtual machines as a respective trust domain with a region of protected memory by a trust domain manager of a hardware processor core;
sending a request for a direct memory access of a protected memory of a trust domain from an input/output device to input/output memory management unit (IOMMU) circuitry comprising trusted direct memory access translation data and coupled between the hardware processor core and the input/output device; and
in response to a field in the request being set to indicate the input/output device is in a trusted computing base of the trust domain and an entry in the trusted direct memory access translation data being set into an active state by the trust domain manager, allowing the direct memory access by the input/output device.
Example 40. The method of example 39, further comprising, in response to the entry in the trusted direct memory access translation data being set into a not active state by the trust domain manager, blocking, by the IOMMU circuitry, the direct memory access by the input/output device.
Example 41. The method of example 39, further comprising:
performing, by the IOMMU circuitry, a protection check for an address in the request;
in response to a successful protection check, allowing, by the IOMMU circuitry, the direct memory access by the input/output device; and
in response to an unsuccessful protection check, blocking, by the IOMMU circuitry, the direct memory access by the input/output device.
Example 42. The method of example 39, further comprising:
performing, by the IOMMU circuitry, an address translation to determine a host physical address corresponding to a guest address in the request;
in response to a successful address translation, allowing, by the IOMMU circuitry, the direct memory access by the input/output device; and
in response to an unsuccessful address translation, blocking, by the IOMMU circuitry, the direct memory access by the input/output device.
Example 43. The method of example 42, wherein the guest address is a guest virtual address, and the method further comprises:
determining, by the IOMMU circuitry and based at least in part on the entry in the trusted direct memory access translation data:
a guest physical address corresponding to the guest virtual address, and the host physical address based at least in part on the guest physical address.
Example 44. The method of example 39, wherein the IOMMU circuitry is coupled to a trusted data structure and an untrusted data structure, and the method further comprises:
in response to the field in the request being set to indicate the input/output device is in the trusted computing base of the trust domain, accessing, by the IOMMU circuitry, the trusted data structure; and
in response to the field in the request being set to another value, accessing, by the IOMMU circuitry, the untrusted data structure.
Example 45. The method of example 39, wherein the IOMMU circuitry comprises a trusted interface and an untrusted interface, and the method further comprises permit access, by the IOMMU circuitry, to the trusted interface from the trust domain manager, and not another software agent (e.g., a VMM).
Example 46. The method of example 39, wherein the IOMMU circuitry comprises a trusted interface and an untrusted interface, and the method further comprises:
permitting access to the untrusted interface by a virtual machine monitor of the one or more hardware isolated virtual machines; and
permitting access to the trusted interface by the trust domain manager, and not the virtual machine monitor of the one or more hardware isolated virtual machines.
Example 47. The method of example 39, wherein the IOMMU circuitry is coupled to a trusted data structure and an untrusted data structure, and the method further comprises:
permitting access to the untrusted data structure by a virtual machine monitor of the one or more hardware isolated virtual machines; and
permitting access to the trusted data structure by the trust domain manager, and not the virtual machine monitor of the one or more hardware isolated virtual machines.
Example 48. The method of example 39, wherein the IOMMU circuitry comprises untrusted direct memory access translation data, and the method further comprises accessing the untrusted direct memory access translation data in response to the field being set to another value.
Example 49. A system comprising:
a hardware processor core to implement a trust domain manager to manage one or more hardware isolated virtual machines as a respective trust domain with a region of protected memory;
an input/output device coupled to the hardware processor core; and
input/output memory management unit (IOMMU) circuitry comprising trusted direct memory access translation data and coupled between the hardware processor core and the input/output device, wherein the IOMMU circuitry is to, for a request from the input/output device for a direct memory access of a protected memory of a trust domain:
in response to a field in the request being set to indicate the input/output device is in a trusted computing base of the trust domain and an entry in the trusted direct memory access translation data being set into an active state by the trust domain manager, allow the direct memory access by the input/output device.
Example 50. The system of example 49, wherein the IOMMU circuitry is to, in response to the entry in the trusted direct memory access translation data being set into a not active state by the trust domain manager, block the direct memory access by the input/output device.
Example 51. The system of example 49, wherein the IOMMU circuitry is to perform a protection check for an address in the request, and
in response to a successful protection check, allow the direct memory access by the input/output device, and
in response to an unsuccessful protection check, block the direct memory access by the input/output device.
Example 52. The system of example 49, wherein the IOMMU circuitry is to perform an address translation to determine a host physical address corresponding to a guest address in the request, and
in response to a successful address translation, allow the direct memory access by the input/output device, and
in response to an unsuccessful address translation, block the direct memory access by the input/output device.
Example 53. The system of example 52, wherein the guest address is a guest virtual address, and the IOMMU circuitry is to, based at least in part on the entry in the trusted direct memory access translation data, determine a guest physical address corresponding to the guest virtual address, and determine the host physical address based at least in part on the guest physical address.
Example 54. The system of any one of examples 49-53, wherein the IOMMU circuitry is to perform an address translation to determine a host physical address corresponding to a guest address in the request, and in response to the host physical address being associated with the protected memory, send a trusted indication (e.g., a TPC-bit, such as, but not limited to, a TEE Exclusive Attribute bit) to the input/output device.
Example 55. The apparatus of any one of examples 25-38, wherein the IOMMU circuitry is to perform an address translation to determine a host physical address corresponding to a guest address in the request, and in response to the host physical address being associated with the protected memory, send a trusted indication (e.g., a TPC-bit, such as, but not limited to, a TEE Exclusive Attribute bit) to the input/output device.
Example 56. The method of any one of examples 39-48, further comprising:
performing, by the IOMMU circuitry, an address translation to determine a host physical address corresponding to a guest address in the request; and
in response to the host physical address being associated with the protected memory, sending, by the IOMMU circuitry, a trusted indication (e.g., a TPC-bit, such as, but not limited to, a TEE Exclusive Attribute bit) to the input/output device.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 48 illustrates an example computing system. Multiprocessor system 4800 is an interfaced system and includes a plurality of processors or cores including a first processor 4870 and a second processor 4880 coupled via an interface 4850 such as a point-to-point (P-P) interconnect, a fabric, and/or bus. In some examples, the first processor 4870 and the second processor 4880 are homogeneous. In some examples, first processor 4870 and the second processor 4880 are heterogenous. Though the example system 4800 is shown to have two processors, the system may have three or more processors, or may be a single processor system. In some examples, the computing system is a system on a chip (SoC).

Processors 4870 and 4880 are shown including integrated memory controller (IMC) circuitry 4872 and 4882, respectively. Processor 4870 also includes interface circuits 4876 and 4878; similarly, second processor 4880 includes interface circuits 4886 and 4888. Processors 4870, 4880 may exchange information via the interface 4850 using interface circuits 4878, 4888. IMCs 4872 and 4882 couple the processors 4870, 4880 to respective memories, namely a memory 4832 and a memory 4834, which may be portions of main memory locally attached to the respective processors.

Processors 4870, 4880 may each exchange information with a network interface (NW I/F) 4890 via individual interfaces 4852, 4854 using interface circuits 4876, 4894, 4886, 4898. The network interface 4890 (e.g., one or more of an interconnect, bus, and/or fabric, and in some examples is a chipset) may optionally exchange information with a coprocessor 4838 via an interface circuit 4892. In some examples, the coprocessor 4838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 4870, 4880 or outside of both processors, yet connected with the processors via an interface such as P-P interconnect, such that either or both processors' local cache information may be stored in the shared cache if a processor is placed into a low power mode.

Network interface 4890 may be coupled to a first interface 4816 via interface circuit 4896. In some examples, first interface 4816 may be an interface such as a Peripheral Component Interconnect (PCI) interconnect, a PCI Express interconnect or another I/O interconnect. In some examples, first interface 4816 is coupled to a power control unit (PCU) 4817, which may include circuitry, software, and/or firmware to perform power management operations with regard to the processors 4870, 4880 and/or co-processor 4838. PCU 4817 provides control information to a voltage regulator (not shown) to cause the voltage regulator to generate the appropriate regulated voltage. PCU 4817 also provides control information to control the operating voltage generated. In various examples, PCU 4817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 4817 is illustrated as being present as logic separate from the processor 4870 and/or processor 4880. In other cases, PCU 4817 may execute on a given one or more of cores (not shown) of processor 4870 or 4880. In some cases, PCU 4817 may be implemented as a microcontroller (dedicated or general-purpose) or other control logic configured to execute its own dedicated power management code, sometimes referred to as P-code. In yet other examples, power management operations to be performed by PCU 4817 may be implemented externally to a processor, such as by way of a separate power management integrated circuit (PMIC) or another component external to the processor. In yet other examples, power management operations to be performed by PCU 4817 may be implemented within BIOS or other system software.

Various I/O devices 4814 may be coupled to first interface 4816, along with a bus bridge 4818 which couples first interface 4816 to a second interface 4820. In some examples, one or more additional processor(s) 4815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 4816. In some examples, second interface 4820 may be a low pin count (LPC) interface. Various devices may be coupled to second interface 4820 including, for example, a keyboard and/or mouse 4822, communication devices 4827 and storage circuitry 4828. Storage circuitry 4828 may be one or more non-transitory machine-readable storage media as described below, such as a disk drive or other mass storage device which may include instructions/code and data 4830 and may implement the storage 4828 in some examples. Further, an audio I/O 4824 may be coupled to second interface 4820. Note that other architectures than the point-to-point architecture described above are possible. For example, instead of the point-to-point architecture, a system such as multiprocessor system 4800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 49 illustrates a block diagram of an example processor and/or SoC 4900 that may have one or more cores and an integrated memory controller. The solid lined boxes illustrate a processor 4900 with a single core 4902(A), system agent unit circuitry 4910, and a set of one or more interface controller unit(s) circuitry 4916, while the optional addition of the dashed lined boxes illustrates an alternative processor 4900 with multiple cores 4902(A)-(N), a set of one or more integrated memory controller unit(s) circuitry 4914 in the system agent unit circuitry 4910, and special purpose logic 4908, as well as a set of one or more interface controller units circuitry 4916. Note that the processor 4900 may be one of the processors 4870 or 4880, or co-processor 4838 or 4815 of FIG. 48.

Thus, different implementations of the processor 4900 may include: 1) a CPU with the special purpose logic 4908 being integrated graphics and/or scientific (throughput) logic (which may include one or more cores, not shown), and the cores 4902(A)-(N) being one or more general purpose cores (e.g., general purpose in-order cores, general purpose out-of-order cores, or a combination of the two); 2) a coprocessor with the cores 4902(A)-(N) being a large number of special purpose cores intended primarily for graphics and/or scientific (throughput); and 3) a coprocessor with the cores 4902(A)-(N) being a large number of general purpose in-order cores. Thus, the processor 4900 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 4900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 4904(A)-(N) within the cores 4902(A)-(N), a set of one or more shared cache unit(s) circuitry 4906, and external memory (not shown) coupled to the set of integrated memory controller unit(s) circuitry 4914. The set of one or more shared cache unit(s) circuitry 4906 may include one or more mid-level caches, such as level 2 (L2), level 3 (L3), level 4 (L4), or other levels of cache, such as a last level cache (LLC), and/or combinations thereof. While in some examples interface network circuitry 4912 (e.g., a ring interconnect) interfaces the special purpose logic 4908 (e.g., integrated graphics logic), the set of shared cache unit(s) circuitry 4906, and the system agent unit circuitry 4910, alternative examples use any number of well-known techniques for interfacing such units. In some examples, coherency is maintained between one or more of the shared cache unit(s) circuitry 4906 and cores 4902(A)-(N). In some examples, interface controller units circuitry 4916 couple the cores 4902 to one or more other devices 4918 such as one or more I/O devices, storage, one or more communication devices (e.g., wireless networking, wired networking, etc.), etc.

In some examples, one or more of the cores 4902(A)-(N) are capable of multi-threading. The system agent unit circuitry 4910 includes those components coordinating and operating cores 4902(A)-(N). The system agent unit circuitry 4910 may include, for example, power control unit (PCU) circuitry and/or display unit circuitry (not shown). The PCU may be or may include logic and components needed for regulating the power state of the cores 4902(A)-(N) and/or the special purpose logic 4908 (e.g., integrated graphics logic). The display unit circuitry is for driving one or more externally connected displays.

The cores 4902(A)-(N) may be homogenous in terms of instruction set architecture (ISA). Alternatively, the cores 4902(A)-(N) may be heterogeneous in terms of ISA; that is, a subset of the cores 4902(A)-(N) may be capable of executing an ISA, while other cores may be capable of executing only a subset of that ISA or another ISA.

### Example Core Architectures—In-Order and Out-of-Order Core Block Diagram.

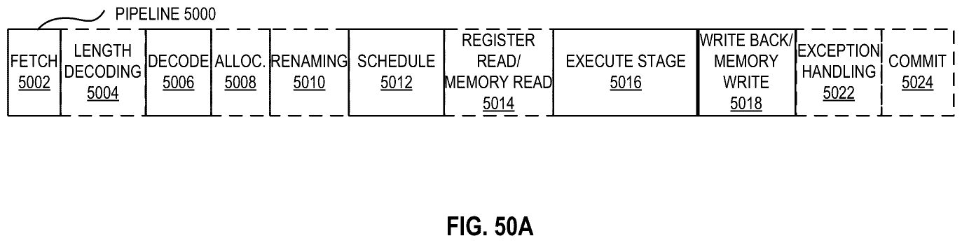

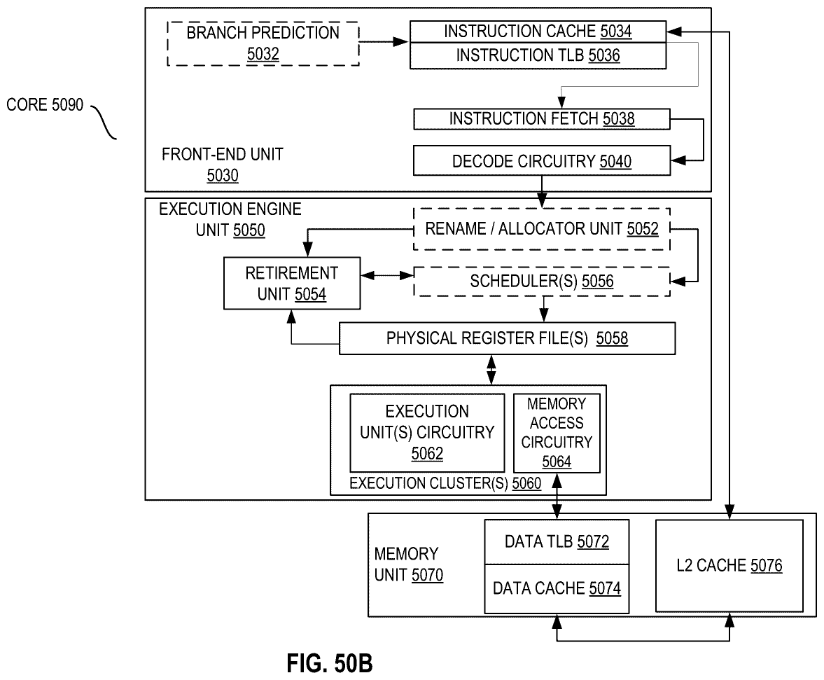

FIG. 50A is a block diagram illustrating both an example in-order pipeline and an example register renaming, out-of-order issue/execution pipeline according to examples. FIG. 50B is a block diagram illustrating both an example in-order architecture core and an example register renaming, out-of-order issue/execution architecture core to be included in a processor according to examples. The solid lined boxes in FIGS. 50A-50B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 50A, a processor pipeline 5000 includes a fetch stage 5002, an optional length decoding stage 5004, a decode stage 5006, an optional allocation (Alloc) stage 5008, an optional renaming stage 5010, a schedule (also known as a dispatch or issue) stage 5012, an optional register read/memory read stage 5014, an execute stage 5016, a write back/memory write stage 5018, an optional exception handling stage 5022, and an optional commit stage 5024. One or more operations can be performed in each of these processor pipeline stages. For example, during the fetch stage 5002, one or more instructions are fetched from instruction memory, and during the decode stage 5006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 5006 and the register read/memory read stage 5014 may be combined into one pipeline stage. In one example, during the execute stage 5016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 50B may implement the pipeline 5000 as follows: 1) the instruction fetch circuitry 5038 performs the fetch and length decoding stages 5002 and 5004; 2) the decode circuitry 5040 performs the decode stage 5006; 3) the rename/allocator unit circuitry 5052 performs the allocation stage 5008 and renaming stage 5010; 4) the scheduler(s) circuitry 5056 performs the schedule stage 5012; 5) the physical register file(s) circuitry 5058 and the memory unit circuitry 5070 perform the register read/memory read stage 5014; the execution cluster(s) 5060 perform the execute stage 5016; 6) the memory unit circuitry 5070 and the physical register file(s) circuitry 5058 perform the write back/memory write stage 5018; 7) various circuitry may be involved in the exception handling stage 5022; and 8) the retirement unit circuitry 5054 and the physical register file(s) circuitry 5058 perform the commit stage 5024.

FIG. 50B shows a processor core 5090 including front-end unit circuitry 5030 coupled to execution engine unit circuitry 5050, and both are coupled to memory unit circuitry 5070. The core 5090 may be a reduced instruction set architecture computing (RISC) core, a complex instruction set architecture computing (CISC) core, a very long instruction word (VLIW) core, or a hybrid or alternative core type. As yet another option, the core 5090 may be a special-purpose core, such as, for example, a network or communication core, compression engine, coprocessor core, general purpose computing graphics processing unit (GPGPU) core, graphics core, or the like.

The front-end unit circuitry 5030 may include branch prediction circuitry 5032 coupled to instruction cache circuitry 5034, which is coupled to an instruction translation lookaside buffer (TLB) 5036, which is coupled to instruction fetch circuitry 5038, which is coupled to decode circuitry 5040. In one example, the instruction cache circuitry 5034 is included in the memory unit circuitry 5070 rather than the front-end circuitry 5030. The decode circuitry 5040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 5040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 5040 may be implemented using various different mechanisms. Examples of suitable mechanisms include, but are not limited to, look-up tables, hardware implementations, programmable logic arrays (PLAs), microcode read only memories (ROMs), etc. In one example, the core 5090 includes a microcode ROM (not shown) or other medium that stores microcode for certain macroinstructions (e.g., in decode circuitry 5040 or otherwise within the front-end circuitry 5030). In one example, the decode circuitry 5040 includes a micro-operation (micro-op) or operation cache (not shown) to hold/cache decoded operations, micro-tags, or micro-operations generated during the decode or other stages of the processor pipeline 5000. The decode circuitry 5040 may be coupled to rename/allocator unit circuitry 5052 in the execution engine circuitry 5050.

The execution engine circuitry 5050 includes the rename/allocator unit circuitry 5052 coupled to retirement unit circuitry 5054 and a set of one or more scheduler(s) circuitry 5056. The scheduler(s) circuitry 5056 represents any number of different schedulers, including reservations stations, central instruction window, etc. In some examples, the scheduler(s) circuitry 5056 can include arithmetic logic unit (ALU) scheduler/scheduling circuitry, ALU queues, address generation unit (AGU) scheduler/scheduling circuitry, AGU queues, etc. The scheduler(s) circuitry 5056 is coupled to the physical register file(s) circuitry 5058. Each of the physical register file(s) circuitry 5058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 5058 includes vector registers unit circuitry, writemask registers unit circuitry, and scalar register unit circuitry. These register units may provide architectural vector registers, vector mask registers, general-purpose registers, etc. The physical register file(s) circuitry 5058 is coupled to the retirement unit circuitry 5054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 5054 and the physical register file(s) circuitry 5058 are coupled to the execution cluster(s) 5060. The execution cluster(s) 5060 includes a set of one or more execution unit(s) circuitry 5062 and a set of one or more memory access circuitry 5064. The execution unit(s) circuitry 5062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 5056, physical register file(s) circuitry 5058, and execution cluster(s) 5060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 5064). It should also be understood that where separate pipelines are used, one or more of these pipelines may be out-of-order issue/execution and the rest in-order.

In some examples, the execution engine unit circuitry 5050 may perform load store unit (LSU) address/data pipelining to an Advanced Microcontroller Bus (AMB) interface (not shown), and address phase and writeback, data phase load, store, and branches.

The set of memory access circuitry 5064 is coupled to the memory unit circuitry 5070, which includes data TLB circuitry 5072 coupled to data cache circuitry 5074 coupled to level 2 (L2) cache circuitry 5076. In one example, the memory access circuitry 5064 may include load unit circuitry, store address unit circuitry, and store data unit circuitry, each of which is coupled to the data TLB circuitry 5072 in the memory unit circuitry 5070. The instruction cache circuitry 5034 is further coupled to the level 2 (L2) cache circuitry 5076 in the memory unit circuitry 5070. In one example, the instruction cache 5034 and the data cache 5074 are combined into a single instruction and data cache (not shown) in L2 cache circuitry 5076, level 3 (L3) cache circuitry (not shown), and/or main memory. The L2 cache circuitry 5076 is coupled to one or more other levels of cache and eventually to a main memory.

The core 5090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 5090 includes logic to support a packed data instruction set architecture extension (e.g., AVX1, AVX2), thereby allowing the operations used by many multimedia applications to be performed using packed data.

### Example Execution Unit(s) Circuitry.

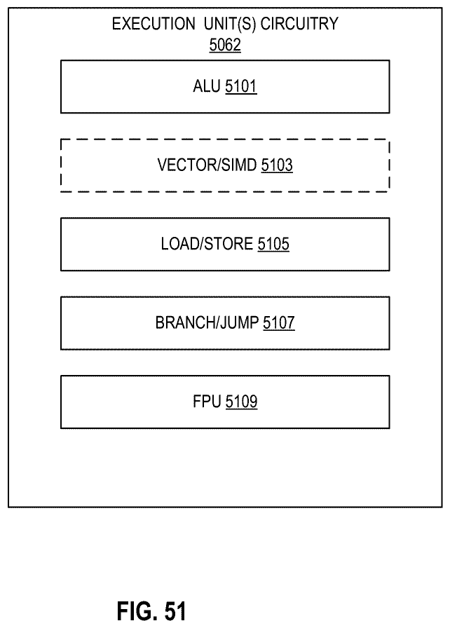

FIG. 51 illustrates examples of execution unit(s) circuitry, such as execution unit(s) circuitry 5062 of FIG. 50B. As illustrated, execution unit(s) circuitry 5062 may include one or more ALU circuits 5101, optional vector/single instruction multiple data (SIMD) circuits 5103, load/store circuits 5105, branch/jump circuits 5107, and/or Floating-point unit (FPU) circuits 5109. ALU circuits 5101 perform integer arithmetic and/or Boolean operations. Vector/SIMD circuits 5103 perform vector/SIMD operations on packed data (such as SIMD/vector registers). Load/store circuits 5105 execute load and store instructions to load data from memory into registers or store from registers to memory. Load/store circuits 5105 may also generate addresses. Branch/jump circuits 5107 cause a branch or jump to a memory address depending on the instruction. FPU circuits 5109 perform floating-point arithmetic. The width of the execution unit(s) circuitry 5062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

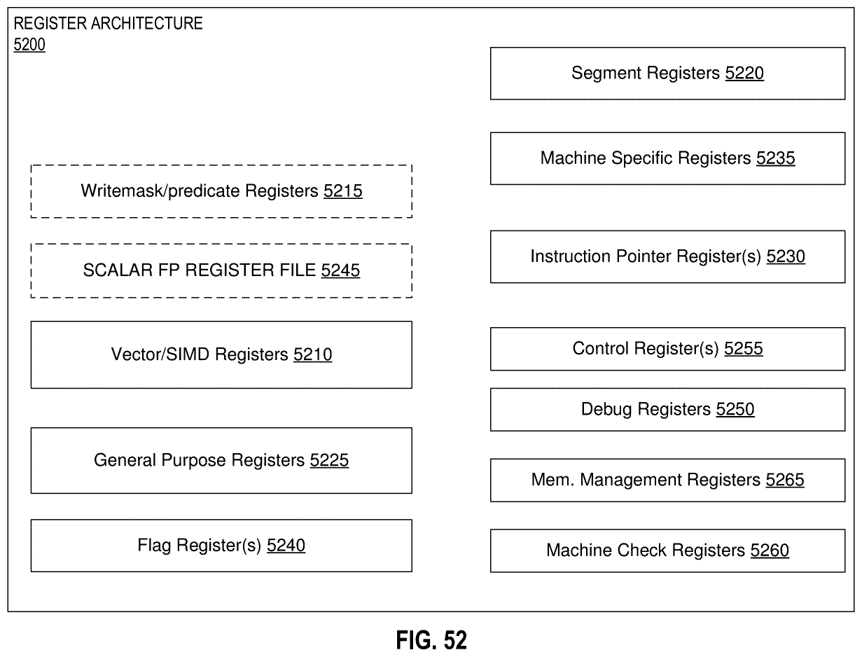

FIG. 52 is a block diagram of a register architecture 5200 according to some examples. As illustrated, the register architecture 5200 includes vector/SIMD registers 5210 that vary from 128-bit to 1,024 bits width. In some examples, the vector/SIMD registers 5210 are physically 512-bits and, depending upon the mapping, only some of the lower bits are used. For example, in some examples, the vector/SIMD registers 5210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 5200 includes writemask/predicate registers 5215. For example, in some examples, there are 8 writemask/predicate registers (sometimes called k0 through k7) that are each 16-bit, 32-bit, 64-bit, or 128-bit in size. Writemask/predicate registers 5215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 5215 corresponds to a data element position of the destination. In other examples, the writemask/predicate registers 5215 are scalable and consists of a set number of enable bits for a given vector element (e.g., 8 enable bits per 64-bit vector element).

The register architecture 5200 includes a plurality of general-purpose registers 5225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 5200 includes scalar floating-point (FP) register file 5245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 5240 (e.g., EFLAGS, RFLAGS, etc.) store status and control information for arithmetic, compare, and system operations. For example, the one or more flag registers 5240 may store condition code information such as carry, parity, auxiliary carry, zero, sign, and overflow. In some examples, the one or more flag registers 5240 are called program status and control registers.

Segment registers 5220 contain segment points for use in accessing memory. In some examples, these registers are referenced by the names CS, DS, SS, ES, FS, and GS.

Machine specific registers (MSRs) 5235 control and report on processor performance. Most MSRs 5235 handle system-related functions and are not accessible to an application program. Machine check registers 5260 consist of control, status, and error reporting MSRs that are used to detect and report on hardware errors.

One or more instruction pointer register(s) 5230 store an instruction pointer value. Control register(s) 5255 (e.g., CR0-CR4) determine the operating mode of a processor (e.g., processor 4870, 4880, 4838, 4815, and/or 4900) and the characteristics of a currently executing task. Debug registers 5250 control and allow for the monitoring of a processor or core's debugging operations.

Memory (mem) management registers 5265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 5200 may, for example, be used in registers 103, 121, or physical register file(s) circuitry 5058.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

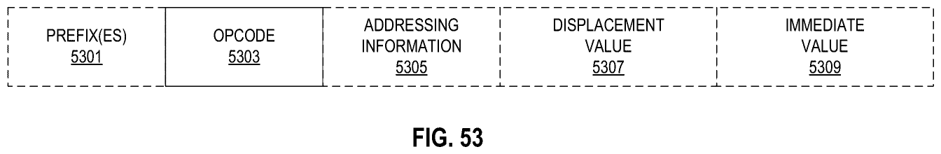

FIG. 53 illustrates examples of an instruction format. As illustrated, an instruction may include multiple components including, but not limited to, one or more fields for: one or more prefixes 5301, an opcode 5303, addressing information 5305 (e.g., register identifiers, memory addressing information, etc.), a displacement value 5307, and/or an immediate value 5309. Note that some instructions utilize some or all the fields of the format whereas others may only use the field for the opcode 5303. In some examples, the order illustrated is the order in which these fields are to be encoded, however, it should be appreciated that in other examples these fields may be encoded in a different order, combined, etc.

The prefix(es) field(s) 5301, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 5303 is used to at least partially define the operation to be performed upon a decoding of the instruction. In some examples, a primary opcode encoded in the opcode field 5303 is one, two, or three bytes in length. In other examples, a primary opcode can be a different length. An additional 3-bit opcode field is sometimes encoded in another field.

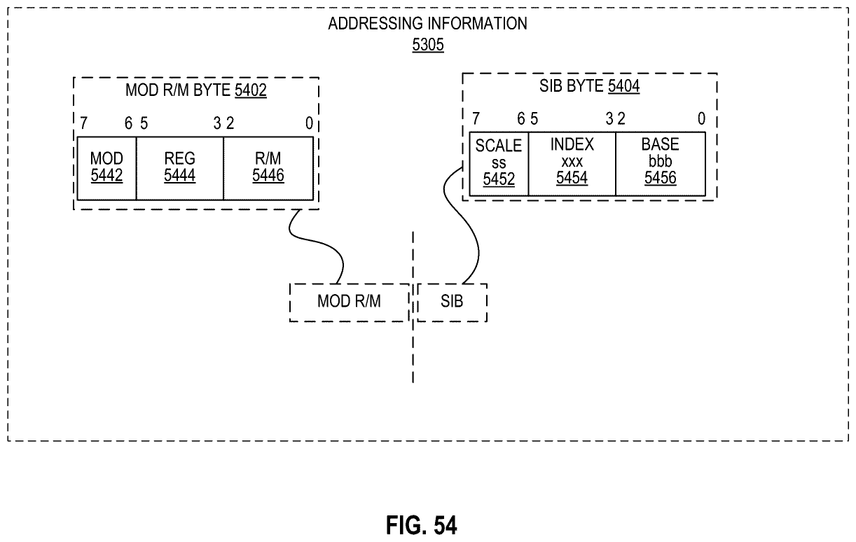

The addressing information field 5305 is used to address one or more operands of the instruction, such as a location in memory or one or more registers. FIG. 54 illustrates examples of the addressing information field 5305. In this illustration, an optional MOD R/M byte 5402 and an optional Scale, Index, Base (SIB) byte 5404 are shown. The MOD R/M byte 5402 and the SIB byte 5404 are used to encode up to two operands of an instruction, each of which is a direct register or effective memory address. Note that both of these fields are optional in that not all instructions include one or more of these fields. The MOD R/M byte 5402 includes a MOD field 5442, a register (reg) field 5444, and R/M field 5446.

The content of the MOD field 5442 distinguishes between memory access and non-memory access modes. In some examples, when the MOD field 5442 has a binary value of 11 (11b), a register-direct addressing mode is utilized, and otherwise a register-indirect addressing mode is used.

The register field 5444 may encode either the destination register operand or a source register operand or may encode an opcode extension and not be used to encode any instruction operand. The content of register field 5444, directly or through address generation, specifies the locations of a source or destination operand (either in a register or in memory). In some examples, the register field 5444 is supplemented with an additional bit from a prefix (e.g., prefix 5301) to allow for greater addressing.

The R/M field 5446 may be used to encode an instruction operand that references a memory address or may be used to encode either the destination register operand or a source register operand. Note the R/M field 5446 may be combined with the MOD field 5442 to dictate an addressing mode in some examples.

The SIB byte 5404 includes a scale field 5452, an index field 5454, and a base field 5456 to be used in the generation of an address. The scale field 5452 indicates a scaling factor. The index field 5454 specifies an index register to use. In some examples, the index field 5454 is supplemented with an additional bit from a prefix (e.g., prefix 5301) to allow for greater addressing. The base field 5456 specifies a base register to use. In some examples, the base field 5456 is supplemented with an additional bit from a prefix (e.g., prefix 5301) to allow for greater addressing. In practice, the content of the scale field 5452 allows for the scaling of the content of the index field 5454 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 5307 provides this value. Additionally, in some examples, a displacement factor usage is encoded in the MOD field of the addressing information field 5305 that indicates a compressed displacement scheme for which a displacement value is calculated and stored in the displacement field 5307.

In some examples, the immediate value field 5309 specifies an immediate value for the instruction. An immediate value may be encoded as a 1-byte value, a 2-byte value, a 4-byte value, etc.

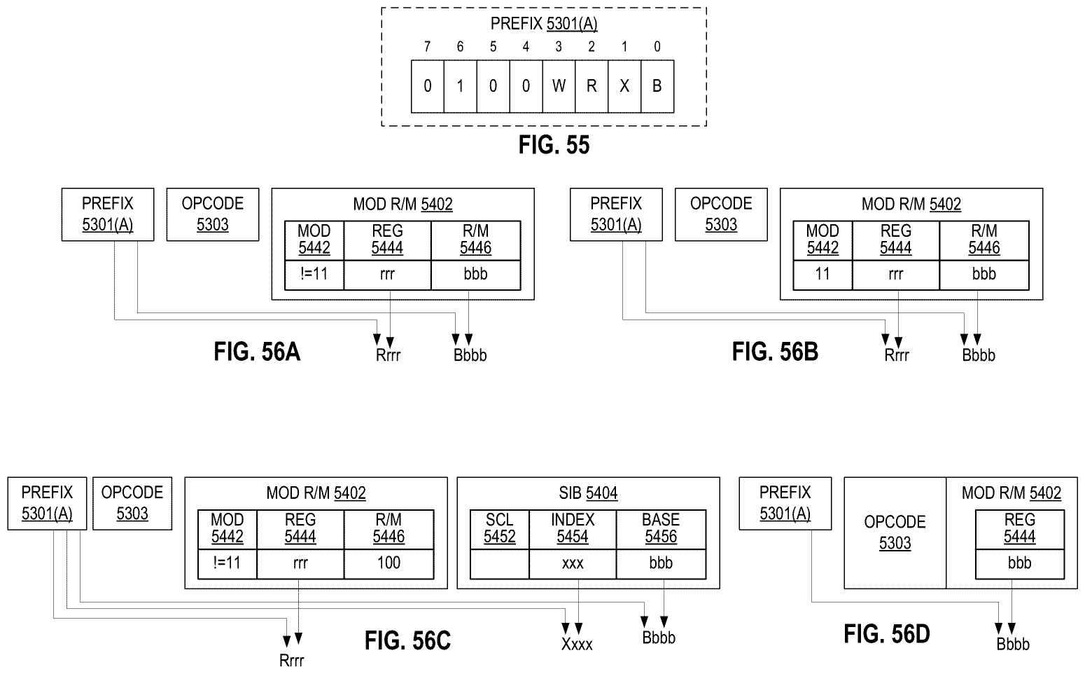

FIG. 55 illustrates examples of a first prefix 5301(A). In some examples, the first prefix 5301(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 5301(A) may specify up to three registers using 3-bit fields depending on the format: 1) using the reg field 5444 and the R/M field 5446 of the MOD R/M byte 5402; 2) using the MOD R/M byte 5402 with the SIB byte 5404 including using the reg field 5444 and the base field 5456 and index field 5454; or 3) using the register field of an opcode.

In the first prefix 5301(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 5444 and MOD R/M R/M field 5446 alone can each only address 8 registers.

In the first prefix 5301(A), bit position 2 (R) may be an extension of the MOD R/M reg field 5444 and may be used to modify the MOD R/M reg field 5444 when that field encodes a general-purpose register, a 64-bit packed data register (e.g., an SSE register), or a control or debug register. R is ignored when MOD R/M byte 5402 specifies other registers or defines an extended opcode.

Bit position 1 (X) may modify the SIB byte index field 5454.

Bit position 0 (B) may modify the base in the MOD R/M R/M field 5446 or the SIB byte base field 5456; or it may modify the opcode register field used for accessing general purpose registers (e.g., general purpose registers 5225).

FIGS. 56A-56D illustrate examples of how the R, X, and B fields of the first prefix 5301(A) are used. FIG. 56A illustrates R and B from the first prefix 5301(A) being used to extend the reg field 5444 and R/M field 5446 of the MOD R/M byte 5402 when the SIB byte 54 04 is not used for memory addressing. FIG. 56B illustrates R and B from the first prefix 5301(A) being used to extend the reg field 5444 and R/M field 5446 of the MOD R/M byte 5402 when the SIB byte 54 04 is not used (register-register addressing). FIG. 56C illustrates R, X, and B from the first prefix 5301(A) being used to extend the reg field 5444 of the MOD R/M byte 5402 and the index field 5454 and base field 5456 when the SIB byte 54 04 being used for memory addressing. FIG. 56D illustrates B from the first prefix 5301(A) being used to extend the reg field 5444 of the MOD R/M byte 5402 when a register is encoded in the opcode 5303.

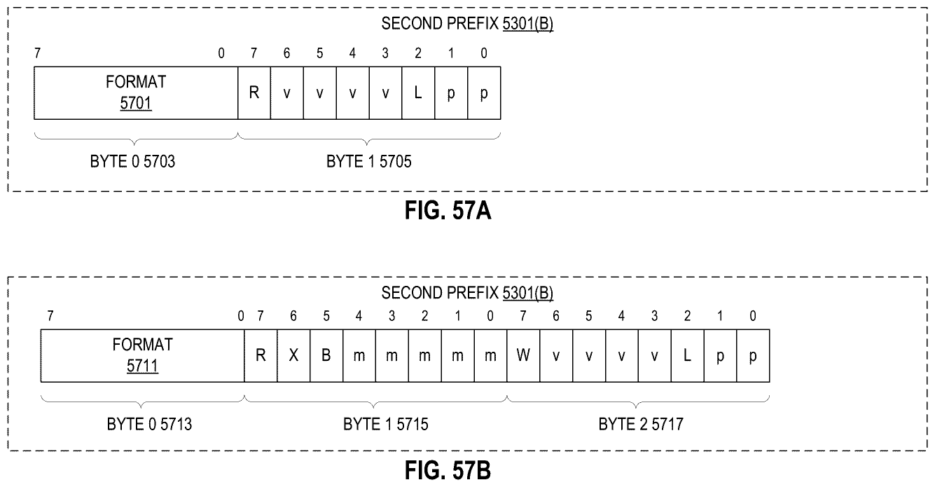

FIGS. 57A-57B illustrate examples of a second prefix 5301(B). In some examples, the second prefix 5301(B) is an example of a VEX prefix. The second prefix 5301(B) encoding allows instructions to have more than two operands, and allows SIMD vector registers (e.g., vector/SIMD registers 5210) to be longer than 64-bits (e.g., 128-bit and 256-bit). The use of the second prefix 5301(B) provides for three-operand (or more) syntax. For example, previous two-operand instructions performed operations such as A=A+B, which overwrites a source operand. The use of the second prefix 5301(B) enables operands to perform nondestructive operations such as A=B+C.

In some examples, the second prefix 5301(B) comes in two forms—a two-byte form and a three-byte form. The two-byte second prefix 5301(B) is used mainly for 128-bit, scalar, and some 256-bit instructions; while the three-byte second prefix 5301(B) provides a compact replacement of the first prefix 5301(A) and 3-byte opcode instructions.

FIG. 57A illustrates examples of a two-byte form of the second prefix 5301(B). In one example, a format field 5701 (byte 0 5703) contains the value CSH. In one example, byte 1 5705 includes an “R” value in bit[7]. This value is the complement of the “R” value of the first prefix 5301(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 5446 to encode the instruction operand that references a memory address or encode either the destination register operand or a source register operand.

Instructions that use this prefix may use the MOD R/M reg field 5444 to encode either the destination register operand or a source register operand, or to be treated as an opcode extension and not used to encode any instruction operand.

For instruction syntax that support four operands, vvvv, the MOD R/M R/M field 5446 and the MOD R/M reg field 5444 encode three of the four operands. Bits[7:4] of the immediate value field 5309 are then used to encode the third source register operand.

FIG. 57B illustrates examples of a three-byte form of the second prefix 5301(B). In one example, a format field 5711 (byte 0 5713) contains the value C4H. Byte 1 5715 includes in bits[7:5] “R,” “X,” and “B” which are the complements of the same values of the first prefix 5301(A). Bits[4:0] of byte 1 5715 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 5717 is used similar to W of the first prefix 5301(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 5446 to encode the instruction operand that references a memory address or encode either the destination register operand or a source register operand.

Instructions that use this prefix may use the MOD R/M reg field 5444 to encode either the destination register operand or a source register operand, or to be treated as an opcode extension and not used to encode any instruction operand.

For instruction syntax that support four operands, vvvv, the MOD R/M R/M field 5446, and the MOD R/M reg field 5444 encode three of the four operands. Bits[7:4] of the immediate value field 5309 are then used to encode the third source register operand.

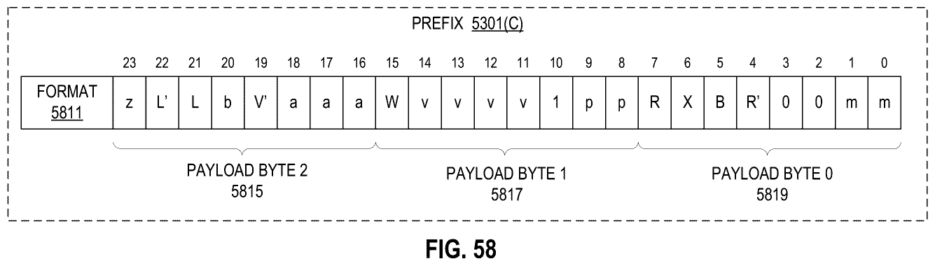

FIG. 58 illustrates examples of a third prefix 5301(C). In some examples, the third prefix 5301(C) is an example of an EVEX prefix. The third prefix 5301(C) is a four-byte prefix.

The third prefix 5301(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 52) or predication utilize this prefix. Opmask register allow for conditional processing or selection control. Opmask instructions, whose source/destination operands are opmask registers and treat the content of an opmask register as a single value, are encoded using the second prefix 5301(B).

The third prefix 5301(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 5301(C) is a format field 5811 that has a value, in one example, of 62H. Subsequent bytes are referred to as payload bytes 5815-5819 and collectively form a 24-bit value of P[23:0] providing specific capability in the form of one or more fields (detailed herein).

In some examples, P[1:0] of payload byte 5819 are identical to the low two mm bits. P[3:2] are reserved in some examples. Bit P[4] (R′) allows access to the high 16 vector register set when combined with P[7] and the MOD R/M reg field 5444. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 5444 and MOD R/M R/M field 5446. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 5301(A) and second prefix 5311(B) and may serve as an opcode extension bit or operand size promotion.

P[18:16] specify the index of a register in the opmask (writemask) registers (e.g., writemask/predicate registers 5215). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

PV[19] can be combined with PV[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 5301(C) are detailed in the following tables.

TABLE 3
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or |
| | | | reg | | Source |
| VVVV | V′ | vvvv | | GPR, Vector | 2nd Source or |
| | | | | | Destination |
| RM | X | B | MOD R/M | GPR, Vector | 1st Source or |
| | | | | | Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 4
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | Vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 5
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

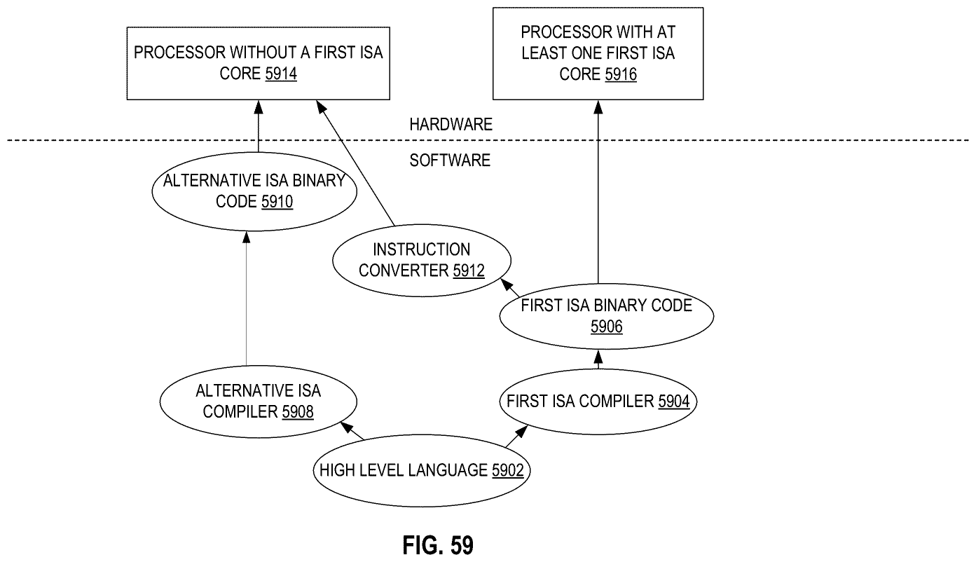

FIG. 59 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 59 shows a program in a high-level language 5902 may be compiled using a first ISA compiler 5904 to generate first ISA binary code 5906 that may be natively executed by a processor with at least one first ISA core 5916. The processor with at least one first ISA core 5916 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 5904 represents a compiler that is operable to generate first ISA binary code 5906 (e.g., object code) that can, with or without additional linkage processing, be executed on the processor with at least one first ISA core 5916. Similarly, FIG. 59 shows the program in the high-level language 5902 may be compiled using an alternative ISA compiler 5908 to generate alternative ISA binary code 5910 that may be natively executed by a processor without a first ISA core 5914. The instruction converter 5912 is used to convert the first ISA binary code 5906 into code that may be natively executed by the processor without a first ISA core 5914. This converted code is not necessarily to be the same as the alternative ISA binary code 5910; however, the converted code will accomplish the general operation and be made up of instructions from the alternative ISA. Thus, the instruction converter 5912 represents software, firmware, hardware, or a combination thereof that, through emulation, simulation, or any other process, allows a processor or other electronic device that does not have a first ISA processor or core to execute the first ISA binary code 5906.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a hardware processor core to implement a trust domain manager to manage one or more hardware isolated virtual machines as a respective trust domain with a region of protected memory; and
input/output memory management unit (IOMMU) circuitry comprising trusted direct memory access translation data and coupled between the hardware processor core and an input/output device, wherein the IOMMU circuitry is to, for a request from the input/output device for a direct memory access of a protected memory of a trust domain:
in response to a field in the request being set to indicate the input/output device is in a trusted computing base of the trust domain and an entry in the trusted direct memory access translation data being set into an active state by the trust domain manager, allow the direct memory access by the input/output device.

2. The apparatus of claim 1, wherein the IOMMU circuitry is to, in response to the entry in the trusted direct memory access translation data being set into a not active state by the trust domain manager, block the direct memory access by the input/output device.

3. The apparatus of claim 1, wherein the IOMMU circuitry is to perform a protection check for an address in the request, and
in response to a successful protection check, allow the direct memory access by the input/output device, and
in response to an unsuccessful protection check, block the direct memory access by the input/output device.

4. The apparatus of claim 1, wherein the IOMMU circuitry is to perform an address translation to determine a host physical address corresponding to a guest address in the request, and
in response to a successful address translation, allow the direct memory access by the input/output device, and
in response to an unsuccessful address translation, block the direct memory access by the input/output device.

5. The apparatus of claim 4, wherein the guest address is a guest virtual address, and the IOMMU circuitry is to, based at least in part on the entry in the trusted direct memory access translation data, determine a guest physical address corresponding to the guest virtual address, and determine the host physical address based at least in part on the guest physical address.

6. The apparatus of claim 1, wherein the IOMMU circuitry is to perform an address translation to determine a host physical address corresponding to a guest address in the request, and in response to the host physical address being associated with the protected memory, send a trusted indication to the input/output device.

7. The apparatus of claim 1, wherein the IOMMU circuitry is coupled to a trusted data structure and an untrusted data structure; and
in response to the field in the request being set to indicate the input/output device is in the trusted computing base of the trust domain, the IOMMU circuitry is to access the trusted data structure; and
in response to the field in the request being set to another value, the IOMMU circuitry is to access the untrusted data structure.

8. The apparatus of claim 1, wherein the IOMMU circuitry comprises a trusted interface and an untrusted interface, and the IOMMU circuitry is to permit access to the trusted interface from the trust domain manager, and not another software agent.

9. The apparatus of claim 1, wherein the IOMMU circuitry is coupled to a trusted data structure and an untrusted data structure; and
a virtual machine monitor of the one or more hardware isolated virtual machines is permitted to access the untrusted data structure; and
the trust domain manager, and not the virtual machine monitor of the one or more hardware isolated virtual machines, is permitted to access the trusted data structure.

10. The apparatus of claim 1, wherein the IOMMU circuitry comprises untrusted direct memory access translation data, and the untrusted direct memory access translation data is accessed in response to the field being set to another value.

11. A method comprising:
managing one or more hardware isolated virtual machines as a respective trust domain with a region of protected memory by a trust domain manager of a hardware processor core;
sending a request for a direct memory access of a protected memory of a trust domain from an input/output device to input/output memory management unit (IOMMU) circuitry comprising trusted direct memory access translation data and coupled between the hardware processor core and the input/output device; and
in response to a field in the request being set to indicate the input/output device is in a trusted computing base of the trust domain and an entry in the trusted direct memory access translation data being set into an active state by the trust domain manager, allowing the direct memory access by the input/output device.

12. The method of claim 11, further comprising, in response to the entry in the trusted direct memory access translation data being set into a not active state by the trust domain manager, blocking, by the IOMMU circuitry, the direct memory access by the input/output device.

13. The method of claim 11, further comprising:
performing, by the IOMMU circuitry, a protection check for an address in the request;
in response to a successful protection check, allowing, by the IOMMU circuitry, the direct memory access by the input/output device; and
in response to an unsuccessful protection check, blocking, by the IOMMU circuitry, the direct memory access by the input/output device.

14. The method of claim 11, further comprising:
performing, by the IOMMU circuitry, an address translation to determine a host physical address corresponding to a guest address in the request;
in response to a successful address translation, allowing, by the IOMMU circuitry, the direct memory access by the input/output device; and
in response to an unsuccessful address translation, blocking, by the IOMMU circuitry, the direct memory access by the input/output device.

15. The method of claim 14, wherein the guest address is a guest virtual address, and the method further comprises:
determining, by the IOMMU circuitry and based at least in part on the entry in the trusted direct memory access translation data:
a guest physical address corresponding to the guest virtual address, and the host physical address based at least in part on the guest physical address.

16. The method of claim 11, further comprising:
performing, by the IOMMU circuitry, an address translation to determine a host physical address corresponding to a guest address in the request; and
in response to the host physical address being associated with the protected memory, sending, by the IOMMU circuitry, a trusted indication to the input/output device.

17. The method of claim 11, wherein the IOMMU circuitry is coupled to a trusted data structure and an untrusted data structure, and the method further comprises:
in response to the field in the request being set to indicate the input/output device is in the trusted computing base of the trust domain, accessing, by the IOMMU circuitry, the trusted data structure; and
in response to the field in the request being set to another value, accessing, by the IOMMU circuitry, the untrusted data structure.

18. The method of claim 11, wherein the IOMMU circuitry comprises a trusted interface and an untrusted interface, and the method further comprises permit access, by the IOMMU circuitry, to the trusted interface from the trust domain manager, and not another software agent.

19. The method of claim 11, wherein the IOMMU circuitry is coupled to a trusted data structure and an untrusted data structure, and the method further comprises:
permitting access to the untrusted data structure by a virtual machine monitor of the one or more hardware isolated virtual machines; and
permitting access to the trusted data structure by the trust domain manager, and not the virtual machine monitor of the one or more hardware isolated virtual machines.

20. The method of claim 11, wherein the IOMMU circuitry comprises untrusted direct memory access translation data, and the method further comprises accessing the untrusted direct memory access translation data in response to the field being set to another value.

21. A system comprising:
a hardware processor core to implement a trust domain manager to manage one or more hardware isolated virtual machines as a respective trust domain with a region of protected memory;
an input/output device coupled to the hardware processor core; and
input/output memory management unit (IOMMU) circuitry comprising trusted direct memory access translation data and coupled between the hardware processor core and the input/output device, wherein the IOMMU circuitry is to, for a request from the input/output device for a direct memory access of a protected memory of a trust domain:
in response to a field in the request being set to indicate the input/output device is in a trusted computing base of the trust domain and an entry in the trusted direct memory access translation data being set into an active state by the trust domain manager, allow the direct memory access by the input/output device.

22. The system of claim 21, wherein the IOMMU circuitry is to, in response to the entry in the trusted direct memory access translation data being set into a not active state by the trust domain manager, block the direct memory access by the input/output device.

23. The system of claim 21, wherein the IOMMU circuitry is to perform a protection check for an address in the request, and
in response to a successful protection check, allow the direct memory access by the input/output device, and
in response to an unsuccessful protection check, block the direct memory access by the input/output device.

24. The system of claim 21, wherein the IOMMU circuitry is to perform an address translation to determine a host physical address corresponding to a guest address in the request, and
in response to a successful address translation, allow the direct memory access by the input/output device, and
in response to an unsuccessful address translation, block the direct memory access by the input/output device.

25. The system of claim 24, wherein the guest address is a guest virtual address, and the IOMMU circuitry is to, based at least in part on the entry in the trusted direct memory access translation data, determine a guest physical address corresponding to the guest virtual address, and determine the host physical address based at least in part on the guest physical address.
